(19) United States
(12) Patent Application Publication
(10) Pub. No.: US 2026/0197130 A1
(43) Pub. Date: Jul. 9, 2026

(54) UL BEAM TRACKING

(71) Applicant: Samsung Electronics Co., Ltd., Suwon-si (KR)

(72) Inventors: Emad Nader Farag, Flanders, NJ (US); Eko Onggosanusi, Coppell, TX (US); Dalin Zhu, Allen, TX (US); Md. Saifur Rahman, Plano, TX (US)

(21) Appl. No.: 19/414,253

(22) Filed: Dec. 9, 2025

Related U.S. Application Data
(60) Provisional application No. 63/742,288, filed on Jan. 6, 2025.
(60) Provisional application No. 63/816,353, filed on Jun. 2, 2025.

(51) Int. Cl. H04L 5/00; H04B 17/318; H04L 27/26

(52) U.S. Cl. CPC H04L 5/0044; H04B 17/328; H04L 27/261

(57) ABSTRACT

Apparatuses and methods for uplink (UL) beam tracking. A method performed by a user equipment includes transmitting a physical uplink shared channel (PUSCH). The PUSCH includes a first set of resource elements (REs) including a first demodulation reference signal (DMRS) and a first UL-shared channel (SCH), the first DMRS and UL-SCH based on a first spatial transmission filter, and a second set of REs including first N reference signals (RSs) based on second N spatial transmission filters, respectively, where N is larger than or equal to 1. The method further includes receiving a first channel including information based on measurement of the first DMRS and the first N RSs, determining, based on the first channel, a third spatial transmission filter for the first DMRS and the first UL-SCH, and transmitting the first set of REs based on the third spatial transmission filter.

### CROSS-REFERENCE TO RELATED AND CLAIM OF PRIORITY

The present application claims priority under 35 U.S.C. § 119(e) to U.S. Provisional Patent Application No. 63/742,288 filed on Jan. 6, 2025, and U.S. Provisional Patent Application No. 63/816,353 filed on Jun. 2, 2025, which are hereby incorporated by reference in their entirety.

### TECHNICAL FIELD

The present disclosure relates generally to wireless communication systems and, more specifically, the present disclosure is related to uplink (UL) beam tracking.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus for UL beam tracking.

In one embodiment, a user equipment (UE) is provided. The UE includes a transceiver configured to transmit a physical uplink shared channel (PUSCH). The PUSCH includes a first set of resource elements (REs) including a first demodulation reference signal (DMRS) and a first UL-shared channel (SCH), the first DMRS and UL-SCH based on a first spatial transmission filter, and a second set of REs including first N reference signals (RSs) based on second N spatial transmission filters, respectively, where N is larger than or equal to 1. The transceiver is further configured to receive a first channel including information based on measurement of the first DMRS and the first N RSs. The UE further includes a processor operably coupled to the transceiver. The processor is configured to determine, based on the first channel, a third spatial transmission filter for the first DMRS and the first UL-SCH. The transceiver is further configured to transmit the first set of REs based on the third spatial transmission filter.

In another embodiment, a base station (BS) is provided. The BS includes a transceiver configured to receive a PUSCH. The PUSCH includes a first set of REs including a first DMRS and a first UL-SCH, the first DMRS and UL-SCH based on a first spatial transmission filter, and a second set of REs including first N RSs based on second N spatial transmission filters, respectively, where N is larger than or equal to 1. The BS further includes a processor operably coupled to the transceiver. The processor is configured to measure a metric based on the first DMRS and N metrics based on the first N RS and determine information based on the metric and the N metrics. The transceiver is further configured to transmit a first channel including the information.

In yet another embodiment, a method of operating a UE is provided. The method includes transmitting a PUSCH. The PUSCH includes a first set of REs including a first DMRS and a first UL-SCH, the first DMRS and UL-SCH based on a first spatial transmission filter, and a second set of REs including first N RSs based on second N spatial transmission filters, respectively, where N is larger than or equal to 1. The method further includes receiving a first channel including information based on measurement of the first DMRS and the first N RSs, determining, based on the first channel, a third spatial transmission filter for the first DMRS and the first UL-SCH, and transmitting the first set of REs based on the third spatial transmission filter.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example PUSCH DM-RS of basic configuration type 1 according to embodiments of the present disclosure;

FIG. 5B illustrates another example PUSCH DM-RS of basic configuration type 1 according to embodiments of the present disclosure;

FIG. 6A illustrates an example PUSCH DM-RS of enhanced configuration type 1 according to embodiments of the present disclosure;

FIG. 6B illustrates another example PUSCH DM-RS of enhanced configuration type 1 according to embodiments of the present disclosure;

FIG. 7A illustrates an example PUSCH DM-RS of basic configuration type 2 according to embodiments of the present disclosure;

FIG. 7B illustrates another example PUSCH DM-RS of basic configuration type 2 according to embodiments of the present disclosure;

FIG. 8A illustrates an example PUSCH DM-RS of enhanced configuration type 2 according to embodiments of the present disclosure;

FIG. 8B illustrates another example PUSCH DM-RS of enhanced configuration type 2 according to embodiments of the present disclosure;

FIG. 9 illustrates an example SRS according to embodiments of the present disclosure;

FIG. 10 illustrates example CDM groups and the ports of each CDM group according to embodiments of the present disclosure;

FIG. 11A illustrates an example beam operation in a wireless communication system according to embodiments of the present disclosure;

FIG. 11B illustrates an example multi-beam operation in a wireless communication system according to embodiments of the present disclosure;

FIG. 12 illustrates an example of a transmitter structure for beamforming according to embodiments of the present disclosure;

FIG. 13 illustrates an example joint phase-time arrays (JPTA) structure for wireless systems according to embodiments of the present disclosure;

FIG. 14 illustrates an example beam operation utilizing JPTA according to embodiments of the present disclosure;

FIGS. 15A-15B illustrate example beam operations according to embodiments of the present disclosure;

FIG. 16 illustrates an example of a multi-beam system in a wireless communication system according to embodiments of the present disclosure;

FIG. 17 illustrates an example UE indication for scheduling the PUSCH according to embodiments of the present disclosure;

FIG. 18 illustrates an example beam or spatial domain transmission filter according to embodiments of the disclosure;

FIGS. 19-21 illustrate example DM-RS symbols of an UL transmission according to embodiments of the present disclosure;

FIG. 22 illustrates examples of RB allocation to different types of reference signals used in UL channel transmission according to embodiments of the present disclosure;

FIG. 23 illustrates further examples of RB allocation to different types of reference signals used in UL channel transmission according to embodiments of the present disclosure;

FIG. 24 illustrates another example of DM-RS symbols of an UL transmission according to embodiments of the present disclosure;

FIG. 25 illustrates further examples of RB allocation to different types of reference signals used in UL channel transmission according to embodiments of the present disclosure;

FIG. 26 illustrates further examples of RB allocation to different types of reference signals used in UL channel transmission according to embodiments of the present disclosure;

FIG. 27 illustrates another example beam or spatial domain transmission filter according to embodiments of the disclosure;

FIGS. 28A-28B illustrate example SRS resources according to embodiments of the present disclosure;

FIGS. 29A-29B illustrate example configurations used for SRS and SBT-RS according to embodiments of the present disclosure;

FIG. 30 illustrates further examples of RB allocation to different types of reference signals according to embodiments of the present disclosure;

FIG. 31 illustrates further examples of RB allocation to different types of reference signals according to embodiments of the present disclosure;

FIG. 32 illustrates further examples of RB allocation to different types of reference signals according to embodiments of the present disclosure;

FIG. 33 illustrates further examples of RB allocation to different types of reference signals according to embodiments of the present disclosure;

FIG. 34 illustrates another example beam or spatial domain transmission filter according to embodiments of the disclosure;

FIGS. 35A-35F illustrate example gNB reports to the UE according to embodiments of the present disclosure; and

FIG. 36 illustrates an example method performed by a UE in a wireless communication system according to embodiments of the present disclosure.

### DETAILED DESCRIPTION

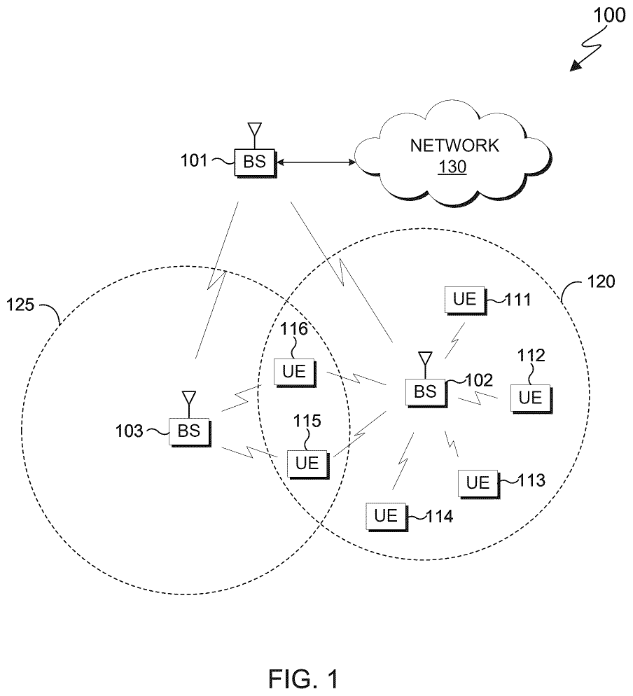

FIGS. 1-36 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v18.4.0, “Physical channels and modulation” (herein, “REF 1”); 3GPP TS 38.212 v18.4.0, “NR; Multiplexing and Channel coding” (herein, “REF 2”); 3GPP TS 38.213 v18.4.0, “NR; Physical Layer Procedures for Control” (herein, “REF 3”); 3GPP TS 38.214 v18.4.0, “NR; Physical Layer Procedures for Data” (herein, “REF 4”); 3GPP TS 38.321 v18.3.0, “NR; Medium Access Control (MAC) protocol specification” (herein, “REF 5”); and 3GPP TS 38.331 v18.3.0, “NR; Radio Resource Control (RRC) Protocol Specification” (herein, “REF 6”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for UL beam tracking. In certain embodiments, one or more of the gNBs 101-103 include circuitry, programing, or a combination thereof to support UL beam tracking.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

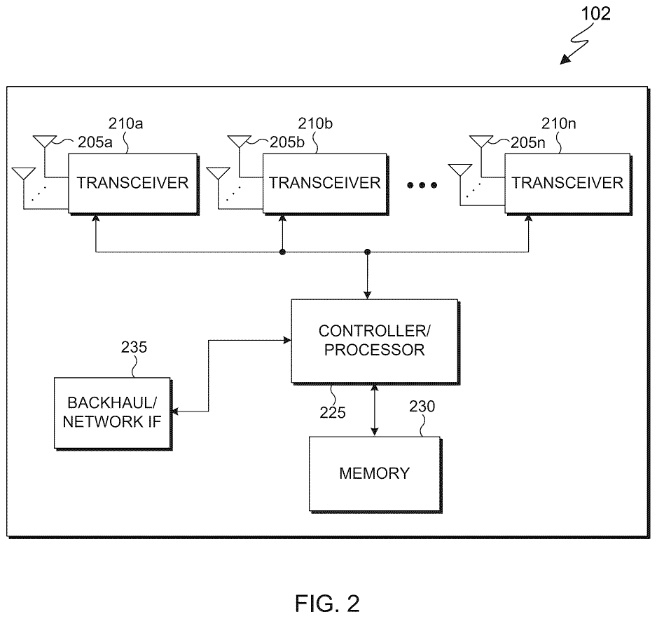

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for UL beam tracking. Any of a wide variety of other functions could be supported in the gNB 102 by the controller/processor 225.

The controller/processor 225 is also capable of executing programs and other processes resident in the memory 230, such as processes to support UL beam tracking. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

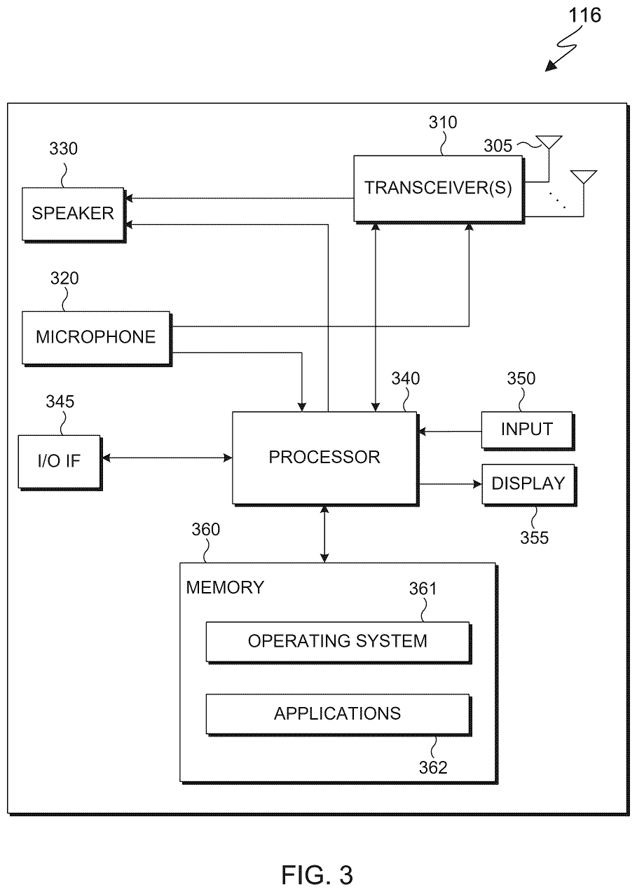

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UL beam tracking as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

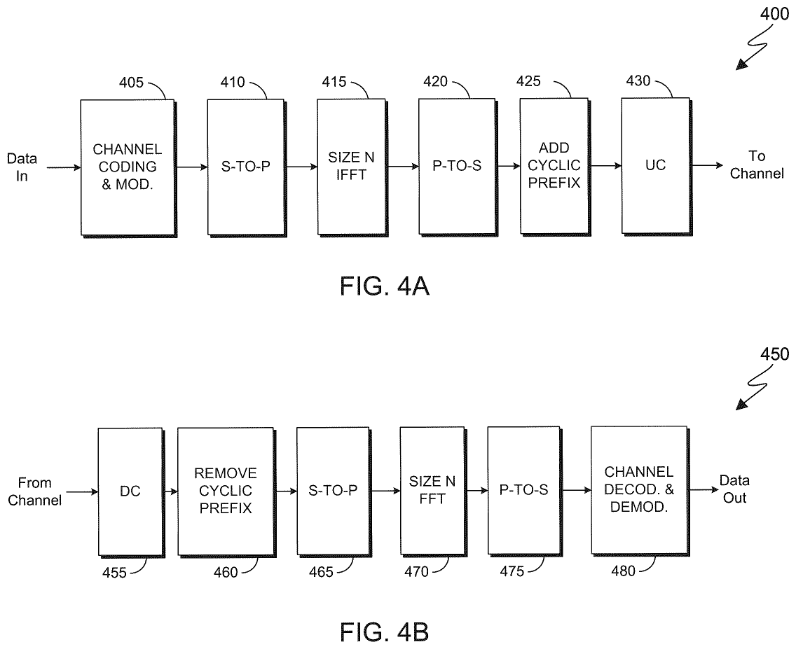

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for supporting UL beam tracking as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the gNBs 101-103 and may implement a receive path 450 for receiving in the downlink from the gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In present disclosure and in general, a time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond, and an RB can have a bandwidth of 180 kHz and include 12 SCs with inter-SC spacing of 15 kHz. As another example, a slot can have a duration of 0.25 milliseconds and include 14 symbols, and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, full UL slot, or hybrid slot similar to a special subframe in time division duplex (TDD) systems (see also REF 1). A slot can include sub-band full duplex (SBFD) symbols, wherein a symbol includes DL sub-band(s) and UL sub-band(s). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in 38.212, are referred for brevity as a unicast DCI format. A DCI format scheduling PDSCH reception for multicast communication, such as a DCI format with CRC scrambled by G-RNTI/G-CS-RNTI as described in 38.212, are referred to as multicast DCI format. DCI formats providing various control information to at least a subset of UEs in a serving cell, such as DCI format 2_0 in 38.212, are referred to as group-common (GC) DCI formats.

The downlink physical-layer processing of transport channels on PDSCH can consist of the following steps: (1) Transport block CRC attachment; (2) Code block segmentation and code block CRC attachment; (3) Channel coding: LDPC coding; (4) Physical-layer hybrid-ARQ processing; (5) Rate matching; (6) Scrambling; (7) Modulation: QPSK, 16QAM, 64QAM, 256QAM, and 1024QAM; (8) Layer mapping; and (9) Mapping to assigned resources and antenna ports.

As introduced above, the Physical Downlink Control Channel (PDCCH) can be used to schedule DL transmissions on PDSCH and UL transmissions on PUSCH, where the Downlink Control Information (DCI) on PDCCH includes: (1) Downlink assignments containing at least modulation and coding format, resource allocation, and hybrid-ARQ information related to DL-SCH; and (2) Uplink scheduling grants containing at least modulation and coding format, resource allocation, and hybrid-ARQ information related to UL-SCH. In addition to scheduling, PDCCH can be used to for: (1) Activation and deactivation of configured PUSCH transmission with configured grant; (2) Activation and deactivation of PDSCH semi-persistent transmission; (3) Notifying one or more UEs of the slot format; (4) Notifying one or more UEs of the RB(s) and OFDM symbol(s) where the UE may assume no transmission is intended for the UE; (5) Transmission of TPC commands for PUCCH and PUSCH; (6) Transmission of one or more TPC commands for SRS transmissions by one or more UEs; (7) Switching a UE's active bandwidth part; (8) Initiating a random access procedure; (9) Indicating the UE(s) to monitor the PDCCH during the next occurrence of the DRX on-duration; (10) In IAB context, indicating the availability for soft symbols of an IAB-DU; (11) Triggering one shot HARQ-ACK codebook feedback; and (11) For operation with shared spectrum channel access: (11a) Triggering search space set group switching; (11b) Indicating one or more UEs about the available RB sets and channel occupancy time duration; and (11c) Indicating downlink feedback information for configured grant PUSCH (CG-DFI). Polar coding is used for PDCCH. QPSK modulation is used for PDCCH.

A gNB (such as BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DM-RS is transmitted only in the BW of a respective PDCCH or PDSCH and a UE can use the DM-RS to demodulate data or control information.

UL signals also include data signals conveying information content, control signals conveying UL control information (UCI), DM-RS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, UE initiated report indicator (UEIRI) indicating a request to transmit a UE initiated measurement report and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

The PUSCH DM-RS is mapped to physical resources (resource elements in a DM-RS symbol) according to configuration type 1 or configuration type 2. Rel-18 introduced enhanced DMRS type through higher layer parameter dmrs-TypeEnh, (enhanced DM-RS multiplexing) which doubles the number of antenna ports, as shown in Table 1 below.

TABLE 1

| | | | Support antenna ports \tilde{p} | |
|---|---|---|---|---|
| DM-RS | DM-RS | | Config | Config |
| multiplexing | duration | l′ | Type 1 | Type 2 |
| Basic | Single symbol | 0 | 0-3 | 0-5 |
| (Rel-15) | Double-symbol | 0, 1 | 0-7 | 0-11 |
| Enhanced | Single symbol | 0 | 0-3, 8-11 | 0-5, 12-17 |
| (Rel-18) | Double-symbol | 0, 1 | 0-15 | 0-23 |

Configuration type 1 is used when transform precoding is enabled or disabled. Configuration type 2 is used when transform precoding is disabled. Enhanced DM-RS multiplexing is configured when transform precoding is disabled.

PUSCH DM-RS is mapped to resource elements for antenna ports \tilde{p}ⱼ, j=0, 1, . . . , ν−1, where ν are the number of layers. The DM-RS antenna ports {\tilde{p}₀, \tilde{p}₁, . . . , \tilde{p}_{ν-1}} are determined according to the DM-RS port(s) given by the tables in clause 7.3.1.1.2 of TS 38.212. An intermediate quantity

$${\tilde{a}}_{k , l}^{( {\overline{p}}_{j} , μ )}$$

is first obtained for antenna port \tilde{p}ⱼ. After mapping DM-RS to resource elements for antenna ports \tilde{p}ⱼ, j=0, 1, . . . , ν−1, where ν are the number of layers, an antenna pre-coding matrix W is applied to transform {\tilde{p}₀, \tilde{p}₁, . . . , \tilde{p}_{ν-1}} to {\tilde{p}₀, \tilde{p}₁, . . . , \tilde{p}_{ν-1}} to get

$${a}_{k , l}^{( {p}_{j} , μ )} ,$$

such that:

$$[ \begin{matrix}{\tilde{a}}_{k , l}^{( {\tilde{p}}_{0} , μ )} \\ ⋮ \\ {\tilde{a}}_{k , l}^{( {\tilde{p}}_{v - 1} , μ )}\end{matrix} ] = {β}_{PUSCH}^{DMRS} W [ \begin{matrix}{a}_{k , l}^{( {p}_{0} , μ )} \\ ⋮ \\ {a}_{k , l}^{( {p}_{v - 1} , μ )}\end{matrix} ] .$$

In the present disclosure, Basic Configuration type 1 is provided by:

$$k = 4 n + 2 {k}^{′} + Δ ,$$

where,
k′=0.1
n=0, 1, . . . .
Δ=0, for ports 1000, 1001, 1004 and 1005. Δ=1, for ports 1002, 1003, 1006 and 1007.

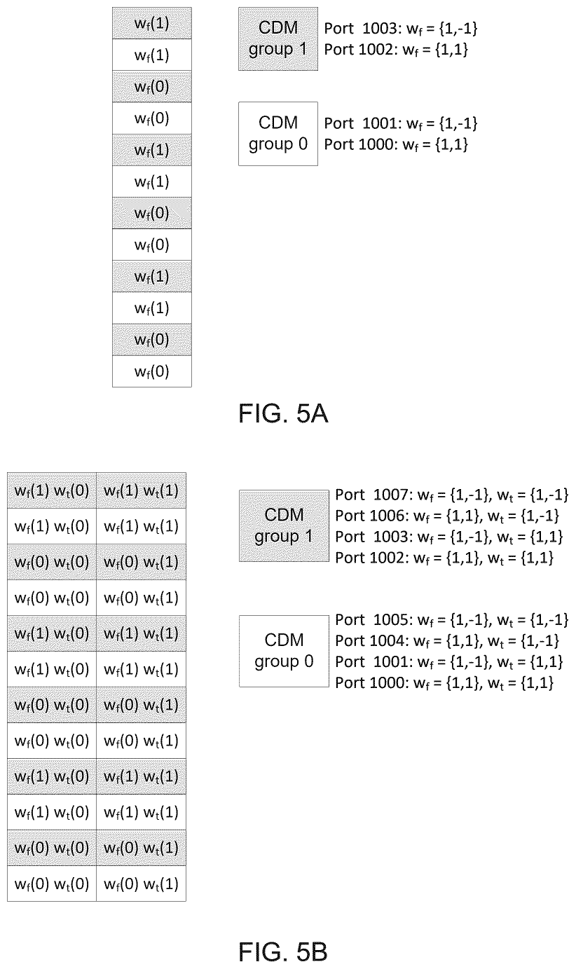

FIG. 5A illustrates an example PUSCH DM-RS 500 of basic configuration type 1 according to embodiments of the present disclosure. For example, PUSCH DM-RS 500 of basic configuration type 1 can be implemented by any of the UEs 111-116 of FIG. 1. This example is for illustration only and can be used without departing from the scope of the present disclosure.

As illustrated in FIG. 5A, with a single DM-RS symbol, the PUSCH DM-RS 500 supports 4 antenna ports (1000 . . . 1003). Further, antenna ports 1000 and 1001 are in a same code division multiplexing (CDM) group (e.g., CDM group 0), where the two antenna ports are differentiated by orthogonal codes in the frequency domain. Similarly, antenna ports 1002 and 1003 are in a same CDM group (e.g., CDM group 1), where the two antenna ports are differentiated by orthogonal codes in the frequency domain.

FIG. 5B illustrates another example PUSCH DM-RS 550 of basic configuration type 1 according to embodiments of the present disclosure. For example, PUSCH DM-RS 550 of basic configuration type 1 can be implemented by any of the UEs 111-116 of FIG. 1. This example is for illustration only and can be used without departing from the scope of the present disclosure.

As illustrated in FIG. 5B, with double DM-RS symbols, the PUSCH DM-RS 550 supports 8 antenna ports (1000 . . . 1007). Further, antenna ports 1000, 1001, 1004 and 1005 are in a same CDM group (e.g., CDM group 0), where the four antenna ports are differentiated by orthogonal codes in the frequency domain and orthogonal codes in the time domain. Similarly, antenna ports 1002, 1003, 1006 and 1007 are in a same CDM group (e.g., CDM group 1), where the four antenna ports are differentiated by orthogonal codes in the frequency domain and orthogonal codes in the time domain. In various embodiments, basic configuration type 1 is used whether or not transform precoding is enabled.

In the present disclosure, enhanced configuration type 1 is provided by:

$$k = 8 n + 2 {k}^{′} + Δ ,$$

where,
n=0, 1, . . . .
k′=0, 1, 2, 3
Δ=0, for \tilde{p} 0, 1, 4, 5, 8, 9, 12 and 13. Δ=1, for \tilde{p} 2, 3, 6, 7, 10, 11, 14 and 15.

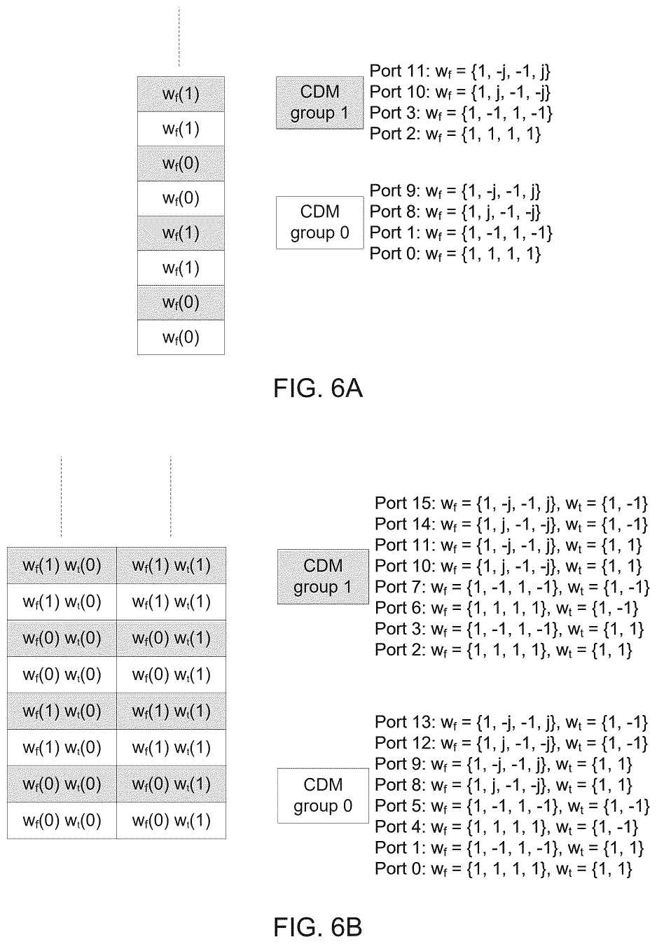

FIG. 6A illustrates an example PUSCH DM-RS 600 of enhanced configuration type 1 according to embodiments of the present disclosure. For example, PUSCH DM-RS 600 of enhanced configuration type 1 can be implemented by any of the UEs 111-116 of FIG. 1. This example is for illustration only and can be used without departing from the scope of the present disclosure.

As illustrated in FIG. 6A, with a single DM-RS symbol, the PUSCH DM-RS 600 supports 8 antenna ports, 0-3 and 8-11. Further, antenna ports 0, 1, 8 and 9 are in a same CDM group (i.e., CDM group 0), where the four antenna ports are differentiated by orthogonal codes in the frequency domain. Similarly, antenna ports 2, 3, 10 and 11 are in a same CDM group (i.e., CDM group 1), where the four antenna ports are differentiated by orthogonal codes in the frequency domain.

FIG. 6B illustrates another example PUSCH DM-RS 650 of enhanced configuration type 1 according to embodiments of the present disclosure. For example, PUSCH DM-RS 650 of enhanced configuration type 1 can be implemented by any of the UEs 111-116 of FIG. 1. This example is for illustration only and can be used without departing from the scope of the present disclosure.

As illustrated in FIG. 6B, with double DM-RS symbols, the PUSCH DM-RS 650 supports 16 antenna ports, 0-15. Further, antenna ports 0, 1, 4, 5, 8, 9, 12 and 13 are in a same CDM group (i.e., CDM group 0), where the eight antenna ports are differentiated by orthogonal codes in the frequency domain and orthogonal codes in the time domain. Similarly, antenna ports 2, 3, 6, 7, 10, 11, 14 and 15 are in a same CDM group (i.e., CDM group 1), where the eight antenna ports are differentiated by orthogonal codes in the frequency domain and orthogonal codes in the time domain. In various embodiments, enhanced configuration type 1 is used when transform precoding is not enabled.

In the present disclosure, basic configuration type 2 is provided by:

$$k = 6 n + {k}^{′} + Δ ,$$

where,
k′=0, 1
n=0, 1, . . . .
Δ=0, for ports 1000, 1001, 1006 and 1007. Δ=2, for ports 1002, 1003, 1008 and 1009. Δ=4, for ports 1004, 1005, 1010 and 1011.

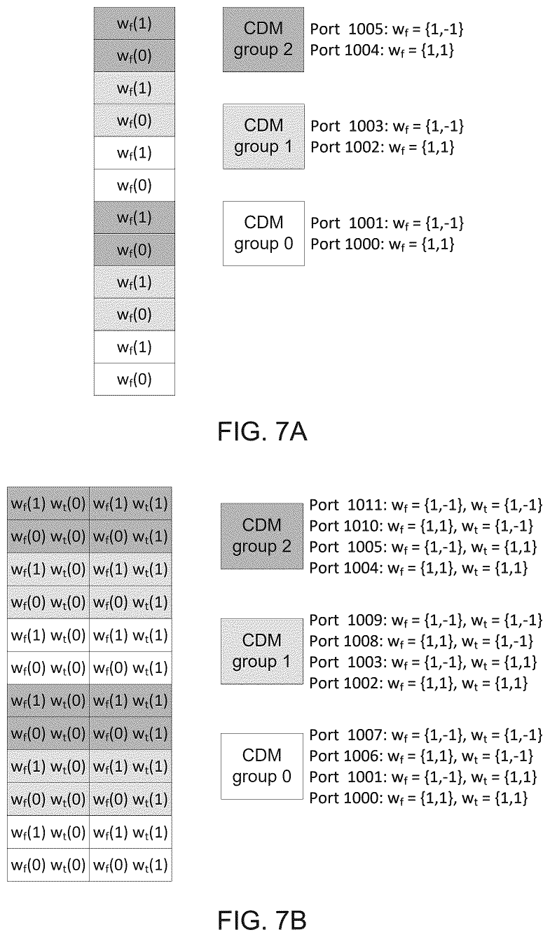

FIG. 7A illustrates an example PUSCH DM-RS 700 of basic configuration type 2 according to embodiments of the present disclosure. For example, PUSCH DM-RS 700 of basic configuration type 2 can be implemented by any of the UEs 111-116 of FIG. 1. This example is for illustration only and can be used without departing from the scope of the present disclosure.

As illustrated in FIG. 7A, with a single DM-RS symbol, the PUSCH DM-RS 700 supports 6 antenna ports (1000 . . . 1005). Further, antenna ports 1000 and 1001 are in a same CDM group (e.g., CDM group 0), where the two antenna ports are differentiated by orthogonal codes in the frequency domain. Similarly, antenna ports 1002 and 1003 are in a same CDM group (e.g., CDM group 1), where the two antenna ports are differentiated by orthogonal codes in the frequency domain. Similarly, antenna ports 1004 and 1005 are in a same CDM group (e.g., CDM group 2), where the two antenna ports are differentiated by orthogonal codes in the frequency domain.

FIG. 7B illustrates another example PUSCH DM-RS 750 of basic configuration type 2 according to embodiments of the present disclosure. For example, PUSCH DM-RS 750 of basic configuration type 2 can be implemented by any of the UEs 111-116 of FIG. 1. This example is for illustration only and can be used without departing from the scope of the present disclosure.

As illustrated in FIG. 7B, with a double DM-RS symbol, the PUSCH DM-RS 750 supports 12 antenna ports (1000 . . . 1011). Further, antenna ports 1000, 1001, 1006 and 1007 are in a same CDM group (e.g., CDM group 0), where the four antenna ports are differentiated by orthogonal codes in the frequency domain and orthogonal codes in the time domain. Similarly, antenna ports 1002, 1003, 1008 and 1009 are in a same CDM group (e.g., CDM group 1), where the four antenna ports are differentiated by orthogonal codes in the frequency domain and orthogonal codes in the time domain. Similarly, antenna ports 1004, 1005, 1010 and 1011 are in a same CDM group (e.g., CDM group 2), where the four antenna ports are differentiated by orthogonal codes in the frequency domain and orthogonal codes in the time domain. In various embodiments, basic configuration type 2 is used when transform precoding is not enabled.

In the present disclosure, enhanced configuration type 2 is provided by:

$$k = \{ \begin{matrix}12 n + {k}^{′} + Δ & {k}^{′} = 0 , 1 \\ 12 n + {k}^{′} + Δ + 4 & {k}^{′} = 2 , 3\end{matrix} ,$$

where,
n=0, 1, . . .
k′=0, 1, 2, 3
Δ=0, for \tilde{p} 0, 1, 6, 7, 12, 13, 18 and 19. Δ=2, for \tilde{p} 2, 3, 8, 9, 14, 15, 20 and 21. Δ=4, for \tilde{p} 4, 5, 10, 11, 16, 17, 22 and 23.

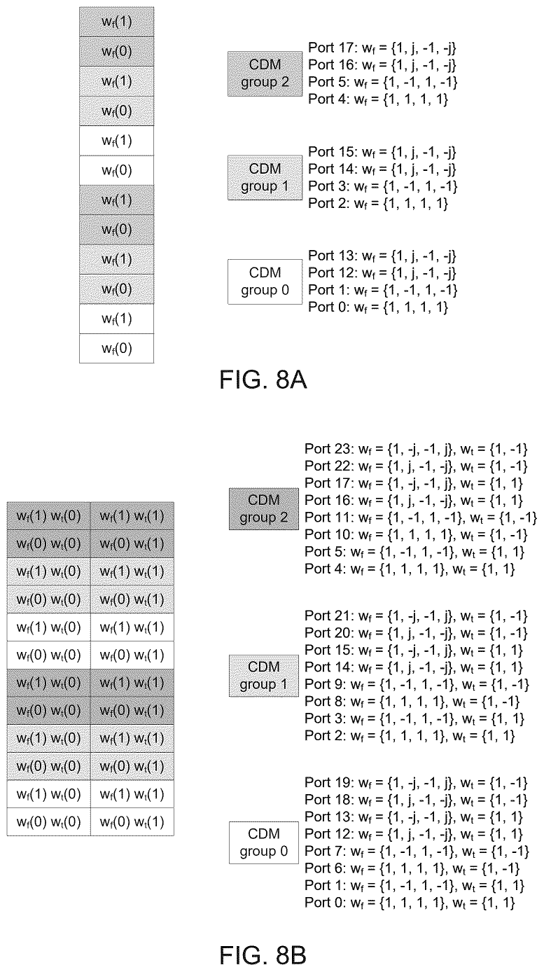

FIG. 8A illustrates an example PUSCH DM-RS 800 of enhanced configuration type 2 according to embodiments of the present disclosure. For example, PUSCH DM-RS 800 of enhanced configuration type 2 can be implemented by any of the UEs 111-116 of FIG. 1. This example is for illustration only and can be used without departing from the scope of the present disclosure.

As illustrated in FIG. 8A, with a single DM-RS symbol, the PUSCH DM-RS 800 supports 12 antenna ports, 0-5 and 12-17. Further, antenna ports 0, 1, 12 and 13 are in a same CDM group (i.e., CDM group 0), where the four antenna ports are differentiated by orthogonal codes in the frequency domain. Similarly, antenna ports 2, 3, 14 and 15 are in a same CDM group (i.e., CDM group 1), where the four antenna ports are differentiated by orthogonal codes in the frequency domain. Similarly, antenna ports 4, 5, 16 and 17 are in a same CDM group (i.e., CDM group 2), where the four antenna ports are differentiated by orthogonal codes in the frequency domain.

FIG. 8B illustrates another example PUSCH DM-RS 850 of enhanced configuration type 2 according to embodiments of the present disclosure. For example, PUSCH DM-RS 850 of enhanced configuration type 2 can be implemented by any of the UEs 111-116 of FIG. 1. This example is for illustration only and can be used without departing from the scope of the present disclosure.

As illustrated in FIG. 8B, with double DM-RS symbols, the PUSCH DM-RS 850 supports 24 antenna ports 0-23. Further, antenna ports 0, 1, 6, 7, 12, 13, 18 and 19 are in a same CDM group (i.e., CDM group 0), where the eight antenna ports are differentiated by orthogonal codes in the frequency domain and orthogonal codes in the time domain. Similarly, antenna ports 2, 3, 8, 9, 14, 15, 20 and 21 are in a same CDM group (i.e., CDM group 1), where the eight antenna ports are differentiated by orthogonal codes in the frequency domain and orthogonal codes in the time domain. Similarly, antenna ports 4, 5, 10, 11, 16, 17, 22 and 23 are in a same CDM group (i.e., CDM group 2), where the eight antenna ports are differentiated by orthogonal codes in the frequency domain and orthogonal codes in the time domain. In various embodiments, enhanced configuration type 2 is used when transform precoding is not enabled.

Sounding reference signal (SRS) is an uplink reference signal that is used for sounding (i.e., channel state or quality estimation) the UL channel between the UE and the gNB. In case of reciprocity between UL and DL, the channel sounding of the UL channel can also be used for link adaptation and precoding on the DL channel from the gNB to the UE. SRS is transmitted independent of data transmissions on the UL. The SRS usage can be one of: beamManagement, codebook, nonCodebook, antennaSwitching, this is in addition to SRS for positioning.

In NR, SRS resources are configured by the network, for example, as part of RRC setup or RRC reconfiguration. SRS resources are configured in SRS resource sets. An SRS resource set includes a set of SRS resources, and defines the following parameters: (1) resourceType, which determines the time domain behavior of SRS, SRS can be aperiodic, semi-persistent or periodic. (2) usage, which can be one of: beamManagement, codebook, nonCodebook or antennaSwitching. (3) information related to power control and TCI state.

The configuration of the SRS resource includes the following: (1) information related to the transmission comb, including comb size, comb offset and cyclic shift. (2) Information related to time domain resource mapping including starting symbol within a slot, number of SRS symbols and repetition factor. (3) information related to frequency domain including freqDomainPosition N_RRC, freqDomainShift n_shift, and frequency hopping parameters c-SRS, b-SRS, and b-hop. (4) Information related to group or sequence hopping, whether one of them or neither is enabled. (5) for periodic and semi-persistent SRS, the periodicity and offset of the SRS resource. (6) Sequence ID. (7) Information related to the TCI state or spatial relation info.

In 5G NR, a UE can transmit a sounding reference signal (SRS). A SRS resource is configured by higher layer IE SRS-Resource.

The SRS sequence is a low PAPR sequence of length

$${N}_{ZC} = {M}_{sc , b}^{SRS}$$

given by:

$${r}^{( p )} ( n , {l}^{′} ) = {r}_{u , v}^{( α , δ )} ( n ) = {e}^{j α n} {\overline{r}}_{u , v} ( n ) , 0 \leq n < {M}_{ZC} ,$$

where

$${M}_{ZC} = m {N}_{sc}^{RB} / {2}^{δ} ,$$

δ=log(K_{TC}), with K_{TC}, being the transmission comb number, is provided in higher layer IE transmissionComb, K_{TC}∈{2,4,8}. l′ is the SRS symbol within a SRS resource of a slot,

$${l}^{′} ∈ \{ 0 , 1 , … , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , max}} , and \\ {n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max} with {n}_{SRS}^{cs}$$

being provided by higher layer in IE transmissionComb,

$${n}_{SRS}^{cs , max}$$

depends on K_{TC}, as own in Table 2 below.

TABLE 2

| K_{TC} | ${n}_{SRS}^{cs , max}$ |
|---|---|
| 2 | 8 |
| 4 | 12 |
| 8 | 6 |

In the present disclosure, u is the group number u∈{0, 1, . . . , 29}, ν is the base sequence number, with ν∈{0}, if 6≤N_{ZC}≤60 and ν∈{0, 1}, if 60<N_{ZC}. The base sequence, r̅_{u,ν}(n), is generated as follows:
1. For N_{ZC}∈{6,12,18,24}, r̅_{u,ν}(n)=e^{jφ(n)π/4}, with 0≤n<M_{ZC}−1. φ(n) is given by Tables 5.2.2.2-1 to 5.2.2.2-4 of TS 38.211.
2. For

$${N}_{ZC} = 30 , {\overline{r}}_{u , v} ( n ) = {e}^{- j \frac{π ( u + 1 ) ( n + 1 ) ( n + 2 )}{31}} ,$$

with 0≤n<M_{ZC}−1.
3. For N_{ZC}≥30, r̅_{u,ν}(n)=x_{q}(n mod N_{ZC}),

$${x}_{q} ( n ) = {e}^{- j \frac{π q m ( m + 1 )}{{N}_{ZC}}} .$$

N_{ZC} is the largest prime number less than

$${M}_{ZC \cdot } q = ⌊ \overline{q} + 1 / 2 ⌋ + v \cdot {( - 1 )}^{⌊ 2 \overline{q} ⌋} \cdot \overline{q} = {N}_{ZC} \frac{u + 1}{31} .$$

The sequence group u is given by:

$$u = ( {f}_{gh} ( {n}_{s , f}^{μ} , {l}^{′} ) + {n}_{ID}^{SRS} ) .$$

### Where,

$${n}_{ID}^{SRS}$$

is provided by higher layer parameter sequenceID, with

$${n}_{ID}^{SRS} ∈ \{ 0 , 1 , … , 65535 \} .$$

Higher layer parameter groupOrSequenceHopping determines the values of u and ν:
if groupOrSequenceHopping equals ‘neither’, neither group, nor sequence hopping shall be used and

$${f}_{g h} ( {n}_{s , f}^{μ} , {l}^{′} ) = 0 ,$$

anu ν=0.
if groupOrSequenceHopping equals ‘groupHopping’, group hopping but not sequence hopping is used and ν=0, and

$${f}_{g h} ( {n}_{s , f}^{μ} , {l}^{′} ) = ( {\sum }_{m = 0}^{7} c ( 8 ( {n}_{s , f}^{μ} {N}_{s y m b}^{slot} + {l}_{0} + {l}^{′} ) + m ) \cdot {2}^{m} ) mod 30 , {N}_{s y m b}^{slot}$$

is the number of symbols in a slot, l₀ is the first SRS symbols in the slot, and c(n) a length-31 Gold sequence defined as c(n)=(x₁(n+N_{c})+x₂(n+N_{c}) mod 2, with N_{c}=1600, x₁(n+31)=(x₁(n+3)+x₁(n) mod 2, x₂(n+31)=(x₂(n+3)+x₂(n+2)+x₂(n+1)+x₂(n) mod 2, the first m-sequence is initialized with x₁(0)=1, and x₁(n)=0, for n=1, 2, . . . 30. The second m-sequence is initialized with cᵢₙᵢₜ, where

$${c}_{init} = {n}_{ID}^{SRS}$$

if groupOrSequenceHopping equals ‘sequenceHopping’, sequence hopping but not group hopping is used and

$${f}_{g h} ( {n}_{s , f}^{μ} , {l}^{′} ) = 0$$

and

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{s c}^{R B} \\ 0 & otherwise\end{matrix}$$

$${N}_{s y m b}^{slot}$$

is the number or symbols in a slots, l₀ is the first SRS symbols in the slot, and c(n) a length-31 Gold sequence as previously defined.

The SRS sequence, r^{(p)}n, l′) is mapped to resource elements

$${a}_{k , l}^{( p )}$$

within a slot, where k is the sub-carrier frequency, l is the symbol number within the slot and p is the antenna port, where for SRS with antenna port p,

$${a}_{k , l}^{( p )}$$

is given by:

$${a}_{k , l}^{( p )} = {β}_{SRS} {r}^{( p )} ( {k}^{′} , {l}^{′} ) ,$$

$$l = {l}^{′} + {l}_{0} ,$$

where, β_{SRS} is a scaling factor,

$${k}^{′} = 0 , 1 , … , {M}_{sc , b}^{SRS} - 1 , {M}_{sc , b}^{SRS} = {m}_{SRS , b} {N}_{sc}^{RB} / {K}_{TC} , {m}_{SRS , b}$$

is provided by Table 6.4.14.3-1 of TS 38.211, and

$${l}^{′} = 0 , 1 , … , {N}_{symb}^{SRS} - 1 .$$

The time domain position of SRS symbols l is determined by higher layer parameter startPosition (l₀), and higher layer parameter

$$nrofSymbols ( {N}_{symb}^{SRS} ) .$$

l=l′+l₀, with l₀ the first SRS symbol in the slot, where l₀∈{0, 1, . . . , 13}. The repetition factor R provided by higher layer parameter repetitionFactor provides the number of SRS symbols used for each frequency hop within a slot, when frequency hopping is enabled as described later, where

$$R \leq {N}_{symb}^{SRS} .$$

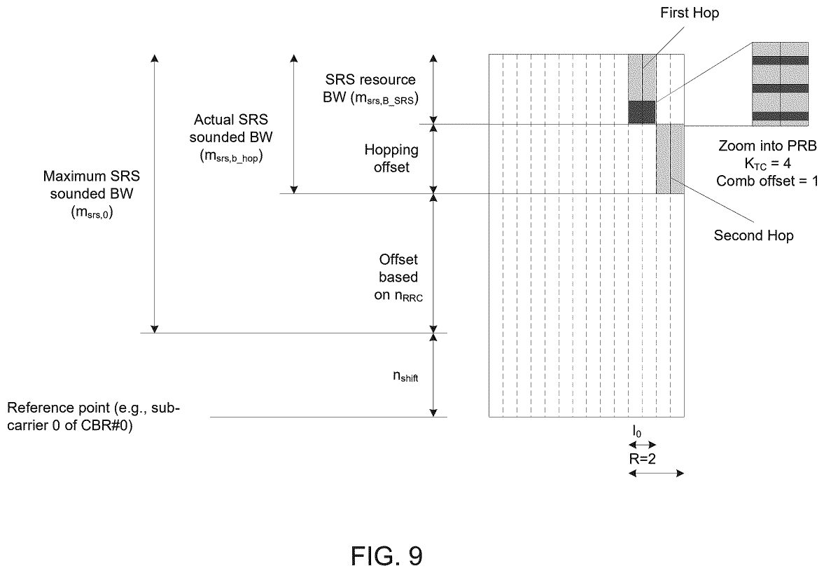

FIG. 9 illustrates an example SRS 900 according to embodiments of the present disclosure. For example, SRS 900 can be implemented by any of the UEs 111-116 of FIG. 1. This example is for illustration only and can be used without departing from the scope of the present disclosure.

In the example of FIG. 9, l₀=10, i.e., symbol index 10 is the starting symbol of the SRS 900, there are 4 SRS symbols in the slot

$${N}_{s y m b}^{SRS} = 4 ,$$

and the repetition factor R=2, where the SRS 900 is transmitted in two consecutive symbols in each frequency hop.

The frequency domain position of SRS sub-carriers k consists of two components, (1) the comb offset, which determines which of the K_{TC} sub-carriers to use for SRS transmission, (2) the SRS RBs used for SRS transmission, which determines the starting RB and the number of RBs for SRS.

The comb offset is determined by higher layer parameter combOffstet. The comb offset can also depend on the SRS antenna port, and for SRS for positioning, on the SRS symbol index within the slot as described in the following. In the example of FIG. 9, K_{TC}=1, with a comb offset of 1. The comb offset is the same in each symbol (e.g., SRS for MIMO).

The SRS RBs are determined by following higher layer parameters:
c-SRS (C_{SRS}) in higher layer parameter freqHopping. C_{SRS} selects a bandwidth configuration for the SRS resource, corresponding to a row in Table 6.4.1.4.3-1 of TS 38.211. C_{SRS} is in the range of {0, 1, . . . , 63}. The parameter m_{SRS,0} in the selected row, determines the maximum SRS bandwidth that can be sounded as illustrated in FIG. 9.
b-SRS (B_{SRS}) in higher layer parameter freqHopping. B_{SRS} determines the transmission bandwidth of the SRS resource, as illustrated in FIG. 9, based on the selected row of Table 6.4.1.4.3-1 of TS 38.211. B_{SRS} is in the range of {0, 1, 2, 3}, and corresponds to a column in Table 6.4.1.4.3-1 of TS 38.211.
b-hop (bₕₒₚ) in higher layer parameter freqHopping. bₕₒₚ determines the actual SRS bandwidth that is sounded, using multiple frequency hops, as illustrated in FIG. 9, based on the selected row of Table 6.4.1.4.3-1 of TS 38.211. bₕₒₚ is in the range of {0, 1, 2, 3}, and corresponds to a column in Table 6.4.1.4.3-1 of TS 38.211. If bₕₒₚ<B_{SRS}, frequency hopping is enabled. Otherwise, bₕₒₚ≥B_{SRS}, frequency hopping is disabled, and the actual SRS bandwidth that is sounded is determined by b=min (B_{SRS}, bₕₒₚ) based on the selected row of Table 6.4.1.4.3-1 of TS 38.211.
freqDomainShift (n_{shift}), in units of RBs in the range {0, 1, . . . 268}, adjust the SRS allocation with respect to a reference point as illustrated in FIG. 9. If

$${N}_{BWP}^{s t a r t} \leq {n}_{shift}$$

the reference point for

$${k}_{0}^{( p )}$$

is sub-carrier 0 in common resource block (CRB) 0, otherwise the reference point is the lowest subcarrier of the BWP.
freqDomainPosition (N_{RRC}), in units of four RBs in the range {0, 1, . . . 67}, determines the position of the actual SRS bandwidth as illustrated in FIG. 9, based on bₕₒₚ, within the maximum SRS bandwidth, based on m_{SRS,0}.
When SRS frequency hopping is enabled, the location of the frequency hop depends on a SRS counter N_{SRS} that counts the number of SRS instances.
   For aperiodic SRS, n_{SRS}=└l′/R┘.
   For periodic and semi-persistent SRS,

$${n}_{s r s} = ( \frac{{N}_{slot}^{f r ame , μ} {n}_{f} + {n}_{s , f}^{μ} - {T}_{offset}}{{T}_{S R S}} ) \cdot ( \frac{{N}_{s y m b}^{S R S}}{R} ) + ⌊ \frac{{l}^{′}}{R} ⌋ ,$$

for slots that satisfy

$$( {N}_{slot}^{f r a m e , μ} {n}_{f} + {n}_{s , f}^{μ} - {T}_{offset} ) mod {T}_{S R S} = 0. {T}_{SRS}$$

is the SRS periodicity, and T_{offset} is the SRS offset.

As introduced above,

$$k = {K}_{T C} {k}^{′} + {k}_{0}^{( {p}_{i} )} ,$$

K_{TC} is the transmission comb number as previously described,

$${k}_{0}^{( p )} = {\overline{k}}_{0}^{( p )} + {\sum }_{b = 0}^{{B}_{S R S}} {K}_{T C} {M}_{sc , b}^{S R S} {n}_{b} , {\overline{k}}_{0}^{( {p}_{i} )} = {n}_{shift} {N}_{s c}^{R B} + ( {k}_{T C}^{( {p}_{i} )} + {k}_{offset}^{{l}^{′}} ) mod {K}_{T C} , {k}_{T C}^{( {p}_{i} )} = \{ \begin{matrix}( {\overline{k}}_{T C} + {K}_{T C} / 2 ) mod {K}_{T C} & if {n}_{S R S}^{c s} ∈ \{ \frac{{n}_{S R S}^{cs , max}}{2} , … , {n}_{S R S}^{cs , max} - 1 \} and {N}_{a p}^{S R S} = 4 and {p}_{i} ∈ \{ 1001 , 1003 \} \\ {\overline{k}}_{T C} & otherwise\end{matrix} ,$$

k̅_{TC} is the transmission comb offset included within higher layer IE transmissionComb, with k̅_{TC}∈{0, 1, . . . , K_{TC-1}}, and

$${k}_{offset}^{{l}^{′}}$$

is a symbol dependent sub-carrier offset given by Table 3 below.

TABLE 3
${k}_{offset}^{0} , {k}_{offset}^{1} , … , {k}_{offset}^{{N}_{symb}^{SRS} - 1}$

| K_{TC} | ${N}_{symb}^{SRS} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
|---|---|---|---|---|---|
| 2 | 0 | 0, 1 | 0, 1, 0, 1 | — | — |
| 4 | — | 0, 2 | 0, 2, 1, 3 | 0, 2, 1, 3, | 0, 2, 1, 3, 0, 2, |
| 8 | — | — | 0, 4, 2, 6 | 0, 2, 1, 3 | 1, 3, 0, 2, 1, 3 |
| | | | | 0, 4, 2, 6, | 0, 4, 2, 6, 1,5, |
| | | | | 1, 5, 3, 7 | 3, 7, 0, 4, 2, 6 |

Further, n_{shift} is given by higher layer parameter freqDomainShift and it adjusts the frequency allocation with respect to a reference point. If

$${N}_{BWP}^{start} \leq {n}_{shift}$$

the reference point for

$${k}_{0}^{( p )}$$

is sup-carrier 0 in common resource block 0, otherwise the reference point is the lowest subcarrier of the BWP. n_{b} is a frequency positioning index. If frequency hopping is disabled (i.e., bₕₒₚ≥B_{SRS} as aforementioned), n_{b} remains constant and is given by:

$${n}_{b} = ⌊ \frac{4 {n}_{RRC}}{{m}_{SRS , b}} ⌋ mod {N}_{b} .$$

n_{RRC} is given by higher layer parameter freqDomainPosition, and m_{SRS,b} and N_{b} are determined by Table 6.4.14.3-1 of TS 38.211 for the configured value of C_{SRS}.

If frequency hopping is enabled (i.e., bₕₒₚ<B_{SRS} as aforementioned), n_{b} depends on the SRS counter (n_{SRS}) and is given by:

$${n}_{b} = \{ ( \begin{matrix}⌊ 4 {n}_{R R C} / {m}_{SRS , b} ⌋ mod {N}_{b} & b \leq {b}_{h o p} \\ ( {F}_{b} ( {n}_{S R S} ) + ⌊ 4 {n}_{R R C} / {m}_{S R S , b} ⌋ ) mod {N}_{b} & othe r w i s e\end{matrix} ) ,$$

where, F_{b}(n_{SRS}) is given by:

$${F}_{b} ( {n}_{S R S} ) = \{ \begin{matrix}( {N}_{b} / 2 ) ⌊ \frac{{n}_{SRS} mod {\prod }_{{b}^{′} = {b}_{hop}}^{b - 1} {N}_{{b}^{′}}}{{\prod }_{{b}^{′} = {b}_{hop}}^{b - 1} {N}_{{b}^{′}}} ⌋ + ⌊ \frac{{n}_{SRS} mod {\prod }_{{b}^{′} = {b}_{hop}}^{b - 1} {N}_{{b}^{′}}}{{\prod }_{{b}^{′} = {b}_{hop}}^{b - 1} {N}_{{b}^{′}}} ⌋ & if {N}_{b} is even \\ ⌊ {N}_{b} / 2 ⌋ ⌊ {n}_{SRS} / {\prod }_{{b}^{′} = {b}_{hop}}^{b - 1} {N}_{{b}^{′}} ⌋ & if {N}_{b} is odd\end{matrix} ,$$

and where N_{b}_{ₕₒₚ}=1 regardless of the values of N_{b}.

The SRS resource can be configured as periodic, semi-persistent or aperiodic using higher layer parameter resourceType. For periodic and semi-persistent resources, a periodicity, T_{SRS}, and a slot offset, 0, within the periodicity are configured. The allowed values of the periodicity in slots are:

$${T}_{S R S} ∈ \{ 1 , 2 , 4 , 5 , 8 , 10 , 16 , 20 , 32 , 40 , 64 , 80 , 160 , 320 , 640 , 1280 , 2560 \} .$$

Every T_{SRS} slots has a candidate SRS slot. The offset O is with respect to slot 0 of frame 0, the allowed values of offset O where O∈{0, 1, . . . , T_{SRS}−1}. Candidate SRS slots are slots satisfying;

$$( {N}_{slot}^{f r a m e , μ} {n}_{f} + {n}_{s , f}^{μ} - {T}_{offset} ) mod {T}_{S R S} = 0 .$$

Periodic SRS resources are transmitted in slots determined by the periodicity and offset once the UE receives and processes the RRC configuration message, while semi-persistent SRS resources are activated by an MAC CE activation message, and can be deactivated by a MAC CE deactivation message.

Aperiodic SRS resources are triggered by a DCI command. The UE transmits the SRS in a slot with a configured offset from the slot of the DCI command. The offset can be a value between 1 to 32 slots, where for slot offset 1, the SRS slot is the slot after the slot containing the DCI trigger.

Channel state information-reference signal (CSI-RS) is a downlink reference signal that is used for measuring the DL channel (i.e., channel state or quality estimation) between the UE and the gNB. In case of reciprocity between UL and DL, the channel measurement of the DL channel can also be used for link adaptation and precoding on the UL channel from the UE to the gNB. SRS is transmitted independent of data transmissions on the DL. The CSI-RS can be configured for tracking (e.g., tracking reference signal (TRS)), or for CSI measurement or for beam management. In one example, a signal with structure similar to CSI-RS can be transmitted in the UL direction from the UE to the gNB.

CSI-RS is mapped to resource elements outside the PDSCH transmission. The resource mapping depends higher layer configuration:
startPRB and nrofPRBs provide the starting RB index of the measurement (CSI-RS) bandwidth and the allowed size of the measurement (CSI-RS) BW in RBs respectively.
frequencyDomainAllocation is a bitmap that provides the REs used for CSI-RS within an RB. The interpretation of frequencyDomainAllocation is influenced by density and cdm-Type. The frequency domain allocation determines the values of k₀, k₁, k₂ and k₃ used for the starting RB of CDM groups as shown in Table 4 below.
firstOFDMSymbolInTime Domain (l₀) and firstOFDMSymbolInTimeDomain2 (l₁) provide the first OFDM symbol in a slot used for a CMD group of CSI-RS as shown in Table 4 below.
density (ρ) provides the density of CSI-RS in terms of RE/port/RB. The allowed values are:
   3, which is used for tracking reference signal with one antenna port.
   1.
   0.5, when ρ=0.5, the CSI-RS is mapped to even RBs or odd RBs as indicated by the density parameter. Density 0.5 is used for 1, 2, 16, 24 and 32 antenna ports.
nrofPorts (X) provides the number of antenna ports used for CSI-RS, allowed values are in the set {1, 2, 4, 8, 12, 16, 24, 32}.
cdm-Type provides the cdm-Type used for CSI-RS from the set of values {noCDM, fd-CDM2, cdm4-FD2-TD2, cdm8-FD2-TD4}. The allowed cdm-Type depends on the nrofPorts, and determines the number of CMD groups as shown in Table 4 below.

TABLE 4
CSI-RS locations within a slot [38.211]

| | Ports | Density | | | CDM grp | | |
|---|---|---|---|---|---|---|---|
| Row | (X) | (ρ) | cdm-Type | (k̅, l̅) | index | k′ | l′ |
| 1 | 1 | 3 | noCDM | (k₀, l₀), (k₀ + 4, l₀), (k₀ + 8, l₀) | 0, 0, 0 | 0 | 0 |
| 2 | 1 | 1, 0.5 | noCDM | (k₀, l₀) | 0 | 0 | 0 |
| 3 | 2 | 1, 0.5 | fd-CDM2 | (k₀, l₀) | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), (k₃, l₀) | 0, 1, 2, 3 | 0, 1 | 0 |
| 7 | 8 | 1 | fd-CDM2 | (k₀, l₀), (k₁, l₀), (k₀, l₀ + 1), | 0, 1, 2, 3 | 0, 1 | 0 |
| | | | | (k₁, l₀ + 1) | | | |
| 8 | 8 | 1 | cdm4-FD2- | (k₀, l₀), (k₁, l₀) | 0, 1 | 0, 1 | 0, 1 |
| | | | TD2 | | | | |
| 9 | 12 | 1 | fd-CDM2 | (k₀, l₀), (k₁, l₀), (k₂, l₀), | 0, 1, 2, 3, | 0, 1 | 0 |
| | | | | (k₃, l₀), (k₄, l₀), (k₅, l₀) | 4, 5 | | |
| 10 | 12 | 1 | cdm4-FD2- | (k₀, l₀), (k₁, l₀), (k₂, l₀) | 0, 1, 2 | 0, 1 | 0, 1 |
| | | | TD2 | | | | |
| 11 | 16 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), (k₁, l₀ + | 4, 5, 6, 7 | | |
| | | | | 1), (k₂, l₀ + 1), (k₃, l₀ + 1) | | | |
| 12 | 16 | 1, 0.5 | cdm4-FD2- | (k₀, l₀), (k₁, l₀), (k₂, l₀), (k₃, l₀) | 0, 1, 2, 3 | 0, 1 | 0, 1 |
| | | | TD2 | | | | |
| 13 | 24 | 1, 0.5 | fd-CDM2 | (k₀, l₀), (k₁, l₀), (k₂, l₀), | 0, 1, 2, 3, | 0, 1 | 0 |
| | | | | (k₀, l₀ + 1), (k₁, l₀ + 1), | 4, 5, 6, 7, | | |
| | | | | (k₂, l₀ + 1), (k₀, l₁), (k₁, l₁), | 8, 9, 10, 11 | | |
| | | | | (k₂, l₁), (k₀, l₁ + 1), (k₁, l₁ + | | | |
| | | | | 1), (k₂, l₁ + 1) | | | |
| 14 | 24 | 1, 0.5 | cdm4-FD2- | (k₀, l₀), (k₁, l₀), (k₂, l₀), | 0, 1, 2, 3, | 0, 1 | 0, 1 |
| | | | TD2 | (k₀, 1₁), (k₁, l₁), (k₂, l₁) | 4, 5 | | |
| 15 | 24 | 1, 0.5 | cdm8-FD2- | (k₀, l₀), (k₁, l₀), (k₂, l₀) | 0, 1, 2 | 0, 1 | 0, 1, |
| | | | TD2 | | | | 2, 3 |
| 16 | 32 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), (k₁, l₀ + | 4, 5, 6, 7, | | |
| | | | | 1), (k₂, l₀ + 1), (k₃, l₀ + 1), | 8, 9, 10, | | |
| | | | | (k₀, l₁), (k₁, l₁), (k₂, l₁), | 11, 12, 13, | | |
| | | | | (k₃, l₁), (k₀, l₁ + 1), (k₁, l₁ + | 14, 15 | | |
| | | | | 1), (k₂, l₁ + 1), (k₃, l₁ + 1) | | | |
| 17 | 32 | 1, 0.5 | cdm4-FD2- | (k₀, l₀), (k₁, l₀), (k₂, l₀), | 0, 1, 2, 3, | 0, 1 | 0, 1 |
| | | | TD2 | (k₃, l₀), (k₀, l₁), (k₁, l₁), | 4, 5, 6, 7 | | |
| | | | | (k₂, l₁), (k₃, l₁) | | | |
| 18 | 32 | 1, 0.5 | cdm8-FD2- | (k₀, l₀), (k₁, l₀), (k₂, l₀), (k₃, l₀) | 0, 1, 2, 3 | 0, 1 | 0, 1, |
| | | | TD2 | | | | 2, 3 |

The REs within a RB used for CSI-RS, with a sub-carrier k, and symbol l, is given by:

$$k = n {N}_{s c}^{R B} + \overline{k} + {k}^{′} ,$$

$$l = \overline{l} + {l}^{′} ,$$

where,
k̅, k′, l̅ and l′ are provided in Table 4 above. k̅ and l̅ are the starting sub-carrier and symbol of a CDM group respectively. k′ and l′ are the sub-carrier and symbol within the CDM group respectively.
n=0, 1, . . .

$${N}_{sc}^{R B} = 12 sub - carriers .$$

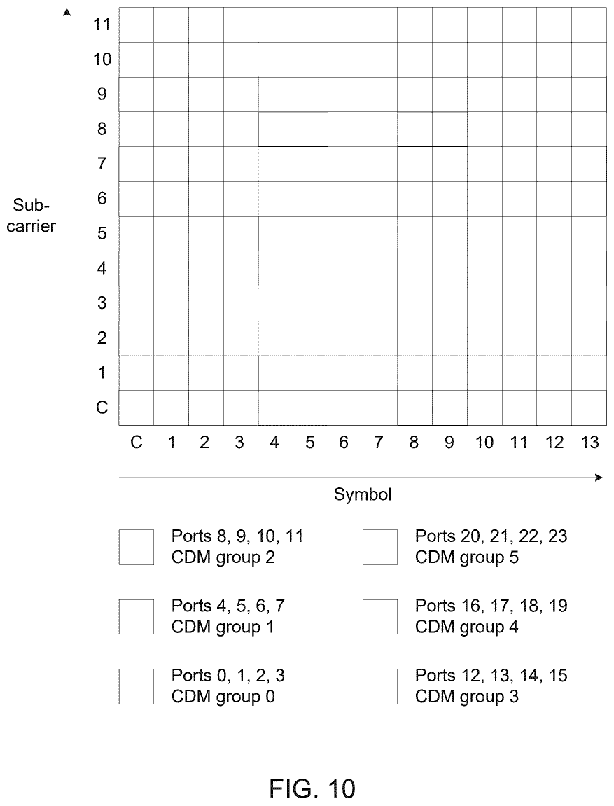

FIG. 10 illustrates example CDM groups 1000 and the ports of each CDM group according to embodiments of the present disclosure. For example, CDM groups 1000 can be utilized by any of the UEs 111-116 of FIG. 1. This example is for illustration only and can be used without departing from the scope of the present disclosure.

As an example, consider the RE allocation for row 14 in Table 4 above. This corresponds to X=24 ports, assume density ρ=1, cdm-Type cdm4-FD2-TD2. Let the frequencyDomainAllocation be 010101, therefore k₀=0, k₁=4 and k₂=8. Let, l₀=4, and l₁=8. In this example, as illustrated in FIG. 10, there are 6 CDM groups, each CDM group consists of 4 ports, and occupies 4 elements, 2 in the frequency domain with k′=0 and 1; by 2 in the time domain with l′=0 and 1.

An antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

In this disclosure, [DEF1] a beam is determined by either of:
A TCI state, that establishes a quasi-colocation (QCL) relationship or spatial relation between a source reference signal (e.g. SSB and/or CSI-RS) and a target reference signal.
A spatial relation information that establishes an association to a source reference signal, such as SSB or CSI-RS or SRS.

Alternatively, [DEF2] a beam can be determined by any of:
A port with a static/fixed (e.g. for FR1) or dynamic virtualization (e.g. FR2, FR3), or
A port group (PG) comprising multiple ports, with a dynamic indication/assignment of one (or two) ports from the multiple ports and associated QCL property=QCL TypeD or spatial relation.

In either case, the ID of the source reference signal or the one (or two) port(s) or the TCI state ID or the spatial relation ID identifies the beam.

Alternatively, [DEF3] a beam can be determined by a pair [A, B], which is any of:

$$[ A , B ] = [ TCI state , port ]$$

$$[ A , B ] = [ TCI state , PG ]$$

$$[ A , B ] = [ Spatial relation information , port ]$$

$$[ A , B ] = [ Spatial relation information , PG ]$$

Where TCI state, Spatial relation information, port and PG are as described above. In this case, a pair of IDs for [A, B] identifies the beam.

According to [DEF1], the TCI state and/or the spatial relation reference RS can determine a spatial Rx filter for reception of downlink channels at the UE, or a spatial Tx filter for transmission of uplink channels from the UE. The TCI state and/or the spatial relation reference RS can also determine a spatial Tx filter for transmission of downlink channels from the gNB, or a spatial Rx filter for reception of uplink channels at the gNB.

Likewise, for [DEF2], the port with dynamic virtualization and/or the PG with dynamic indication of one (or two) ports can determine a spatial Rx filter or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the gNB, or a spatial Rx filter or a port or a PG for reception of uplink channels at the gNB. In one example, a port can be associated with or indicated by a TCI state.

Likewise, for [DEF3], A and B together can determine a spatial Rx filter for reception of downlink channels at the UE, or a spatial Tx filter for transmission of uplink channels from the UE. They can also determine a spatial Tx filter for transmission of downlink channels from the gNB, or a spatial Rx filter for reception of uplink channels at the gNB.

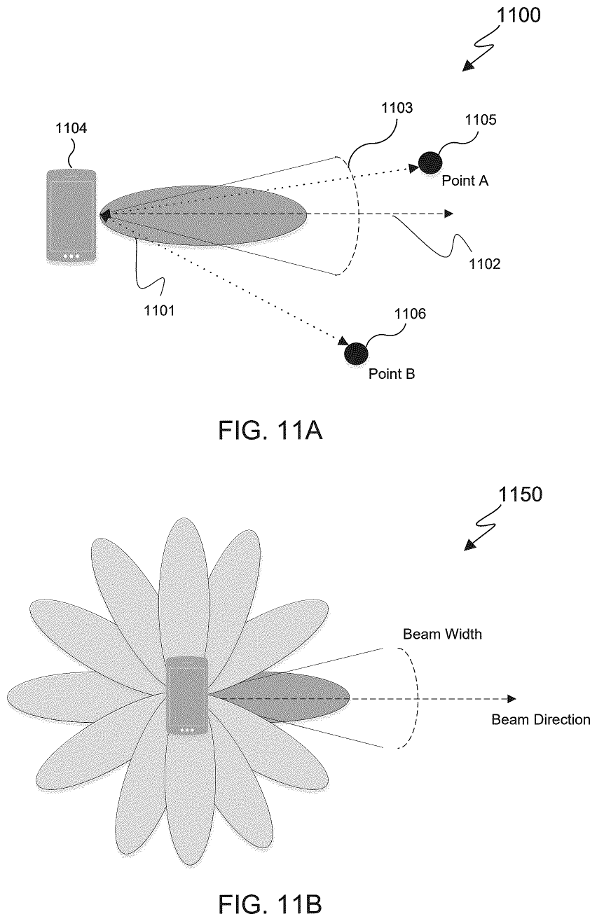

FIG. 11A illustrates an example beam operation 1100 in a wireless communication system according to embodiments of the present disclosure. For example, beam operation 1100 can be implemented by gNB 102 and/or any of the UEs 111-116 of FIG. 1. This example is for illustration only and other embodiments can be used without departing from the scope of the present disclosure.

As illustrated in FIG. 11A, in a wireless system, a beam (1101), for a device (1104), can be characterized by a beam direction (1102) and a beam width (1103). For example, a device (1104) transmits radio frequency (RF) energy in a beam direction and within a beam width. A device (1104) receives RF energy in a beam direction and within a beam width. As illustrated in FIG. 11A, a device at point A (1105) can receive from and transmit to device (1104) as Point A is within a beam width and direction of a beam from device (1104). As illustrated in FIG. 11A, a device at point B (1106) cannot receive from and transmit to device (1104) as Point B is outside a beam width and direction of a beam from device (1104). While FIG. 11A, for illustrative purposes, shows a beam in 2-dimensions (2D), it should be apparent to those skilled in the art, that a beam can be in 3-dimensions (3D), where the beam direction and beam width are defined in space.

FIG. 11B illustrates an example multi-beam operation 1150 in a wireless communication system according to embodiments of the present disclosure. For example, multi-beam operation 1150 can be implemented by gNB 102 and/or any of the UEs 111-116 of FIG. 1. This example is for illustration only and other embodiments can be used without departing from the scope of the present disclosure.

As illustrated in FIG. 11B, in a wireless system, a device can transmit and/or receive on multiple beams. This is known as “multi-beam operation.” While FIG. 11B, for illustrative purposes, shows beams in 2D, it should be apparent to those skilled in the art, that beams can be 3D, where the beams can be transmitted to or received from any direction in space.

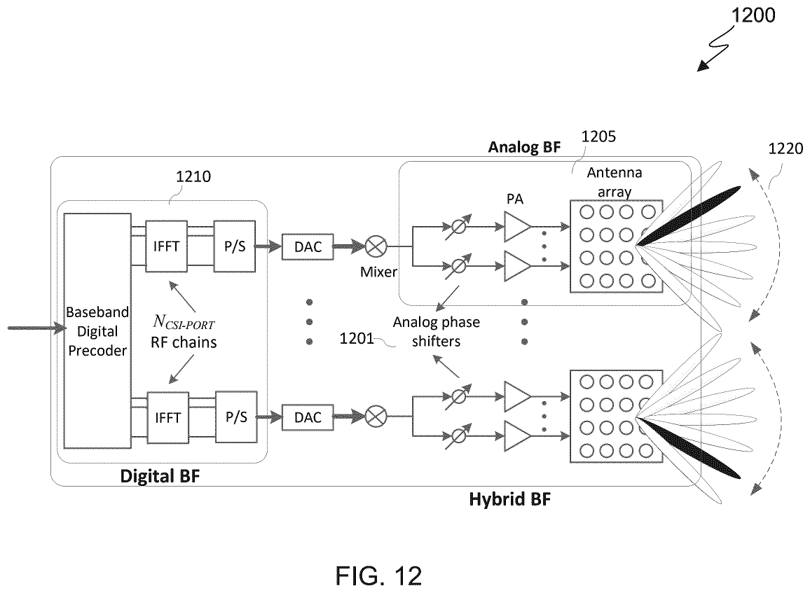

FIG. 12 illustrates an example of a transmitter structure 1200 for beamforming according to embodiments of the present disclosure. In certain embodiments, one or more of gNB 102 or UE 116 includes the transmitter structure 1200. For example, one or more of antenna 205 and its associated systems or antenna 305 and its associated systems can be included in transmitter structure 1200. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 12. Then, one CSI-RS port can be mapped onto a large number of antenna elements that can be controlled by a bank of analog phase shifters 1201. One CSI-RS port can then correspond to one sub-array which produces a narrow analog beam through analog beamforming 1205. This analog beam can be configured to sweep across a wider range of angles 1220 by varying the phase shifter bank across symbols or slots/subframes. The number of sub-arrays (equal to the number of RF chains) is the same as the number of CSI-RS ports N_{CSI-PORT}. A digital beamforming unit 1210 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 1200 of FIG. 12 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 12 is also applicable to higher frequency bands such as >52.6 GHz. In this case, the system can employ only analog beams. Due to the 02 absorption loss around 60 GHz frequency (~10 dB additional loss per 100 m distance), a larger number and narrower analog beams (hence a larger number of radiators in the array) are essential to compensate for the additional path loss.

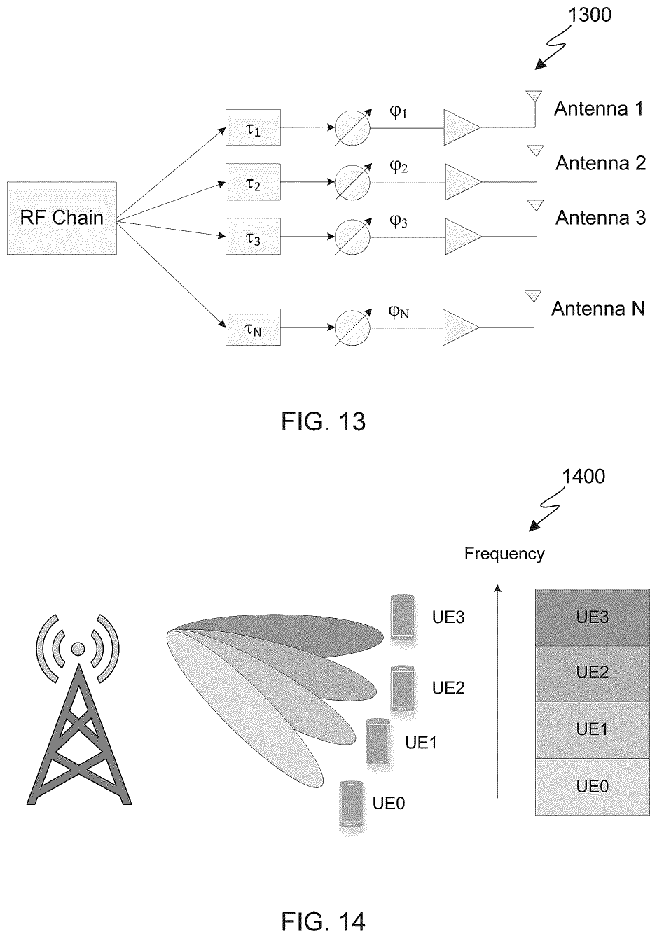

FIG. 13 illustrates an example joint phase-time arrays (JPTA) structure 1300 for wireless systems according to embodiments of the present disclosure. For example, JPTA structure 1300 can be implemented by gNB 102 and/or any of the UEs 111-116 of FIG. 1. This example is for illustration only and other embodiments can be used without departing from the scope of the present disclosure.

JPTA is a technique for wireless systems, especially in mmWave. As illustrated in FIG. 13, the output of the RF chain is split into N paths for the N antennas, where, each path includes a True-Time-Delay block (τ₁, τ₂, . . . , τ_{N}) followed by a phase shifter (φ₁, φ₂, φ_{N}) before going to the antenna. As a result of this structure and by properly designing the JPTA parameters, e.g., (τ₁, τ₂, . . . , τ_{N}) and (φ₁, φ₂, φ_{N}), different groups of sub-carriers can have different beams pointing in different directions.

FIG. 14 illustrates an example beam operation 1400 utilizing JPTA according to embodiments of the present disclosure. For example, beam transmission configuration 1400 can be implemented by gNB 102 and/or any of the UEs 111-116 of FIG. 1. This example is for illustration only and other embodiments can be used without departing from the scope of the present disclosure.

As illustrated in FIG. 14, using the JPTA structure, the network is able to transmit in M different directions (e.g., M beams) using M different sub-bands, e.g., sub-band i is associated with beam i, wherein, i=0, 1, . . . , M−1. The example, of FIG. 14, M=4 and the transmission is to 4 different UEs. In this disclosure a sub-band can refer to any frequency domain region (e.g., sub-carriers, RBs or sub-channels).

To access the network, a UE monitors and receives synchronization signal/physical broadcast channel (PBCH) Blocks, referred to as SSB blocks. This allows the UE to establish time and frequency synchronization with the network and receive information (e.g., in master information block (MIB)) on the PBCH channel to access the network. In NR, up to 8 different SSBs can be transmitted in FR1 and up to 64 different SSBs can be transmitted in FR2. Each SSB can be associated with a quasi-co-location or a beam. The SSBs are time division multiplexed as described in TS 38.213. The SSBs repeat every time period T. For example, T can be 5 ms, 10 ms, 20 ms, 40 ms, 80 ms, or 160 ms. The period T can be configured by higher layers. In one example, a UE initially accessing the network can assume a default period T, for example the default period can be 20 ms.

With analog-based beamforming, a single beam is used at time t, hence the time division multiplexing of the SSBs that can be using different beams. However, if JPTA is leveraged, at time t there could be M different sub-bands as illustrated in FIG. 14, each sub-band can be on different beam. Each sub-band can include a different SSB, hence leveraging time-frequency multiplexing of SSBs.

Other multi-antenna architectures that support simultaneous transmissions on multiple beams and/or simultaneous reception on multiple beams can be used.

Rel-17 introduced the unified TCI framework, where a unified or main or indicated TCI state is signaled to the UE. The unified or main or indicated TCI state can be one of:
1. In case of joint TCI state indication, wherein a same beam or port/PG is used for DL and UL channels, a joint TCI state that can be used at least for UE-dedicated DL channels and UE-dedicated UL channels.
2. In case of separate TCI state indication, wherein different beams or ports/PGs are used for DL and UL channels, a DL TCI state that can be used at least for UE-dedicated DL channels.
3. In case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on PDSCH/PDCCH or dynamic-grant/configured-grant based PUSCH and all of dedicated PUCCH resources.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g. format 0_1 or 0_2), or a purposed-designed DCI (or channel) for TCI state indication, wherein the DCI format includes a “transmission configuration indication” field that includes/indicates a TCI state code point out of the TCI state code points activated by a MAC CE. A DL related DCI format (or an UL related DCI format or purpose-design DCI or channel) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. Alternatively, a purpose designed DCI Format can be used to indicate a TCI state. A TCI state (TCI state code point) indicated/included in a DL related DCI format or UL related DCI format or a purposed designed DCI Format is applied after a beam application time from the corresponding HARQ-ACK feedback.

In FR2, the UE and gNB use narrow beams to communicate with each other, as the UE moves within a cell or as the surrounding environment changes, the UE can move outside the coverage area of a beam used for communication between the UE and the gNB, and a new beam can be used for communication between the UE and the gNB. This disclosure provides aspects related to beam tracking as the UE moves or as the channel conditions change.

Wireless mobile network operating in FR2, from 24 GHz to 71 GHz, and FR3, e.g., from 7 (or 7.125) GHz to 24 GHz, rely on beam-based operation for communication between wireless devices, e.g., gNB and UE. As aforementioned, a beam is formed by a spatial domain filter that focuses the transmitted signal from a device in a certain direction within a certain beam width. Similarly, for a receiver, a beam or reception spatial domain filter allows the device to receive signals from a certain direction and within a certain beam width. For beam-based operation, a network device (e.g., gNB) can transmit DL signals within different spatial domain filters (or beams). For example, the DL signals can be channel state information reference signals (CSI-RS) or Synchronization Signal/Physical Broadcast Channel (SS/PBCH) Blocks, also referred to as SSBs. In one example, DL signals transmitted with different beams can be demodulation reference signals (DM-RS). Similarly, for beam-based operation, a device (e.g., UE) can transmit UL signals within different spatial domain filters (or beams). For example, the UL signals can be sounding reference signals (e.g., SRS) as described in this disclosure. In one example, UL signals transmitted with different beams can be demodulation reference signals (DM-RS) as described in this disclosure. A receiving device (e.g., gNB) measures a quality of the UL signals transmitted on different beams. In one example, the gNB can use measurement of the UL signals to determine a beam for transmission, for example, an UL beam (UL spatial domain filter), or in case of beam reciprocity, a DL beam (DL spatial domain filter). In a variant example, the gNB can transmit measurement report (e.g., based on the measurement of the UL signals) to the UE, the measurement report can include one or more resource IDs associated with the UL signals and corresponding quality measurement. The quality can be an absolute quality or a differential quality (e.g., relative to the quality of the first/strongest resource). In one example, the quality can be Layer 1 reference signal received power (L1-RSRP), or Layer 3 RSRP (L3-RSRP). L1-RSRP can be the instantaneous RSRP from one instance of the UL signal. L3-RSRP can be averaged RSRP (e.g., exponential averaging or sliding window) over multiple instances of the UL signal. Various embodiments use RSRP to refer to L1-RSRP or L3-RSRP. In one example, the quality can be L1 signal-to-interference-and-noise ratio (L1-SINR), or L3-SINR. L1-SINR can be the instantaneous SINR from one instance of the UL signal. L3-SINR can be averaged SINR (e.g., exponential averaging or sliding window) over multiple instances of the UL signal. Various embodiments use SINR to refer to L1-SINR or L3-SINR. In one example, the quality can be channel quality indicator (CQI). In one example, the quality can be modulation coding (MCS), e.g., MCS to achieve a certain target error rate (e.g., block error rate (BLER)), e.g., 10% BLER. In one example, the quality can be BLER, e.g., BLER for a reference MCS.

Based on the measurement, the network selects a beam (for UL channels/signals and/or DL channels/signals) and signals the beam (e.g., beam indication) to the UE using a DCI Format or a MAC CE. The beam is signaled as a TCI state ID or TCI state code point. The signal conveying the beam indication is acknowledged, and after signal conveying the acknowledgment by a beam application time (BAT), the beam is applied.

The aforementioned procedure for finding and applying new beams can be slow. The latency of finding and applying a new beam depends on the periodicity of the measurement reference signal. With low-periodicity of measurement reference signals latency can be lowered at the expense of overhead. Alternatively, the measurement reference signals can be event triggered (rather than periodic), the measurement reference signals can be triggered when the channel quality degrades, but this is a reactive procedure leading to longer latencies.

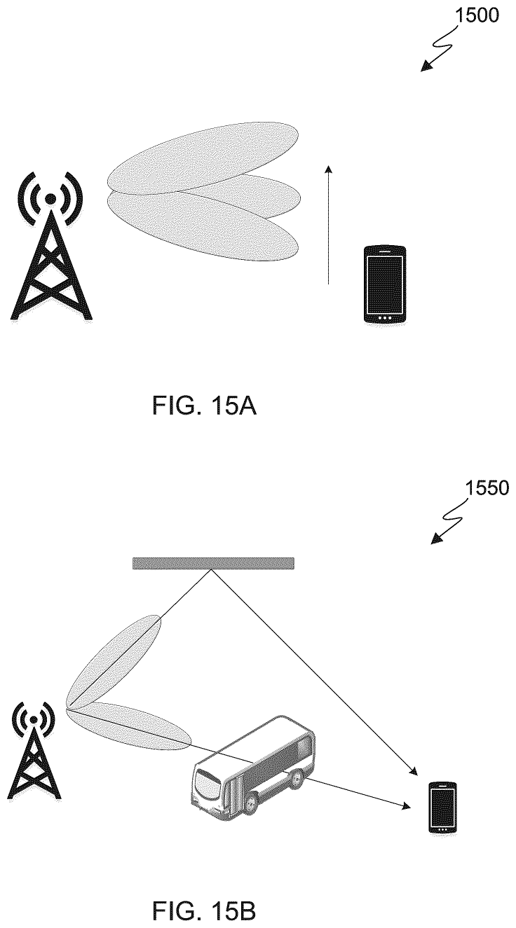

FIGS. 15A-15B illustrate example beam operations 1500 and 1550 according to embodiments of the present disclosure. For example, beam transmission configurations 1500 and 1550 can be implemented by gNB 102 and/or any of the UEs 111-116 of FIG. 1. This example is for illustration only and other embodiments can be used without departing from the scope of the present disclosure.

In FR2, beams can change due to the UE's mobility as illustrated in FIG. 15A, this can apply to the case of mobile communications. As the user's position changes, or due to device rotation, a new and better beam can be selected for communication between the gNB and the UE. Beams can also change due to change in channel conditions, for example, a beam can become blocked and an alternative beam is used instead as illustrated in FIG. 15B, this can apply to fixed wireless communications as well as mobile communication.

Based on the above discussion, fast identification, indication and application of new beams, e.g., beam tracking would provide a more reliable communication link and better link quality. Various embodiments provide methods to improve beam measurement, reporting and indication (e.g., beam tracking) by reducing latency and overhead of measurement signals. The procedures discussed in the disclosure, can leverage simultaneous multi-beam operation of device (e.g., gNB or UE), by transmitting multiple reference signals simultaneously on different beams. In one example, the reference signals transmitted on multiple beams, can be transmitted with UL data (e.g., PUSCH or PUCCH). In another example, the reference signals transmitted on multiple beams can be transmitted outside of the UL data, e.g., using SRS like structure. In another example, the reference signal can have a physical signal structure similar to the physical signal structure of CSI-RS.

As introduced above, the present disclosure relates to a 5G/NR and/or 6G communication system.

In this disclosure, the beam tracking reference signals can be transmitted with the UL transmission. The UE transmits multiple beam tracking reference signals (BT-RS) with the UL transmission (e.g., PUSCH or PUCCH). The spatial relation (or quasi-co-location or TCI state) of the BT-RS signals can be signaled by the network (e.g., gNB), or can be determined by the UE. Alternatively, the BT-RS are transmitted outside the UL data channel or UL control channel, e.g., using SRS, where the spatial relation (or quasi-co-location or TCI state) of the BT-RS signals can be signaled by the network (e.g., gNB), or can be determined by the UE.

In the present disclosure, both FDD and TDD are considered as a duplex method for DL and UL signaling. In addition, full duplex (XDD) operation is possible, e.g., sub-band full duplex (SBFD) or single frequency full duplex (SFFD).

Further, although the present disclosure may assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure considers several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIBI or other SIB) or (2) RRC dedicated signaling that is sent to a specific UE wherein the information can be common/cell-specific information or dedicated/UE-specific information or (3) UE-group RRC signaling.

In this disclosure, MAC CE signaling can be UE-specific e.g., to one UE or can be UE common (e.g., to a group of UEs or to all UEs in a cell). MAC CE signaling can be DL MAC CE signaling or UL MAC CE signaling.

In this disclosure, L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or all UEs in a cell). In this disclosure, L1 control signaling can also use a sequence-based signal, e.g., similar to wake-up-signal (WUS) or e.g., where one of L sequences can be transmitted from the BS to the UE to indicate or convey signaling information to the UE.

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure, a list with N elements can be denoted as L(i), where i can take N values, and L (i) can correspond to the element associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE.

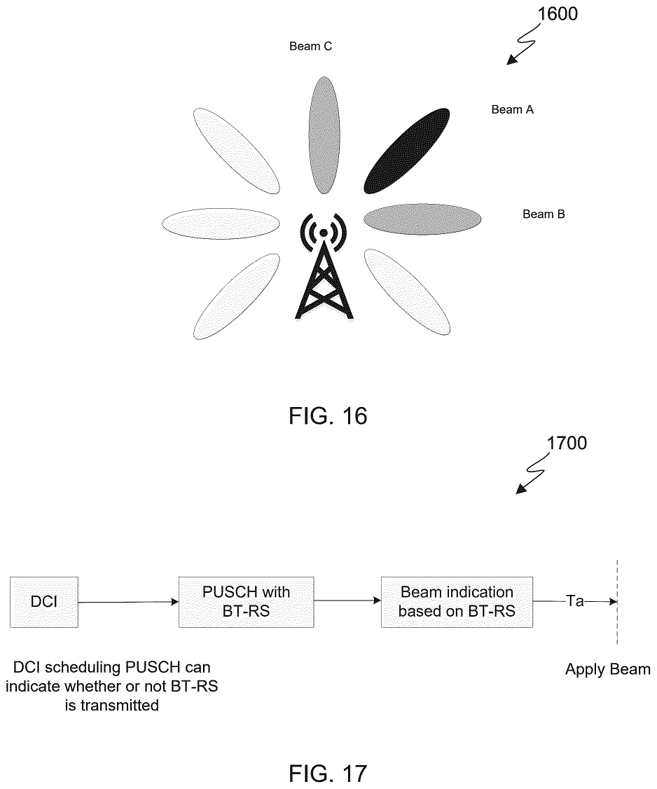

FIG. 16 illustrates an example of a multi-beam system 1600 in a wireless communication system according to embodiments of the present disclosure. For example, multi-beam system 1600 can be implemented by gNB 102 of FIG. 1. This example is for illustration only and other embodiments can be used without departing from the scope of the present disclosure.

As illustrated in FIG. 16, each beam can have a set of adjacent or associated beams. In the example of FIG. 16, beams are shown in 2D and a beam (e.g., Beam A) has two adjacent beams (e.g., Beam B and Beam C). In 3D a beam can have more adjacent beams. As the UE moves, it is likely to move from a first beam to an adjacent or associated beam, by providing signaling to quickly identify and move to a new beam, system performance improves with fewer beam failures.

In the present disclosure, an embodiment of beam tracking reference signal transmitted with UL transmissions is provided.

In one example, the UE can transmit one or more reference signals for beam tracking (for brevity referred to as beam tracking reference signal or BT-RS), as explained in this disclosure, with the PUSCH transmission or the PUCCH transmission. In one example, the beam tracking reference signal(s) can be transmitted/received in the symbol(s) used for DM-RS. In one example, the beam tracking reference signal(s) can be transmitted/received in symbol(s) used for beam tracking reference signals with no DM-RS or UL data as described in this disclosure.

In one example, the UE can be configured by higher layer signaling (e.g., SIB or RRC) whether or not beam tracking reference signals is transmitted with UL channels (e.g., PUSCH or PUCCH). In one example, the UE can be activated (e.g., by MAC CE or L1 control (e.g., DCI Format)), to transmit beam tracking reference signal with UL channels (e.g., PUSCH or PUCCH). In one example, the DCI Format is UE specific. In one example, the DCI Format is to a group of UEs (e.g., group common DCI).

FIG. 17 illustrates an example UE indication 1700 for scheduling the PUSCH according to embodiments of the present disclosure. For example, UE indication 1700 can be implemented by any of the UEs 111-116 of FIG. 1. This example is for illustration only and other embodiments can be used without departing from the scope of the present disclosure.

As illustrated in FIG. 17, in one example, for an instance of a PUSCH, the UE can be indicated by L1 control (e.g., DCI Format) scheduling the PUSCH whether or not to transmit beam tracking reference signals. In one example, the UE can be indicated by L1 control (e.g., DCI Format) scheduling the PUSCH the number of resources M for the beam tracking reference signal included in the PUSCH. In one example, the gNB sends a signal after the UE's transmission of BT-RS, the signal can indicate a preferred beam of the M BT-RS transmitted with the UL data or no beam change (e.g., keep existing beam, e.g., of PUSCH or PUCCH or corresponding DMRS). In one example, the signal can have a size of ┌log₂ M┐ to indicate one of the M BT-RS. In one example, the signal can have a size of ┌log₂(M+1)┐ to indicate one of the M BT-RS or no beam change (or indication of existing beam or DM-RS). In one example, index 0 indicate the existing beam or DM-RS. In one example, after the signal is transmitted by the gNB/received by the UE by a time Tₐ, the beam can be applied as described later in this disclosure. In one example, the gNB can use the measurements of the BT-RS transmitted by the UE for subsequent beam indication, e.g., the beam can be signaled, e.g., as a TCI state or TCI state code point, to the UE in MAC CE activating/indication TCI state(s) or indicated to the UE using a DCI Format conveying a TCI state. In one example, the M BT-RS are associated with M TCI states (e.g., M of the N activated TCI states, or M of the N configured TCI states, wherein M≤N, or M=N). In one example, the M BT-RS are associated with M QCL states. In one example, the M BT-RS are associated with M spatial relations (e.g., M of N activated spatial relations, or M of the N configured spatial relations, wherein M≤N, or M=N). In one example, the M BT-RS have spatial domain filters that are determined by the UE, for example, the UE can use the BT-RS along with the feedback from the network to fine tune its UL spatial domain filter.

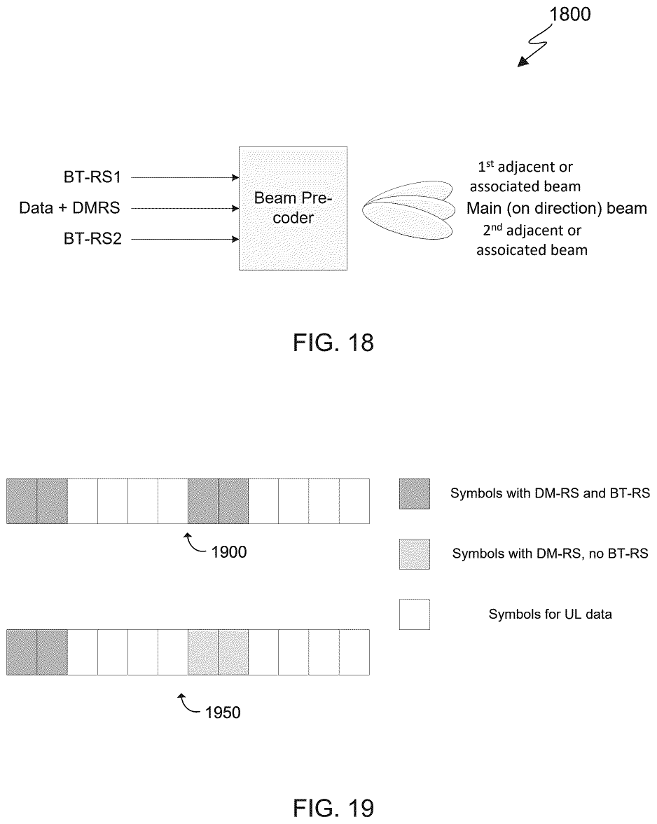

FIG. 18 illustrates an example beam or spatial domain transmission filter 1800 according to embodiments of the disclosure. For example, filter 1800 can be implemented by any of the UEs 111-116 of FIG. 1. This example is for illustration only and other embodiments can be used without departing from the scope of the present disclosure.

In one example, for an UL channel (e.g., PUSCH or PUCCH), the UE transmits the UL channel and the demodulation reference signal of the UL channel using an indicated or main beam (an indicated or main spatial domain transmission filter). In addition, as illustrated in FIG. 18, the UE transmits M beam tracking reference signals (BT-RS) wherein BT-RS i, for i=1, . . . , M, is transmitted using beam or spatial domain transmission filter i. The beam or spatial domain filter i for BT-RS i can be based on:
The gNB signals or indicates a TCI state/spatial relation (or TCI state/spatial relation ID) for each BT-RS of the M BT-RS. In one example, the signaling of M TCI states/spatial relations is by L1 control (e.g., DCI Format) signaling. In one example, the DCI Format is UE specific. In one example, the DCI Format is to a group of UEs (e.g., group common DCI). In one example, the signaling of M TCI states/spatial relations is by MAC CE or RRC signaling. In one example, the M TCI states/spatial relations are from the configured TCI state/spatial relations. In one example, the M TCI states/spatial relations are from the activated TCI state/spatial relations.
The gNB configures an association between the main TCI state of the UL channel (e.g., PUSCH or PUSCH) and M TCI states or spatial relations as illustrated in Table 5 below. Based on the indicated TCI state, the UE determines (based on the configured association), M TCI states/spatial relations for M BT-RS. The main TCI state is the TCI state used to transmit the UL data REs and the associated DM-RS.
The UE selects M TCI states/spatial relations for the M BT-RS. In one example, the UE can signal to the network using L1 UL control information (L1 UCI) and/or MAC CE and/or RRC the M selected TCI states/spatial relations for the M BT-RS. In one example, the M UE-selected TCI states/spatial relations are from the configured TCI state/spatial relations. In one example, the M UE-selected TCI states/spatial relations are from the activated TCI state/spatial relations.
The UE selects M spatial domain transmit filter for the M BT-RS. The UE can use the BT-RS along with the feedback from the network to fine tune its UL spatial domain filter.

TABLE 5

| Main | First adjacent/ | Second adjacent/ | | Mth adjacent/ |
|---|---|---|---|---|
| Beam | associated beam | associated beam | . . . | associated beam |
| TCI0 RS0 | TCI(0, 0) or RS(0, 0) | TCI(0, 1) or RS(0, 1) | . . . | TCI(0, M) or RS(0, M) |
| TCI1 RS1 | TCI(1, 0) or RS(1, 0) | TCI(1, 1) or RS(1, 1) | | TCI(1, M) or RS(1, M) |
| . . . | . . . | . . . | . . . | . . . |

In a variant of FIG. 18, the UE is indicated two (or more)-TCI states, e.g., a first TCI state to communicate with a first TRP and second TCI state to communicate with a second TRP. The UE transmits a first DM-RS and first UL-SCH/UCI, using the first TCI state, or corresponding first spatial relation or first spatial domain transmission filter. The UE transmits a second DM-RS and second UL-SCH/UCI (second UL-SCH/UCI can be same as first UL-SCH/UCI), using the second TCI state, or corresponding second spatial relation or second spatial domain transmission filter. In one example, the UE transmits a first M₁ BT-RS associated with first TCI state or first spatial relation or first spatial domain transmission filter. In one example, the UE transmits a second M₂ BT-RS associated with second TCI state or second spatial relation or second spatial domain transmission filter. In one example, M₁=M₂=M. In one example, M₁ and M₂ can be different.

The term beam tracking reference signal (BT-RS) is used to describe the functionality of the reference signal to be used for beam tracking or identifying new beams as the channel conditions change. The BT-RS transmitted with a UL channel can be configured according to the following examples, as described in this disclosure:
In one example, a DM-RS is configured with N antenna ports, of the N antenna ports No antenna ports follow the spatial domain filter (or beam or TCI state) of the UL channel (e.g., the indicated or main TCI state), N₁ antenna ports use a first spatial domain transmission filter for a first adjacent or associated beam or TCI state, N₂ antenna ports use a second spatial domain transmission filter for a second adjacent or associated beam or TCI state, . . . , N_{M} antenna ports use a Mth spatial domain transmission filter for a Mth adjacent or associated beam or TCI state. In one example, N₀+N₁+N₂ . . . +N_{M}≤N. In one example, N₀+N₁+N₂ . . . +N_{M}=N.
In one example, a DM-RS is configured for BT-RS separate from the DM-RS used for the demodulation of the UL channel. The BT-RS has a physical signal structure similar to DM-RS, but is configured in different resources. In one example, the BT-RS (or DM-RS for beam tracking) can be configured in symbols different from the symbols used for the DM-RS for demodulation. In one example, the BT-RS (or DM-RS for beam tracking) can be configured in resource blocks (RBs) different from the RBs used for the DM-RS for demodulation. In one example, the BT-RS (or DM-RS for beam tracking) can be configured in resource element (REs) different from the REs used for the DM-RS for demodulation. In one example, one DM-RS for beam tracking is configured for M beam tracking reference signals (e.g., different antenna ports are associated with different BT-RS). In one example, K DM-RS for beam tracking are configured for M BT-RS, e.g., each of the M BT-RS is associated with one of the K DM-RS configured for beam tracking. M DM-RS for beam tracking are configured M BT-RS, e.g., with a one-to-one association.
In one example, the BT-RS has a physical signal structure similar to CSI-RS or similar to SRS. In one example, the BT-RS (or CSI-RS for beam tracking or SRS for beam tracking) can be configured in symbols different from the symbols used for the DM-RS for demodulation or data. In one example, the BT-RS (or CSI-RS for beam tracking or SRS for beam tracking) can be configured in resource blocks (RBs) different from the RBs used for the DM-RS for demodulation. In one example, the BT-RS (or CSI-RS for beam tracking or SRS for beam tracking) can be configured in resource element (REs) different from the REs used for the DM-RS for demodulation. In one example, one CSI-RS for beam tracking or SRS for beam tracking is configured for M beam tracking reference signals (e.g., different antenna ports are associated with different BT-RS). In one example, K CSI-RS for beam tracking or K SRS for beam tracking are configured for M BT-RS, e.g., each of the M BT-RS is associated with one of the K CSI-RS configured for beam tracking or the K SRS for beam tracking respectively. M CSI-RS for beam tracking or M SRS for beam tracking are configured M BT-RS, e.g., with a one-to-one association.

In one example, the UE transmits a first beam tracking reference signals (BT-RS1) and a second beam tracking reference signal (BT-RS2), the receiver, e.g., in the base station measures a first metric from BT-RS1 and a second metric from BT-RS2, and the base station reports to the UE the first metric and the second metric. In one example, the UE can adjust the TCI state or spatial relation or spatial domain transmission filter the UE uses for UL transmissions (e.g., for PUSCH and/or PUCCH) based on the first metric and the second metric, and in case of reciprocity, the adjustment can also apply to the TCI state or spatial relation or spatial domain reception filter the UE uses for DL transmissions (e.g., DL transmissions following a main or indicated joint TCI state received at the UE). In one example, BT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

and BT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] .$$

In a variant example, the first metric is measured using the DM-RS (e.g., using the main or indicated TCI state) and the second metric is measured using a BT-RS. In one example, the beam (or spatial domain filter) of the DM-RS is the sum beam, and the beam (or spatial domain filter) of the BT-RS is the difference beam. In a variant example, of the aforementioned examples, the gNB determines a TCI state or spatial relation based on the first metric and the second metric, and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the UE determines a TCI state or spatial relation based on the first metric and the second metric, and the UE signals the TCI state or the spatial relation to the gNB for the gNB and/or UE to use for UL transmissions and in case of reciprocity for DL transmissions (e.g., DL transmissions following a main or indicated joint TCI state).

In one example, the UE transmits a first beam tracking reference signals (BT-RS1) and a second beam tracking reference signal (BT-RS2), the receiver, e.g., in the base station measures a first metric from BT-RS1 and a second metric from BT-RS2, the base station calculates a quantity based on the first metric and the second metric, and the base station reports the quantity to the UE. In one example, the UE can adjust the TCI state or spatial relation or spatial domain transmission filter the UE uses for UL transmissions (e.g., for PUSCH and/or PUCCH) based on the quantity, and in case of reciprocity, the adjustment can also apply to the TCI state or spatial relation or spatial domain reception filter the UE uses for DL transmissions (e.g., DL transmissions following a main or indicated joint TCI state received at the UE). In one example, BT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

and BT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] .$$

In a variant example, the first metric is measured using the DM-RS (e.g., using the main or indicated TCI state) and the second metric is measured using a BT-RS. In one example, the beam (or spatial domain filter) of the DM-RS is the sum beam, and the beam (or spatial domain filter) of the BT-RS is the difference beam. In a variant example, of the aforementioned examples, the gNB determines a TCI state or spatial relation based on the quantity (from the first metric and the second metric), and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the UE determines a TCI state or spatial relation based on the quantity (from the first metric and the second metric), and the UE signals the TCI state or the spatial relation to the gNB for the gNB and/or UE to use for UL transmissions and in case of reciprocity for DL transmissions (e.g., DL transmissions following a main or indicated joint TCI state).

In one example, the UE transmits a first beam tracking reference signals (BT-RS1), a second beam tracking reference signal (BT-RS2) and a third beam tracking reference signal (BT-RS3), the receiver, e.g., in the base station measures a first metric from BT-RS1, a second metric from BT-RS2 and a third metric from BT-RS3, and the base station reports to the UE the first metric, the second metric and the third metric. In one example, the UE can adjust the TCI state or spatial relation or spatial domain transmission filter the UE uses for UL transmissions (e.g., for PUSCH and/or PUCCH) based on the first metric, the second metric and/or the third metric, and in case of reciprocity, the adjustment can also apply to the TCI state or spatial relation or spatial domain reception filter the UE uses for DL transmissions (e.g., DL transmissions following a main or indicated joint TCI state received at the UE).
In one example, BT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

in a first dimension (e.g., azimuth) and

$$[ {d}_{0} , d , … {d}_{\frac{n}{2} - 1} , {d}_{\frac{n}{2}} , {d}_{\frac{n}{2} + 1} , … , {d}_{n - 1} ] ,$$

in a second dimension (e.g., zenith),
In one example, BT-RS2 is a difference beam (or difference spatial domain filter) in the first dimension (e.g., azimuth), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] ,$$

in one example the coefficients of the second dimension (e.g., zenith) can correspond to

$$[ {d}_{0} , d , … {d}_{\frac{n}{2} - 1} , {d}_{\frac{n}{2}} , {d}_{\frac{n}{2} + 1} , … , {d}_{n - 1} ] ,$$

and
In one example, BT-RS3 is a difference beam (or difference spatial domain filter) in the second dimension (e.g., zenith), e.g., with beam coefficients

$$[ {d}_{0} , d , … {d}_{\frac{n}{2} - 1} , - {d}_{\frac{n}{2}} , - {d}_{\frac{n}{2} + 1} , … , - {d}_{n - 1} ] ,$$

in one example the coefficients of the first dimension (e.g., azimuth) can correspond to

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] .$$

In a variant example, the first metric is measured using the DM-RS (e.g., using the main or indicated TCI state) (e.g., DM-RS is used as BT-RS1) and the second metric and the third metric are measured using a BT-RS (e.g., BT-RS2 and BT-RS3). In one example, the beam (or spatial domain filter) of the DM-RS is the sum beam, and the beam (or spatial domain filter) of the BT-RS2 is the difference beam in the first dimension (e.g., azimuth), and the beam (or spatial domain filter) of the BT-RS3 is the difference beam in the second dimension (e.g., zenith). In a variant example, of the aforementioned examples, the gNB determines a TCI state or spatial relation based on the first metric, the second metric and/or the third metric, and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the UE determines a TCI state or spatial relation based on the first metric, the second metric and/or the third metric, and the UE signals the TCI state or the spatial relation to the gNB for the gNB and/or UE to use for UL transmissions and in case of reciprocity for DL transmissions (e.g., DL transmissions following a main or indicated joint TCI state).

In one example, the UE transmits a first beam tracking reference signals (BT-RS1), a second beam tracking reference signal (BT-RS2) and a third beam tracking reference signal (BT-RS3), the receiver, e.g., in the base station measures a first metric from BT-RS1, a second metric from BT-RS2 and a third metric from BT-RS3. In one example, the base station calculates a quantity(s) based on the first metric, the second metric and/or the third metric, and the base station reports the quantity to the UE. In one example, the base station calculates a first quantity based on the first metric and the second metric, and the base station calculates a second quantity based on the first metric and the third metric, and the base station reports the first quantity and the second quantity to the UE. In one example, the UE can adjust the TCI state or spatial relation or spatial domain transmission filter the UE uses for UL transmissions (e.g., for PUSCH and/or PUCCH) based on the quantity or quantities, and in case of reciprocity, the adjustment can also apply to the TCI state or spatial relation or spatial domain reception filter the UE uses for DL transmissions (e.g., DL transmissions following a main or indicated joint TCI state received at the UE).
In one example, BT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] .$$

in a first dimension (e.g., azimuth) and

$$[ {d}_{0} , d , … {d}_{\frac{n}{2} - 1} , {d}_{\frac{n}{2}} , {d}_{\frac{n}{2} + 1} , … , {d}_{n - 1} ] ,$$

in a second dimension (e.g., zenith),
In one example, BT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ]$$

in the first dimension (e.g., azimuth), in one example the coefficients of the second dimension (e.g., zenith) can correspond to

$$[ {d}_{0} , d , … {d}_{\frac{n}{2} - 1} , {d}_{\frac{n}{2}} , {d}_{\frac{n}{2} + 1} , … , {d}_{n - 1} ] ,$$

and
In one example, BT-RS3 is a difference beam (or difference spatial domain filter) in the second dimension (e.g., zenith), e.g., with beam coefficients

$$[ {d}_{0} , d , … {d}_{\frac{n}{2} - 1} , - {d}_{\frac{n}{2}} , - {d}_{\frac{n}{2} + 1} , … , - {d}_{n - 1} ] ,$$

in one example the coefficients of the first dimension (e.g., azimuth) can correspond to

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] .$$

In a variant example, the first metric is measured using the DM-RS (e.g., using the main or indicated TCI state) (e.g., DM-RS is used as BT-RS1) and the second metric and the third metric are measured using a BT-RS (e.g., BT-RS2 and BT-RS3). In one example, the beam (or spatial domain filter) of the DM-RS is the sum beam, and the beam (or spatial domain filter) of the BT-RS2 is the difference beam in the first dimension (e.g., azimuth), and the beam (or spatial domain filter) of the BT-RS3 is the difference beam in the second dimension (e.g., zenith). In a variant example, of the aforementioned examples, the gNB determines a TCI state or spatial relation based on the quantity(s) (from the first metric, the second metric and/or the second metric), and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the gNB determines a TCI state or spatial relation based on a first quantity (from the first metric and the second metric), and a second quantity (from the first metric and the third metric), and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the UE determines a TCI state or spatial relation based on the quantity(s) (from the first metric and/or the second metric and/or the third metric), and the UE signals the TCI state or the spatial relation to the gNB for the gNB and/or UE to use for UL transmissions and in case of reciprocity for DL transmissions (e.g., DL transmissions following a main or indicated joint TCI state).

In the present disclosure, mapping BT-RS to REs or RBs or symbols of an UL transmission is provided.

In one example, DM-RS using the main spatial domain transmission has N-ports. In one example, a BT-RS using an adjacent or associated spatial domain transmission filter has one port. In one example, a BT-RS using an adjacent or associated spatial domain transmission filter has two ports. In one example, a BT-RS using an adjacent or associated spatial domain transmission filter has N-ports.

FIGS. 19-21 illustrate example DM-RS symbols of an UL transmission according to embodiments of the present disclosure. For example, the DM-RS symbols of the UL transmission can be implemented by any of the UEs 111-116 of FIG. 1. This example is for illustration only and can be used without departing from the scope of the present disclosure.

In one example, the DM-RS and the BT-RS are multiplexed in a same symbol or in a same group of symbols. In one example, as illustrated in FIGS. 19-21, for a DM-RS configuration, the DM-RS for demodulation (also referred to as DM-RS for brevity) uses one or more CDM groups of the DM-RS configuration, and the DM-RS for beam tracking (also referred to as BT-RS for brevity) uses a second one or CDM groups.

As illustrated by DM-RS symbols 1900 in FIG. 19, a symbol can have DM-RS and BT-RS, for example, a first antenna port(s) or a first CDM group(s) or a first set of RE(s) or a first set of RB(s) is used for DM-RS, and a second antenna port(s) or a second CDM group(s) or a second set of RE(s) or a second set of RB(s) is used for BT-RS. The mapping of CDM groups to REs can be as described in this disclosure. In addition to DM-RS/BT-RS symbol(s), there are symbols for UL data transmission (e.g., for transmitting the encoded and modulated UL-SCH and/or UCI). In a variant example, UL data can be transmitted in unused CDM groups or unused REs of the DM-RS/BT-RS symbol(s). In a variant example, when the BT-RS is in the same symbol as the DM-RS, but uses different RBs, the BT-RS can have a physical signal structure similar to the CSI-RS or SRS.

As illustrated by DM-RS symbols 1950 in FIG. 19, a symbol can have DM-RS and BT-RS, for example, a first antenna port(s) or a first CDM group(s) or a first set of RE(s) or a first set of RB(s) is used for DM-RS, and a second antenna port(s) or a second CDM group(s) or a second set of RE(s) or a second set of RB(s) is used for BT-RS. The mapping of CDM groups to REs can be as described in this disclosure. In addition, a symbol can have DM-RS with no BT-RS. In addition to DM-RS for demodulation/BT-RS symbol(s) and DM-RS symbol(s), there are symbols for UL data transmission (e.g., for transmitting the encoded and modulated UL-SCH and/or UCI). In a variant example, UL data can be transmitted in unused CDM groups or unused REs of the DM-RS/BT-RS symbol(s) and/or the DM-RS symbol(s). In a variant example, when the BT-RS is in the same symbol as the DM-RS, but uses different RBs, the BT-RS can have a physical signal structure similar to the CSI-RS or SRS.

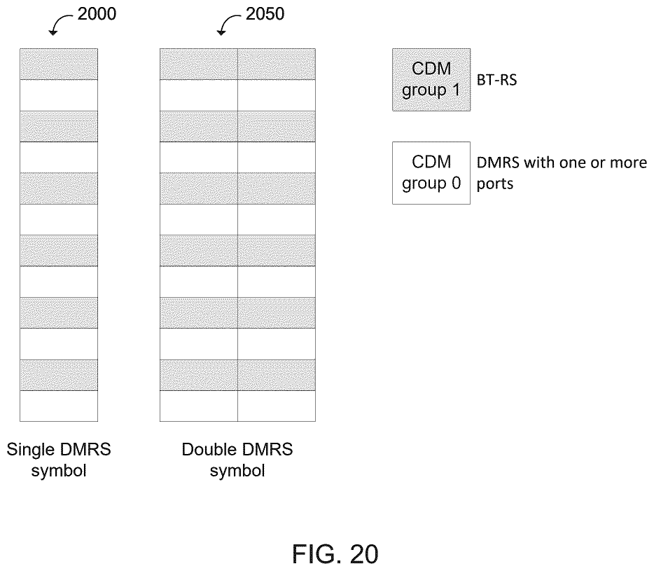

In FIG. 20, with DM-RS basic configuration type 1, a single DM-RS symbol 2000 may be used. In one example, CDM group 0 can be used for DM-RS, in this example, the DM-RS can be a single port DMRS or a two-port DM-RS. In one example, CDM group 1 can be used for BT-RS, in one example a two-port BT-RS is transmitted in CDM group 1, in one example, two one-port BT-RS are transmitted in CDM group 1. In one example, a combination of M BT-RS are transmitted in CMD group 1 such that the total number of ports across the M BT-RS is less than or equal to N, in one example, N is 1, in one example, N is 2. In one example, DM-RS is transmitted in CDM group 0 with N_{D} antenna ports and a combination of M BT-RS are transmitted in CMD group 1 such that the total number of ports across the M BT-RS equal to N_{B}, in one example, N_{D}+N_{B}≤2, in one example, N_{D}+N_{B}≤4, in one example, N_{D}=1, in one example, N_{D}≤2, in one example, N_{B}≤1, in one example, N_{B}≤2. In one example of the aforementioned examples, M=1 or M=2.

Further in FIG. 20, with DM-RS enhanced configuration type 1, single DM-RS symbol 2000 may also be used. In one example, CDM group 0 can be used for DM-RS, in this example, the DM-RS can be a single port DMRS or a two-port DM-RS or a three-port DM-RS or a four-port DM-RS. In one example, CDM group 1 can be used for BT-RS, in one example a two-port BT-RS is transmitted in CDM group 1, in one example, two one-port BT-RS are transmitted in CDM group 1, in one example two two-port BT-RS are transmitted in CDM group 1, in one example, four one-port BT-RS are transmitted in CDM group 1, in one example, one two-port BT-RS and two one-port BT-RS are transmitted in CDM group 1, in one example one four-port BT-RS is transmitted in CDM group 1. In one example one two-port BT-RS is transmitted in CDM group 1. In one example one one-port BT-RS is transmitted in CDM group 1. In one example, a combination of M BT-RS are transmitted in CMD group 1 such that the total number of ports across the M BT-RS is less than or equal to N, in one example, N is 2, in one example, N is 4. In one example, DM-RS is transmitted in CDM group 0 with N_{D} antenna ports and a combination of M BT-RS are transmitted in CMD group 1 such that the total number of ports across the M BT-RS equal to N_{B}, in one example, N_{D}+N_{B}≤4, in one example, N_{D}+N_{B}≤8, in one example, N_{D}≤2, in one example, N_{D}≤4, in one example, N_{B}≤2, in one example, N_{B}≤4. In one example of the aforementioned examples, M=1 or M=2 or M=4.

Further in FIG. 20, with DM-RS basic configuration type 1, double DM-RS symbols 2050 may be used. In one example, CDM group 0 can be used for DM-RS, in this example, the DM-RS can be a single port DMRS or a two-port DM-RS or a three-port DM-RS or a four-port DM-RS. In one example, CDM group 1 can be used for BT-RS, in one example two two-port BT-RS are transmitted in CDM group 1, in one example, four one-port BT-RS are transmitted in CDM group 1, in one example, one two-port BT-RS and two one-port BT-RS are transmitted in CDM group 1, in one example one four-port BT-RS is transmitted in CDM group 1. In one example one two-port BT-RS is transmitted in CDM group 1. In one example one one-port BT-RS is transmitted in CDM group 1. In one example, a combination of M BT-RS are transmitted in CMD group 1 such that the total number of ports across the M BT-RS is less than or equal to N, in one example, N is 2, in one example, N is 4. In one example, DM-RS is transmitted in CDM group 0 with N_{D} antenna ports and a combination of M BT-RS are transmitted in CMD group 1 such that the total number of ports across the M BT-RS equal to N_{B}, in one example, N_{D}+N_{B}≤4, in one example, N_{D}+N_{B}≤8, in one example, N_{D}≤2, in one example, N_{D}≤4, in one example, N_{B}≤2, in one example, N_{B}≤4. In one example of the aforementioned examples, M=1 or M=2 or M=4.

Further in FIG. 20, with DM-RS enhanced configuration type 1, double DM-RS symbols 2050 may also be used. In one example, CDM group 0 can be used for DM-RS, in this example, the DM-RS can be a single port DMRS or a two-port DM-RS or a three-port DM-RS or a four-port DM-RS or a five-port DM-RS or a six-port DM-RS or a seven port DM-RS or an eight port DM-RS. In one example, a combination of M BT-RS are transmitted in CMD group 1 such that the total number of ports across the M BT-RS is less than or equal to N, in one example, N is 4, in one example, N is 8. In one example, DM-RS is transmitted in CDM group 0 with N_{D} antenna ports and a combination of M BT-RS are transmitted in CMD group 1 such that the total number of ports across the M BT-RS equal to N_{B}, in one example, N_{D}+N_{B}≤8, in one example, N_{D}+N_{B}≤16, in one example, N_{D}≤4, in one example, N_{D}≤8, in one example, N_{B}≤4, in one example, N_{B}≤8. In one example of the aforementioned examples, M=1 or M=2 or M=4 or M=8.

In one example, of the aforementioned examples, a CDM group used for BT-RS is associated with one BT-RS. In one example, of the aforementioned examples, a CDM group used for BT-RS can be associated with more than one BT-RS.

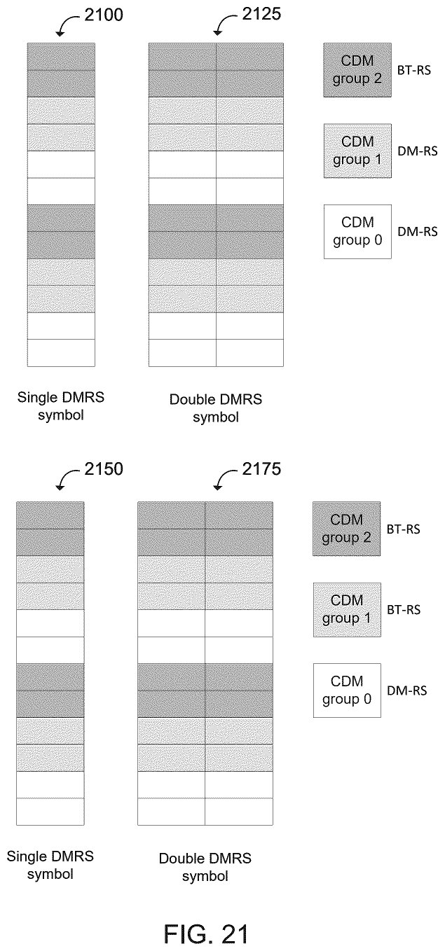

In FIG. 21, with basic DM-RS configuration type 2, a single DM-RS symbol 2100 may be used. In one example, CDM group 0 and CDM group 1 can be used for DM-RS, in this example, the DM-RS can have a number of DM-RS varying from one DM-RS port to 4 DM-RS ports. In one example, CDM group 2 can be used for BT-RS, in one example a two-port BT-RS is transmitted in CDM group 2, in one example, two one-port BT-RS are transmitted in CDM group 2. In one example, a combination of M BT-RS are transmitted in CMD group 2 such that the total number of ports across the M BT-RS is less than or equal to N, in one example, N is 1, in one example, N is 2. In one example, DM-RS is transmitted in CDM group 0 and CDM group 1 with N_{D} antenna ports and a combination of M BT-RS are transmitted in CMD group 2 such that the total number of ports across the M BT-RS equal to N_{B}, in one example, N_{D}+N_{B}≤2, in one example, N_{D}+N_{B}≤3, in one example, N_{D}+N_{B}≤4, in one example, N_{D}+N_{B}≤6, in one example, N_{D}≤2, in one example, N_{D}≤3, in one example, N_{D}≤4, in one example, N_{B}≤1, in one example, N_{B}≤2. In one example of the aforementioned examples, M=1 or M=2.

Further in FIG. 21, with enhanced DM-RS configuration type 2, single DM-RS symbol 2100 may also be used. In one example, CDM group 0 and CDM group 1 can be used for DM-RS, in this example, the DM-RS can have a number of DM-RS varying from one DM-RS port to up to 8 DM-RS ports. In one example, a combination of M BT-RS are transmitted in CMD group 2 such that the total number of ports across the M BT-RS is less than or equal to N, in one example, N is 1, in one example, N is 2, in one example, N is 4. In one example, DM-RS is transmitted in CDM group 0 and CDM group 1 with N_{D} antenna ports and a combination of M BT-RS are transmitted in CMD group 2 such that the total number of ports across the M BT-RS equal to N_{B}, in one example, N_{D}+N_{B}≤4, in one example, N_{D}+N_{B}≤6, in one example, N_{D}+N_{B}≤8, in one example, N_{D}+N_{B}≤12, in one example, N_{D}≤4, in one example, N_{D}≤6, in one example, N_{D}≤12, in one example, N_{B}≤1, in one example, N_{B}≤2, in one example, N_{B}≤4. In one example of the aforementioned examples, M=1 or M=2 or M=4.

Further in FIG. 21, with DM-RS basic configuration type 2, double DM-RS symbols 2125 may be used. In one example, CDM group 0 and CDM group 1 can be used for DM-RS, in this example, the DM-RS can have a number of DM-RS varying from one DM-RS port to up to 8 DM-RS ports. In one example, CDM group 2 can be used for BT-RS, in one example two two-port BT-RS are transmitted in CDM group 2, in one example, four one-port BT-RS are transmitted in CDM group 2, in one example, one two-port BT-RS and two one-port BT-RS are transmitted in CDM group 2, in one example one four-port BT-RS is transmitted in CDM group 2. In one example, a combination of M BT-RS are transmitted in CMD group 2 such that the total number of ports across the M BT-RS is less than or equal to N, in one example, N is 1, in one example, N is 2, in one example, N is 4. In one example, DM-RS is transmitted in CDM group 0 and CDM group 1 with N_{D} antenna ports and a combination of M BT-RS are transmitted in CMD group 2 such that the total number of ports across the M BT-RS equal to N_{B}, in one example, N_{D}+N_{B}≤3, in one example, N_{D}+N_{B}≤4, in one example, N_{D}+N_{B}≤6, in one example, N_{D}+N_{B}≤8, in one example, N_{D}+N_{B}≤12, in one example, N_{D}≤2, in one example, N_{D}≤3, in one example, N_{D}≤4, in one example, N_{D}≤8, in one example, N_{B}≤1, in one example, N_{B}≤2, in one example, N_{B}≤4. In one example of the aforementioned examples, M=1 or M=2 or M=4.

Further in FIG. 21, with DM-RS enhanced configuration type 2, double DM-RS symbols 2125 may also be used. In one example, CDM group 0 and CDM group 1 can be used for DM-RS, in this example, the DM-RS can have a number of DM-RS varying from one DM-RS port to up to 8 DM-RS ports. In this example, the DM-RS can have a number of DM-RS varying from one DM-RS port to up to 16 DM-RS ports. In one example, a combination of M BT-RS are transmitted in CMD group 2 such that the total number of ports across the M BT-RS is less than or equal to N, in one example, N is 1, in one example, N is 2, in one example, N is 4, in one example, N is 8. In one example, DM-RS is transmitted in CDM group 0 and CDM group 1 with Np antenna ports and a combination of M BT-RS are transmitted in CMD group 2 such that the total number of ports across the M BT-RS equal to N_{B}, in one example, N_{D}+N_{B}≤6, in one example, N_{D}+N_{B}≤8, in one example, N_{D}+N_{B}≤12, in one example, N_{D}+N_{B}≤16, in one example, N_{D}+N_{B}≤24, in one example, N_{D}≤4, in one example, N_{D}≤6, in one example, N_{D}≤8, in one example, N_{D}≤16, in one example, N_{B}≤1, in one example, N_{B}≤2, in one example, N_{B}≤4, in one example, N_{B}≤8. In one example of the aforementioned examples, M=1 or M=2 or M=4 or M=6 or M=8.

Further in FIG. 21, with DM-RS basic configuration type 2, a single DM-RS symbol 2150 may be used. In one example, CDM group 0 can be used for DM-RS, in this example, the DM-RS can have a number of DM-RS varying from one DM-RS port to 2 DM-RS ports. In one example, CDM group 1 and CDM group 2 can be used for BT-RS, in one example two two-port BT-RS are transmitted in CDM group 1 and CDM group 2, in one example, four one-port BT-RS are transmitted in CDM group 1 and CDM group 2, in one example, one two-port BT-RS and two one-port BT-RS are transmitted in CDM group 1 and CDM group 2, in one example one four-port BT-RS is transmitted in CDM group 1 and CDM group 2. In one example one two-port BT-RS is transmitted in CDM group 1 or CDM group 2. In one example one one-port BT-RS is transmitted in CDM group 1 or CDM group 2. In one example, a combination of M BT-RS are transmitted in CMD group 1 and CDM group 2 such that the total number of ports across the M BT-RS is less than or equal to N, in one example, N is 1, in one example, N is 2, in one example, N is 4. In one example, DM-RS is transmitted in CDM group 0 with N_{D} antenna ports and a combination of M BT-RS are transmitted in CMD group 1 and CDM group 2 such that the total number of ports across the M BT-RS equal to N_{B}, in one example, N_{D}+N_{B}≤2, in one example, N_{D}+N_{B}≤3, in one example, N_{D}+N_{B}≤4, in one example, N_{D}+N_{B}≤6, in one example, N_{D}=1, in one example, N_{D}≤2, in one example, N_{B}≤2, in one example, N_{B}≤4. In one example of the aforementioned examples, M=1 or M=2 or M=4.

Further in FIG. 21, with DM-RS enhanced configuration type 2, single DM-RS symbol 2150 may also be used. In one example, CDM group 0 can be used for DM-RS, in this example, the DM-RS can have a number of DM-RS varying from one DM-RS port to 4 DM-RS ports. In one example, a combination of M BT-RS are transmitted in CMD group 1 and CDM group 2 such that the total number of ports across the M BT-RS is less than or equal to N, in one example, N is 1, in one example, N is 2, in one example, N is 4, in one example, N is 8. In one example, DM-RS is transmitted in CDM group 0 with N_{D} antenna ports and a combination of M BT-RS are transmitted in CMD group 1 and CDM group 2 such that the total number of ports across the M BT-RS equal to N_{B}, in one example, N_{D}+N_{B}≤3, in one example, N_{D}+N_{B}≤4, in one example, N_{D}+N_{B}≤6, in one example, N_{D}+N_{B}≤8, in one example, N_{D}+N_{B}≤12, in one example, N_{D}=1, in one example, N_{D}≤2, in one example, N_{D}≤4 in one example, N_{B}≤2, in one example, N_{B}≤4, in one example, N_{B}≤8. In one example of the aforementioned examples, M=1 or M=2 or M=4 or M=6 or M=8.

Further in FIG. 21, with DM-RS basic configuration type 2, double DM-RS symbols 2175 may be used. In one example, CDM group 0 can be used for DM-RS, in this example, the DM-RS can have a number of DM-RS ports varying from one DM-RS port to up to 4 DM-RS ports. In one example, CDM group 1 and CDM group 2 can be used for BT-RS, in one example four two-port BT-RS are transmitted in CDM group 1 and CDM group 2, in one example, eight one-port BT-RS are transmitted in CDM group 1 and CDM group 2, in one example, a combination of p₂ two-port BT-RS and p₁ one-port BT-RS are transmitted in CDM group 1 and CDM group 2 such that p₁+2p₂≤8, in one example two four-port BT-RS are transmitted in CDM group 1 and CDM group 2. In one example, a combination of M BT-RS are transmitted in CMD group 1 and CDM group 2 such that the total number of ports across the M BT-RS is less than or equal to N, in one example, N is 1, in one example, N is 2, in one example, N is 4, in one example, N is 8. In one example, DM-RS is transmitted in CDM group 0 with N_{D} antenna ports and a combination of M BT-RS are transmitted in CMD group 1 and CDM group 2 such that the total number of ports across the M BT-RS equal to N_{B}, in one example, N_{D}+N_{B}≤3, in one example, N_{D}+N_{B}≤4, in one example, N_{D}+N_{B}≤6, in one example, N_{D}+N_{B}≤8, in one example, N_{D}+N_{B}≤12, in one example, N_{D}≤2, in one example, N_{D}≤4, in one example, N_{B}≤2, in one example, N_{B}≤4, in one example, N_{B}≤8. In one example of the aforementioned examples, M=1 or M=2 or M=4 or M-=6 or M=8.

Further in FIG. 21, with DM-RS enhanced configuration type 2, double DM-RS symbols 2175 may also be used. In one example, CDM group 0 can be used for DM-RS. In one example, the DM-RS can have a number of DM-RS ports varying from one DM-RS port to up to 4 DM-RS ports. In one example, the DM-RS can have a number of DM-RS ports varying from one DM-RS port to up to 8 DM-RS ports. In one example, a combination of p₂ two-port BT-RS and p₁ one-port BT-RS are transmitted in CDM group 1 and CDM group 2 such that p₁+2p₂≤16. In one example, a combination of M BT-RS are transmitted in CMD group 1 and CDM group 2 such that the total number of ports across the M BT-RS is less than or equal to N, in one example, N is 1, in one example, N is 2, in one example, N is 4, in one example, N is 8, in one example, N is 16. In one example, DM-RS is transmitted in CDM group 0 with N_{D} antenna ports and a combination of M BT-RS are transmitted in CMD group 1 and CDM group 2 such that the total number of ports across the M BT-RS equal to N_{B}, in one example, N_{D}+N_{B}≤3, in one example, N_{D}+N_{B}≤4, in one example, N_{D}+N_{B}≤6, in one example, N_{D}+N_{B}≤8, in one example, N_{D}+N_{B}≤12, in one example, N_{D}+N_{B}≤16, in one example, N_{D}+N_{B}≤24, in one example, N_{D}≤2, in one example, N_{D}≤4, in one example, N_{D}≤8, in one example, N_{B}≤2, in one example, N_{B}≤4, in one example, N_{B}≤8, in one example, N_{B}≤16. In one example of the aforementioned examples, M=1 or M=2 or M=4 or M=6 or M=8 or M=12 or M=16.

In one example, of the aforementioned examples, a CDM group used for BT-RS is associated with one BT-RS. In one example, of the aforementioned examples, a CDM group used for BT-RS can be associated with more than one BT-RS. In one example, of the aforementioned example, a BT-RS can be associated with antenna ports of one CDM group. In one example, of the aforementioned example, a BT-RS can be associated with antenna ports of more than one CDM group.

In one example, in symbols with reference signal (e.g., DM-RS/BT-RS symbols or BT-RS symbols) used in UL channel transmission (e.g., for PUSCH transmission), a first set of RBs are allocated to DM-RS (for symbols with DM-RS), and a second set of RBs are allocated to BT-RS.
In one example, the RBs allocated to DM-RS can be configured with CDM groups and antenna ports according to basic or enhanced configuration type 1 and basic or enhanced configuration type 2 as aforementioned.
In one example, the RBs allocated to BT-RS can be configured with CDM groups and antenna ports according to basic or enhanced configuration type 1 and basic or enhanced configuration type 2 as aforementioned. In one example, a BT-RS on an adjacent beam (or spatial domain filter) can be allocated one or two ports or more ports in a CDM group. In one example, a CDM group is used for one BT-RS. In one example, a CDM group can be used for more than one BT-RS. In one example, a BT-RS can be associated with one CDM group. In one example, a BT-RS can be associated with more than one CDM group.
In one example, the REs of RBs allocated to BT-RS can be divided into groups, wherein a group of REs is associated with a BT-RS. For example, the first group of REs are associated with a first BT-RS, the second group of REs are associated with a second BT-RS and so on. In one example, the REs in a RB associated with a BT-RS can be contiguous. In one example, the REs in a RB associated with a BT-RS can be non-contiguous.

In one example, the RBs allocated to BT-RS can be divided into groups, wherein a group of RBs is associated with a BT-RS. For example, the first group of RBs are associated with a first BT-RS, the second group of RBs are associated with a second BT-RS and so on. In one example, the RBs associated with a BT-RS can be contiguous. In one example, the RBs associated with a BT-RS can be non-contiguous

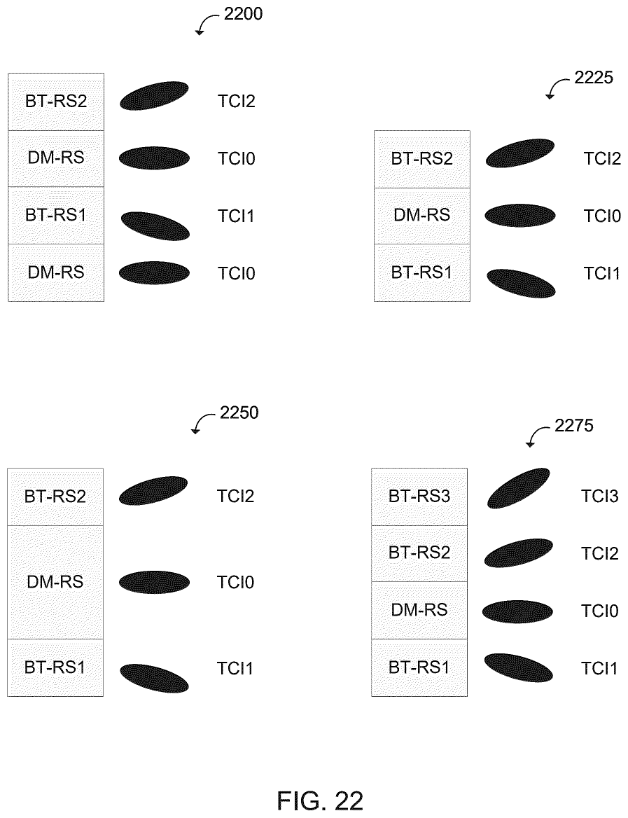

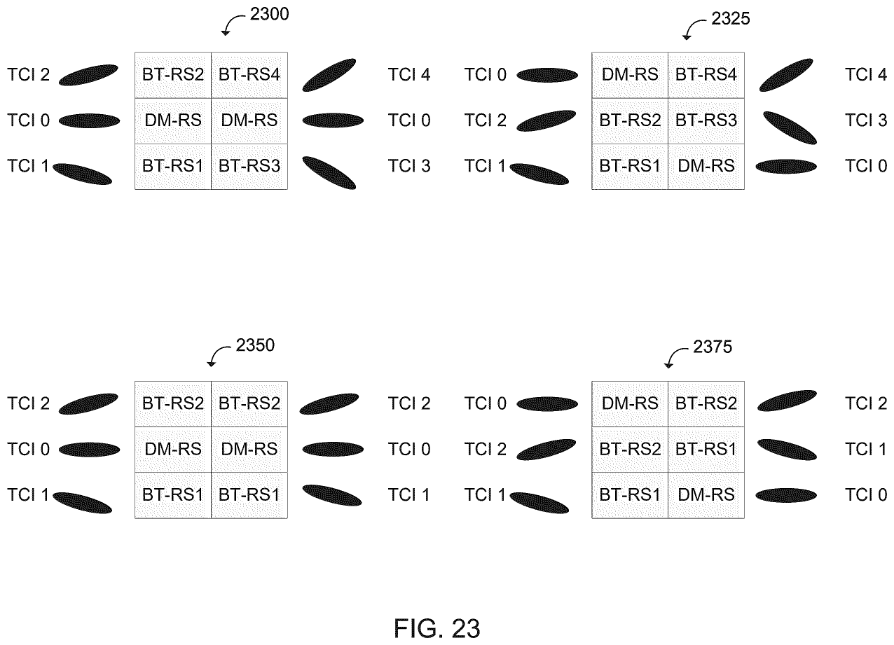

FIG. 22 illustrates examples of RB allocation to different types of reference signals used in UL channel transmission according to embodiments of the present disclosure. For example, the RB allocation can be implemented by any of the UEs 111-116 of FIG. 1. This example is for illustration only and can be used without departing from the scope of the present disclosure.

As illustrated in FIG. 22, contiguous REs or contiguous RBs can be allocated to different types of reference signals. In example 2200, the frequency allocation is split in to 4 equal or near equal frequency bands. In DM-RS/BT-RS symbols, frequency band 0 and frequency band 2 are allocated to DM-RS using TCI state 0 or spatial domain filter 0 or spatial relation 0, frequency band 1 is allocated to BT-RS1 and uses TCI state 1 or spatial domain filter 1 or spatial relation 1, and frequency band 3 is allocated to BT-RS2 and uses TCI state 2 or spatial domain filter 2 or spatial relation 2. In a variant example 2225, the bands for DM-RS are contiguous bands, for example, frequency band 0 is allocated to BT-RS1 and uses TCI state 1 or spatial domain filter 1 or spatial relation 1, frequency band 1 and frequency band 2 are allocated to DM-RS and uses TCI state 0 or spatial domain filter 0 or spatial relation 0, frequency band 3 is allocated to BT-RS2 and uses TCI state 2 or spatial domain filter 2 or spatial relation 2.

In yet another example 2250, the frequency allocation is split in frequency bands that can be of unequal size for the DM-RS/BT-RS symbol, frequency band 1 is larger than frequency band 0 and frequency band 2. Frequency band 0 is allocated to BT-RS1 and uses TCI state 1 or spatial domain filter 1 or spatial relation 1, frequency band 1 is allocated to DM-RS and uses TCI state 0 or spatial domain filter 0 or spatial relation 2, and frequency band 2 is allocated to BT-RS2, and uses TCI state 2 or spatial domain filter 2 or spatial relation 2.

In yet another example 2275, the frequency allocation is split in to 4 equal or near equal frequency bands for the DM-RS/BT-RS symbol. Frequency band 0 is allocated to BT-RS1 and uses TCI state 1 or spatial domain filter 1 or spatial relation 1, frequency band 1 is allocated to DM-RS and uses TCI state 0 or spatial domain filter 0 or spatial relation 0, frequency band 2 is allocated to BT-RS2, and uses TCI state 2 or spatial domain filter 2 or spatial relation 2, and frequency band 3 is allocated to BT-RS3, and uses TCI state 3 or spatial domain filter 3 or spatial relation 3.

In one example of the aforementioned examples of FIG. 22, the BT-RS can have a physical signal structure similar to the physical signal structure of DM-RS. In another example of the aforementioned examples of FIG. 22, the BT-RS can have a physical signal structure similar to the physical signal structure of CSI-RS. In yet another example of the aforementioned examples of FIG. 22, the BT-RS can have a physical signal structure similar to the physical signal structure of SRS.

FIG. 23 illustrates further examples of RB allocation to different types of reference signals used in UL channel transmission according to embodiments of the present disclosure. For example, the RB allocation can be implemented by any of the UEs 111-116 of FIG. 1. This example is for illustration only and can be used without departing from the scope of the present disclosure.

In yet another example, there are two DM-RS/BT-RS symbols. In one example, the DM-RS/BT-RS symbols are consecutive. In one example, DM-RS/BT-RS symbols are non-consecutive. In one example, the frequency allocation of each DM-RS/BT-RS symbol is split into three frequency bands, wherein different BT-RS can be allocated to different DM-RS/BT-RS as illustrated in example 2300 of FIG. 23:
In one example, frequency band 0 is allocated to BT-RS1 in DM-RS/BT-RS symbol 0 and frequency band 0 is allocated to BT-RS3 in DM-RS/BT-RS symbol 1.
In one example, frequency band 1 is allocated to DM-RS in DM-RS/BT-RS symbol 0 and DM-RS/BT-RS symbol 1, in this example, there is no frequency hopping of DM-RS between symbols.
In one example, frequency band 2 is allocated to BT-RS2 in DM-RS/BT-RS symbol 0 and frequency band 0 is allocated to BT-RS4 in DM-RS/BT-RS symbol 1.

In a variant example, the same BT-RS can be repeated in both DM-RS/BT-RS symbols without or with frequency hopping.
In a variant of the aforementioned examples, the number of frequency bands can be N. In one example, N=2. In one example, N=1 (e.g., one BT-RS per OFDM symbol).

In yet another example, there are two DM-RS/BT-RS symbols. In one example, the DM-RS/BT-RS symbols are consecutive. In one example, DM-RS/BT-RS symbols are non-consecutive. In one example, the frequency allocation of each DM-RS/BT-RS symbol is split into three frequency bands, wherein different BT-RS can be allocated to different DM-RS/BT-RS, with frequency hopping of DM-RS as illustrated in example 2325 of FIG. 23:
In one example, frequency band 0 is allocated to BT-RS1 in DM-RS/BT-RS symbol 0 and frequency band 0 is allocated to DM-RS in DM-RS/BT-RS symbol 1.

In one example, frequency band 1 is allocated to BT-RS2 in DM-RS/BT-RS symbol 0 and frequency band 1 is allocated to BT-RS3 in DM-RS/BT-RS symbol 1.
In one example, frequency band 2 is allocated to DM-RS in DM-RS/BT-RS symbol 0 and frequency band 2 is allocated to BT-RS4 in DM-RS/BT-RS symbol 1.

In a variant example, the same BT-RS can be repeated in both DM-RS/BT-RS symbols with or without frequency hopping.
In a variant of the aforementioned examples, the number of frequency bands can be N. In one example, N=2. In one example, N=1 (e.g., one BT-RS per OFDM symbol).

In yet another example, there are two DM-RS/BT-RS symbols. In one example, the DM-RS/BT-RS symbols are consecutive. In one example, DM-RS/BT-RS symbols are non-consecutive. In one example, the frequency allocation of each DM-RS/BT-RS symbol is split into three frequency bands, wherein same BT-RS can be allocated to different DM-RS/BT-RS without frequency hopping as illustrated in example 2350 of FIG. 23:
In one example, frequency band 0 is allocated to BT-RS1 in DM-RS/BT-RS symbol 0 and DM-RS/BT-RS symbol 1.
In one example, frequency band 1 is allocated to DM-RS in DM-RS/BT-RS symbol 0 and DM-RS/BT-RS symbol 1.
In one example, frequency band 2 is allocated to BT-RS2 in DM-RS/BT-RS symbol 0 and DM-RS/BT-RS symbol 1.
In a variant of the aforementioned examples, the number of frequency bands can be N. In one example, N=2. In one example, N=1 (e.g., one BT-RS per OFDM symbol).

In yet another example, there are two DM-RS/BT-RS symbols. In one example, the DM-RS/BT-RS symbols are consecutive. In one example, DM-RS/BT-RS symbols are non-consecutive. In one example, the frequency allocation of each DM-RS/BT-RS symbol is split into three frequency bands, wherein same BT-RS can be allocated to different DM-RS/BT-RS, with frequency hopping of DM-RS and BT-RS as illustrated in example 2375 of FIG. 23:
In one example, frequency band 0 is allocated to BT-RS1 in DM-RS/BT-RS symbol 0 and frequency band 0 is allocated to DM-RS in DM-RS/BT-RS symbol 1.
In one example, frequency band 1 is allocated to BT-RS2 in DM-RS/BT-RS symbol 0 and frequency band 1 is allocated to BT-RS1 in DM-RS/BT-RS symbol 1.
In one example, frequency band 2 is allocated to DM-RS in DM-RS/BT-RS symbol 0 and frequency band 2 is allocated to BT-RS2 in DM-RS/BT-RS symbol 1.
In a variant of the aforementioned examples, the number of frequency bands can be N. In one example, N=2. In one example, N=1 (e.g., one BT-RS per OFDM symbol).

In the aforementioned mentioned: DM-RS uses TCI state 0 or spatial domain filter 0 or spatial relation 0, BT-RS1 uses TCI state 1 or spatial domain filter 1 or spatial relation 1, BT-RS2 uses TCI state 2 or spatial domain filter 2 or spatial relation 2, BT-RS3 uses TCI state 3 or spatial domain filter 3 or spatial relation 3, and BT-RS4 uses TCI state 4 or spatial domain filter 4 or spatial relation 4.

In one example of the aforementioned examples of FIG. 23, the BT-RS can have a physical signal structure similar to the physical signal structure of DM-RS. In another example of the aforementioned examples of FIG. 23, the BT-RS can have a physical signal structure similar to the physical signal structure of CSI-RS. In another example of the aforementioned examples of FIG. 23, the BT-RS can have a physical signal structure similar to the physical signal structure of SRS.

In one example, within respective frequency bands, one or more CDM groups are used for respective DM-RS or respective BT-RS. In one example, in addition to the DM-RS/BT-RS, there is one or more DM-RS symbols wherein the entire frequency allocation of the DM-RS symbol is used for DM-RS, wherein TCI state 0 or spatial domain filter 0 or spatial relation 0 is used. In one example, for symbols used for data transmission (e.g., for transmitting the encoded and modulated UL-SCH and/or UCI), TCI state 0 or spatial domain filter 0 or spatial relation 0 is used. In the aforementioned, example, TCI state 0 or spatial domain filter 0 or spatial relation 0, is the TCI state or spatial relation of the main beam. TCI state 1 . . . M, or spatial domain filter 1 . . . M or spatial relation 1 . . . M, is the TCI state or spatial domain filter or spatial relation of the 1^{st}, . . . . Mth beam respectively.

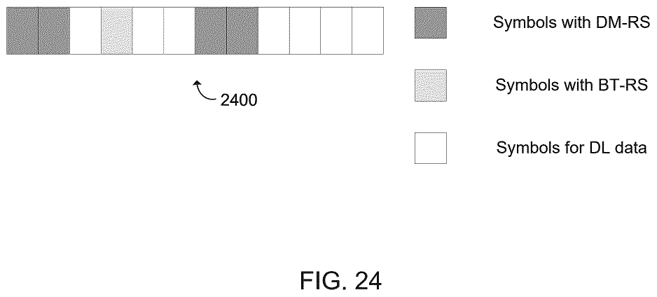

FIG. 24 illustrates another example of DM-RS symbols 2400 of an UL transmission according to embodiments of the present disclosure. For example, DM-RS symbols 2400 of the UL transmission can be implemented by any of the UEs 111-116 of FIG. 1. This example is for illustration only and can be used without departing from the scope of the present disclosure.

In one example, the DM-RS and the BT-RS associated with a UL channel (e.g., PUSCH or PUCCH) are transmitted (or multiplexed) in different symbols or in different groups of symbols as illustrated in FIG. 23. In one example of FIG. 24, the BT-RS can have a physical signal structure similar to the physical signal structure of DM-RS as described in the following. In another example of FIG. 24, the BT-RS can have a physical signal structure similar to the physical signal structure of CSI-RS as described later in this disclosure. In another example of FIG. 24, the BT-RS can have a physical signal structure similar to the physical signal structure of SRS as described later in this disclosure.

In FIG. 24, a first one or more symbols or groups of symbols in a UL channel allocation can have DM-RS (e.g, DM-RS used for demodulation). A second one or more symbols or groups of symbols in a UL channel (e.g., PUSCH or PUCCH) allocation can have BT-RS (e.g., DM-RS configured for tracking, alternatively, the BT-RS can be CSI-RS or SRS configured for beam tracking as described layer in this disclosure). A third one or more symbols are symbols for UL data transmission (e.g., for transmitting the encoded and modulated UL-SCH and/or UCI). In a variant example, UL data can be transmitted in unused CDM groups or unused REs of the DM-RS symbol(s) and/or in unused CDM groups or unused REs of BT-RS symbol(s).

In one example, the symbol(s) or group(s) of symbols allocated to DM-RS can be configured with CDM groups and antenna ports according to basic or enhanced configuration type 1 or basic or enhanced configuration type 2 as aforementioned.

In one example, the symbol(s) or group(s) of symbols allocated to BT-RS can be configured with CDM groups and antenna ports according to basic or enhanced configuration type 1 or basic or enhanced configuration type 2 as aforementioned. In one example, a BT-RS on an adjacent beam (or spatial domain filter) can be allocated one or two ports or more ports in a CDM group. In one example, a CDM group is used for one BT-RS. In one example, a CDM group can be used for more than one BT-RS. In one example, a BT-RS can be associated with one CDM group. In one example, a BT-RS can be associated with more than one CDM group.

In one example, the REs of the symbol(s) or group(s) of symbols allocated to BT-RS can be divided into groups, wherein a group of REs is associated with a BT-RS. For example, the first group of REs are associated, with a first BT-RS, the second group of REs are associated with a second BT-RS and so on. In one example, the REs in a symbol or group of symbols associated with a BT-RS can be contiguous. In one example, the REs in a symbol or group of symbols associated with a BT-RS can be non-contiguous. In one example, the REs in a RB of a symbol or group of symbols associated with a BT-RS can be contiguous. In one example, the REs in a RB of a symbol or group of symbols associated with a BT-RS can be non-contiguous.

In one example, the RBs of the symbol(s) or group(s) of symbols allocated to BT-RS can be divided into groups, wherein a group of RBs is associated with a BT-RS. For example, the first group of RBs are associated with a first BT-RS, the second group of RBs are associated with a second BT-RS and so on. In one example, the RBs in a symbol or group of symbols associated with a BT-RS can be contiguous. In one example, the RBs in a symbol or group of symbols associated with a BT-RS can be non-contiguous.

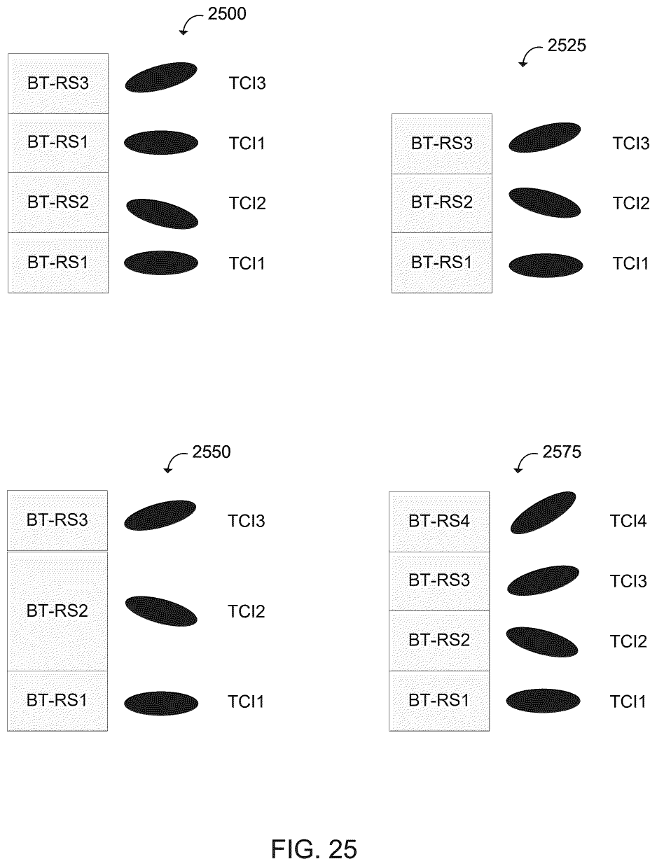

FIG. 25 illustrates further examples of RB allocation to different types of reference signals used in UL channel transmission according to embodiments of the present disclosure. For example, the RB allocation can be implemented by any of the UEs 111-116 of FIG. 1. This example is for illustration only and can be used without departing from the scope of the present disclosure.

As illustrated in FIG. 25, contiguous REs or contiguous RBs can be allocated to different BT-RS. In one example, a BT-RS is allocated a one frequency band. In one example, a BT-RS can be allocated multiple frequency bands. In one example, different BT-RS are allocated the same number of frequency bands. In one example, different BT-RS can be allocated different number of frequency bands. In example 2500, the frequency allocation is split in to 4 equal or near equal frequency bands. In BT-RS symbols, frequency band 0 and frequency band 2 are allocated to BT-RS1 using TCI state 1 or spatial domain filter 1 or spatial relation 1, frequency band 1 is allocated to BT-RS2 and uses TCI state 2 or spatial domain filter 2 or spatial relation 2 and frequency band 3 is allocated to BT-RS3 and uses TCI state 3 or spatial domain filter 3 or spatial relation 3. In a variant example, as illustrated in example 2525, the bands for BT-RS, when BT-RS is allocated multiple bands, are contiguous bands, for example, frequency band 0 is allocated to BT-RS1 and uses TCI state 1 or spatial domain filter 1 or spatial relation 1, frequency band 1 and frequency band 2 are allocated to BT-RS2 and uses TCI state 2 or spatial domain filter 2 or spatial relation 2, frequency band 3 is allocated to BT-RS3 and uses TCI state 3 or spatial domain filter 3 or spatial relation 3.

In yet another example, the frequency allocation is split in frequency bands that can be of unequal size, for example as illustrated in example 2550, where each BT-RS is allocated one frequency band, for the BT-RS symbol, frequency band 1 is larger than frequency band 0 and frequency band 2. Frequency band 0 is allocated to BT-RS1 and uses TCI state 1 or spatial domain filter 1 or spatial relation 1, frequency band 1 is allocated to BT-RS2 and uses TCI state 2 or spatial domain filter 2 or spatial relation 2, and frequency band 2 is allocated to BT-RS3, and uses TCI state 3 or spatial domain filter 3 or spatial relation 3.

In yet another example, the frequency allocation is split in to 4 equal or near equal frequency bands as illustrated in example 2575 for the BT-RS symbol. Frequency band 0 is allocated to BT-RS1 and uses TCI state 1 or spatial domain filter 1 or spatial relation 1, frequency band 1 is allocated to BT-RS2 and uses TCI state 2 or spatial domain filter 2 or spatial relation 2, frequency band 2 is allocated to BT-RS3, and uses TCI state 3 or spatial domain filter 3 or spatial relation 3, and frequency band 3 is allocated to BT-RS4, and uses TCI state 4 or spatial domain filter 4 or spatial relation 4.

In one example of the aforementioned examples of FIG. 25, the BT-RS can have a physical signal structure similar to the physical signal structure of DM-RS. In another example of the aforementioned examples of FIG. 25, the BT-RS can have a physical signal structure similar to the physical signal structure of CSI-RS. In another example of the aforementioned examples of FIG. 25, the BT-RS can have a physical signal structure similar to the physical signal structure of SRS.

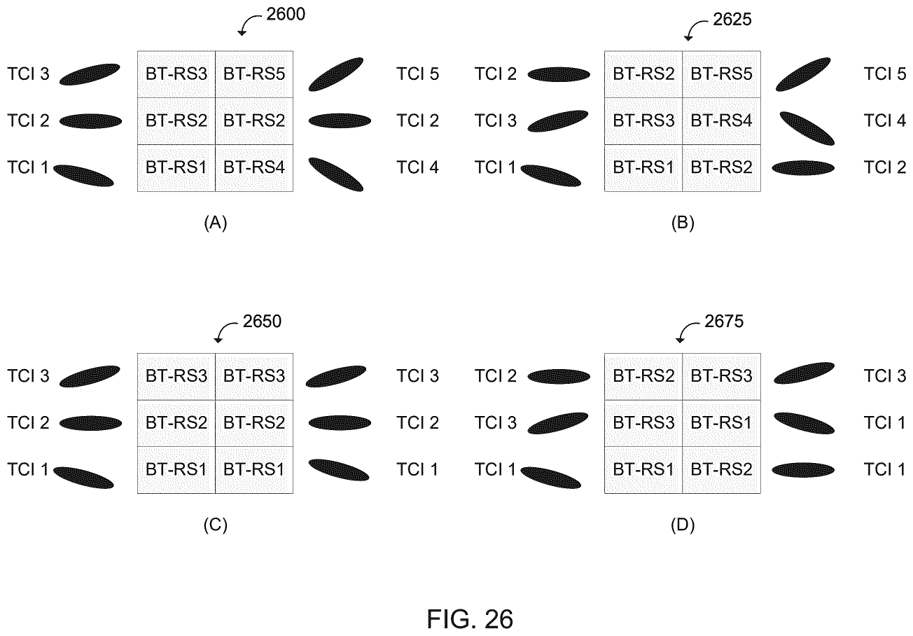

FIG. 26 illustrates further examples of RB allocation to different types of reference signals used in UL channel transmission according to embodiments of the present disclosure. For example, the RB allocation can be implemented by any of the UEs 111-116 of FIG. 1. This example is for illustration only and can be used without departing from the scope of the present disclosure.

In yet another example, there are two BT-RS symbols. In one example, the BT-RS symbols are consecutive. In one example, BT-RS symbols are non-consecutive. In one example, some of the BT-RS occur in both symbols (e.g., BT-RS2 in example 2600 of FIG. 26), while other BT-RS occur in one symbol (either symbol 0, such as BT-RS1 and BT-RS3 in example 2600, or symbol 1 such BT-RS4 and BT-RS5 in example 2600). In one example, BT-RS allocated to both BT-RS symbols are allocated the same frequency. In one example, the frequency allocation of each BT-RS symbol is split into three frequency bands, as illustrated in example 2600:
In one example, frequency band 0 is allocated to BT-RS1 in BT-RS symbol 0 and frequency band 0 is allocated to BT-RS4 in BT-RS symbol 1.
In one example, frequency band 1 is allocated to BT-RS2 in BT-RS symbol 0 and BT-RS symbol 1, in this example, there is no frequency hopping of DM-RS between symbols.
In one example, frequency band 2 is allocated to BT-RS3 in DM-RS/BT-RS symbol 0 and frequency band 2 is allocated to BT-RS5 in DM-RS/BT-RS symbol 1.

In a variant of the aforementioned examples, the number of frequency bands can be N. In one example, N=2. In one example, N=1 (e.g., one BT-RS per OFDM symbol).

In yet another example, there are two BT-RS symbols. In one example, the BT-RS symbols are consecutive. In one example, the BT-RS symbols are non-consecutive. In one example, some of the BT-RS occur in both symbols (e.g., BT-RS2 in example 2625 of FIG. 26), while other BT-RS occur in one symbol (either symbol 0, such as BT-RS1 and BT-RS3 in example 2625, or symbol 1 such BT-RS4 and BT-RS5 in example 2625). In one example, BT-RS allocated to both BT-RS symbols can be allocated different frequencies (e.g., hopping between the first symbol and the second symbol). In one example, the frequency allocation of each BT-RS symbol is split into three frequency bands, as illustrated in example 2625:
In one example, frequency band 0 is allocated to BT-RS1 in BT-RS symbol 0 and frequency band 0 is allocated to BT-RS2 in BT-RS symbol 1.
In one example, frequency band 1 is allocated to BT-RS3 in BT-RS symbol 0 and frequency band 1 is allocated to BT-RS4 in BT-RS symbol 1.
In one example, frequency band 2 is allocated to BT-RS2 in BT-RS symbol 0 and frequency band 2 is allocated to BT-RS5 in BT-RS symbol 1.
In a variant of the aforementioned examples, the number of frequency bands can be N. In one example, N=2. In one example, N=1 (e.g., one BT-RS per OFDM symbol).

In yet another example, there are two BT-RS symbols. In one example, the BT-RS symbols are consecutive. In one example, the BT-RS symbols are non-consecutive. In one example, the BT-RS occur in both symbols. In one example, BT-RS allocated to both BT-RS symbols are allocated the same frequency. In one example, the frequency allocation of each BT-RS symbol is split into three frequency bands, as illustrated in example 2650 of FIG. 26:
In one example, frequency band 0 is allocated to BT-RS1 in BT-RS symbol 0 and BT-RS symbol 1.
In one example, frequency band 1 is allocated to BT-RS2 in BT-RS symbol 0 and BT-RS symbol 1.
In one example, frequency band 2 is allocated to BT-RS3 in BT-RS symbol 0 and BT-RS symbol 1.
In a variant of the aforementioned examples, the number of frequency bands can be N. In one example, N=2.

In yet another example, there are two BT-RS symbols. In one example, the BT-RS symbols are consecutive. In one example, the BT-RS symbols are non-consecutive. In one example, the BT-RS occur in both symbols. In one example, BT-RS allocated to both BT-RS symbols can be allocated different frequencies (e.g., hopping between the first symbol and the second symbol). In one example, the frequency allocation of each BT-RS symbol is split into three frequency bands, as illustrated in example 2675 of FIG. 26:
In one example, frequency band 0 is allocated to BT-RS1 in BT-RS symbol 0 and frequency band 0 is allocated to BT-RS2 in BT-RS symbol 1.
In one example, frequency band 1 is allocated to BT-RS3 in BT-RS symbol 0 and frequency band 1 is allocated to BT-RS1 in BT-RS symbol 1.
In one example, frequency band 2 is allocated to BT-RS2 in BT-RS symbol 0 and frequency band 2 is allocated to BT-RS3 in BT-RS symbol 1.
In a variant of the aforementioned examples, the number of frequency bands can be N. In one example, N=2. In one example, N=1 (e.g., one BT-RS per OFDM symbol).

In the aforementioned mentioned: BT-RS1 uses TCI state 1 or spatial domain filter 1 or spatial relation 1, BT-RS2 uses TCI state 2 or spatial domain filter 2 or spatial relation 2, BT-RS3 uses TCI state 3 or spatial domain filter 3 or spatial relation 3, BT-RS4 uses TCI state 4 or spatial domain filter 4 or spatial relation 4, and BT-RS5 uses TCI state 5 or spatial domain filter 5 or spatial relation 5.

In one example of the aforementioned examples of FIG. 26, the BT-RS can have a physical signal structure similar to the physical signal structure of DM-RS. In another example of the aforementioned examples of FIG. 26, the BT-RS can have a physical signal structure similar to the physical signal structure of CSI-RS. In another example of the aforementioned examples of FIG. 26, the BT-RS can have a physical signal structure similar to the physical signal structure of SRS.

In one example, within respective frequency bands, one or more CDM groups are used for respective BT-RS. In one example, there is one or more DM-RS symbols wherein the entire frequency allocation of the DM-RS symbol is used for DM-RS, wherein TCI state 0 or spatial domain filter 0 or spatial relation 0. In one example, for symbols used for data transmission (e.g., for transmitting the encoded and modulated UL-SCH and/or UCI), TCI state 0 or spatial domain filter 0 or spatial relation 0 is used. In aforementioned, example, TCI state 0 or spatial domain filter 0 or spatial relation 0, is the TCI state or spatial domain filter or spatial relation of the main beam. TCI state 1 . . . M, or spatial domain filter 1 . . . M or spatial relation 1 . . . M, is the TCI state or spatial domain filter or spatial relation of the 1^{st}, . . . Mth beam respectively.

In the above description of beam tracking reference signal transmitted with UL data (e.g., PUSCH or PUCCH), while the examples described are mainly for the case of a BT-RS with a signal structure similar to that of DM-RS, the BT-RS can also have a physical signal structure similar to the physical signal structure of CSI-RS or SRS as describe later in this disclosure.

In the present disclosure, an embodiment of beam tracking reference signal transmitted outside UL transmissions is provided.

In one example, the UE can transmit one or more reference signals for periodic or continuous beam tracking (for brevity referred to as beam tracking reference signal or SBT-RS), as explained in this disclosure, outside the PUSCH transmission. In one example, the SBT-RS can have a physical signal structure similar to the physical signal structure of CSI-RS or SRS as described later in this disclosure. In one example, the SBT-RS can have a physical signal structure similar to the physical signal structure of DM-RS as aforementioned. In one examples, the SBT-RS can be NZP CSI-RS (e.g., used for beam measurements). In one examples, the SBT-RS can be SRS (e.g., used for beam measurements).

In one example, a UE is configured with TCI states, and is configured SBT-RSes and is further configured an association between the TCI states and SBT-RSes, e.g., a TCI state is associated with up M SBT-RS. For example, if a UE is indicated a TCI state. In another example, the association between the TCI states and SBT-RSes can be indicated to the UE by a MAC CE (for example, for the activated TCI states/TCI state code points). In another example, the UE can be indicated the SBT-RS(es) to transmit, e.g., by RRC or MAC CE or L1 control (e.g., DCI Format) signaling. In one example, the DCI Format is UE specific. In one example, the DCI Format is to a group of UEs (e.g., group common DCI). For example, the UE can be indicated to transmit M SBT-RS(es).

FIG. 27 illustrates another example beam or spatial domain transmission filter 2700 according to embodiments of the disclosure. For example, filter 2700 can be implemented by any of the UEs 111-116 of FIG. 1. This example is for illustration only and other embodiments can be used without departing from the scope of the present disclosure.

In one example, the UE can be configured to transmit reference signals outside of the UL data transmissions (e.g., outside of PUSCH and/or PUCCH). These signals can be transmitted periodically, semi-persistently or aperiodically. As illustrated in FIG. 27, the UE transmits M beam tracking reference signals (SBT-RS) wherein SBT-RS i, for i=1, . . . , M, is transmitted using beam or spatial domain transmission filter i associated with the indicated or main beam (or indicated or main spatial domain transmission filter). The term beam tracking reference signal (SBT-RS) is used to described the functionality of the reference signal to be used for beam tracking or identifying new beams as the channel conditions change. The SBT-RS transmitted outside of the UL channel, and can be transmitted periodically, semi-persistently or aperiodically. The SBT-RS can be configured according to the following examples, as described in this disclosure:
In one example, a SRS is configured with N antenna ports, of the N antenna ports N₀ antenna ports follow the spatial domain filter (or beam or TCI state) of the indicated or main TCI state, N₁ antenna ports use a first spatial domain transmission filter for a first adjacent or associated beam or TCI state, N₂ antenna ports use a second spatial domain transmission filter for a second adjacent or associated beam or TCI state, . . . , N_{M} antenna ports use a Mth spatial domain transmission filter for a Mth adjacent or associated beam or TCI state. In one example, N₀+N₁+N₂ . . . +N_{M}≤N. In one example, N₀+N₁+N₂ . . . +N_{M}=N. In one example, N₀=N₁= . . . =Nₘ. In one example, N₁=N₂= . . . =Nₘ. In one example, N₀=0.
In one example, a SRS is configured for SBT-RS separate from the DM-RS used for the demodulation of the UL channel. The SBT-RS has a physical signal structure similar to SRS, but transmitted from the UE. In one example, the SBT-RS (or SRS for beam tracking) can be configured in symbols different from the symbols used for SRS for other purposes. In one example, the SBT-RS (or SRS for beam tracking) can be configured in resource blocks (RBs) different from the RBs used for the SRS for other purposes. In one example, the SBT-RS (or SRS for beam tracking) can be configured in resource element (REs) different from the REs used for the SRS for other purposes. In one example, one SRS resource for beam tracking is configured for M beam tracking reference signals (e.g., different antenna ports are associated with different SBT-RS). In one example, K SRS resources for beam tracking are configured for M SBT-RS, e.g., each of the M SBT-RS is associated with one of the K SRS configured for beam tracking. In one example, M SRS for beam tracking are configured for M SBT-RS, e.g., with a one-to-one association.
In one example, the SBT-RS has a physical signal structure similar to DM-RS. In one example, the SBT-RS can be configured in symbols different from the symbols used for the SRS. In one example, the SBT-RS can be configured in resource blocks (RBs) different from the RBs used for the SRS. In one example, the SBT-RS can be configured in resource element (REs) different from the REs used for the SRS. In one example, one SBT-RS configured with a DM-RS-like physical channel structure is configured for M beam tracking reference signals (e.g., different antenna ports are associated with different SBT-RS). In one example, K SBT-RS configured with a DM-RS-like physical channel structure are configured for M SBT-RS, e.g., each of the M SBT-RS is associated with one of the K SBT-RS. In one example, M SBT-RS configured with a DM-RS-like physical channel structure are configured for M SBT-RS, e.g., with a one-to-one association.
In one example, the SBT-RS has a physical signal structure similar to CSI-RS, but transmitted from the UE. In one example, the SBT-RS can be configured in symbols different from the symbols used for the SRS. In one example, the SBT-RS can be configured in resource blocks (RBs) different from the RBs used for the SRS. In one example, the SBT-RS can be configured in resource element (REs) different from the REs used for the SRS. In one example, one SBT-RS configured with a CSI-RS-like physical channel structure is configured for M beam tracking reference signals (e.g., different antenna ports are associated with different SBT-RS). In one example, K SBT-RS configured with a CSI-RS-like physical channel structure are configured for M SBT-RS, e.g., each of the M SBT-RS is associated with one of the K SBT-RS. In one example, M SBT-RS configured with a CSI-RS-like physical channel structure are configured for M SBT-RS, e.g., with a one-to-one association.

In one example, a SRS-like signal structure can use distributed CDM groups, and a CSI-RS-like signal structure can use localized CDM groups. In one example, a distributed CDM group has non-contiguous REs. In one example, a localized CDM group has contiguous REs.

In the present disclosure, an association of beams is provided.

In one example, a beam can be identified by a TCI state ID or reference signal (RS ID), the reference signal can be a SS/PBCH block index or a CSI-RS or a SRS. The network can configure or update (e.g., through higher layer signaling or through dynamic signaling), as aforementioned an association between an indicated or main beam and a set (e.g., up to M) of adjacent or associated beams (e.g., SBT-RS) for example as shown in Table 5 above.

In one example, the beams are associated with UL signals outside the UL data transmission. The UE can transmit the reference signals associated with the indicated or main beam (or TCI state) based on the aforementioned association.

In one example, if a UE is indicated multiple TCI states (e.g., for multi-TRP), for example two indicated TCI states, the UE can transmit first reference signals associated with the first indicated or main beam (or TCI state), and second reference signals associated with the second indicated or main beam (or TCI state) based on the aforementioned association.

In one example, the UE transmits SRS using a main beam (a main spatial domain transmission filter). In addition, the network transmits M beam tracking reference signals (SBT-RS) wherein SBT-RS i, for i=1, . . . , M, is transmitted using beam or spatial domain transmission filter i associated with the main beam (or main spatial domain transmission filter) as illustrated in FIG. 27.

In a variant example, the UE is indicated two (or more)-TCI states, e.g., a first TCI state to communicate with a first TRP and second TCI state to communicate with a second TRP. The UE transmits a first SRS, using the first TCI state, or corresponding first spatial relation or first spatial domain transmission filter. The UE transmits a second SRS, using the second TCI state, or corresponding second spatial relation or second spatial domain transmission filter. In one example, the UE transmits a first M₁ SBT-RS associated with first TCI state or first spatial relation or first spatial domain transmission filter. In one example, the UE transmits a second M₂ SBT-RS associated with second TCI state or second spatial relation or second spatial domain transmission filter. In one example, M₁=M₂=M. In one example, M₁ and M₂ can be different

In one example, the UE transmits a first beam tracking reference signals (SBT-RS1) and a second beam tracking reference signal (SBT-RS2), the receiver, e.g., in the base station measures a first metric from SBT-RS1 and a second metric from SBT-RS2, and the base station reports to the UE the first metric and the second metric. In one example, the UE can adjust the TCI state or spatial relation or spatial domain transmission filter the UE uses for UL transmissions (e.g., for PUSCH and/or PUCCH) based on the first metric and the second metric, and in case of reciprocity, the adjustment can also apply to the TCI state or spatial relation or spatial domain reception filter the UE uses for DL transmissions (e.g., DL transmissions following a main or indicated joint TCI state). In one example, SBT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

and SBT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] .$$

In a variant example, the first metric is measured using the SRS or PUSCH or PUCCH (e.g., using the main or indicated TCI state) and the second metric is measured using a SBT-RS. In one example, the beam (or spatial domain filter) of the SRS or PUSCH or PUCCH is the sum beam, and the beam (or spatial domain filter) of the SBT-RS is the difference beam. In a variant example, of the aforementioned examples, the gNB determines a TCI state or spatial relation based on the first metric and the second metric, and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the UE determines a TCI state or spatial relation based on the first metric and the second metric, and the UE signals the TCI state or the spatial relation to the gNB for the gNB and/or UE to use for UL transmissions and in case of reciprocity for DL transmissions (e.g., DL transmissions following a main or indicated joint TCI state).

In one example, the UE transmits a first beam tracking reference signals (SBT-RS1) and a second beam tracking reference signal (SBT-RS2), the receiver, e.g., in the base station, measures a first metric from SBT-RS1 and a second metric from SBT-RS2, the base station calculates a quantity based on the first metric and the second metric, and the base station reports the quantity to the UE. In one example, the UE can adjust the TCI state or spatial relation or spatial domain transmission filter the UE uses for UL transmissions (e.g., for PUSCH and/or PUCCH) based on the quantity, and in case of reciprocity, the adjustment can also apply to the TCI state or spatial relation or spatial domain reception filter the UE uses for DL transmissions (e.g., DL transmissions following a main or indicated joint TCI state). In one example, SBT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

and SBT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] .$$

In a variant example, the first metric is measured using the SRS or PUSCH or PUCCH (e.g., using the main or indicated TCI state) and the second metric is measured using a SBT-RS. In one example, the beam (or spatial domain filter) of the SRS or PUSCH or PUCCH is the sum beam, and the beam (or spatial domain filter) of the SBT-RS is the difference beam. In a variant example, of the aforementioned examples, the gNB determines a TCI state or spatial relation based on the quantity (from the first metric and the second metric), and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the UE determines a TCI state or spatial relation based on the quantity (from the first metric and the second metric), and the UE signals the TCI state or the spatial relation to the gNB for the gNB and/or UE to use for UL transmissions and in case of reciprocity for DL transmissions (e.g., DL transmissions following a main or indicated joint TCI state).

In one example, the UE transmits a first beam tracking reference signals (SBT-RS1) and a second beam tracking reference signal (SBT-RS2), the receiver, e.g., in the base station measures a first metric from SBT-RS1 and a second metric from SBT-RS2, and the base station reports to the UE the first metric and the second metric. In one example, the UE can adjust the TCI state or spatial relation or spatial domain transmission filter the UE uses for UL transmissions (e.g., for PUSCH and/or PUCCH) based on the first metric and the second metric, and in case of reciprocity, the adjustment can also apply to the TCI state or spatial relation or spatial domain reception filter the UE uses for UL transmissions (e.g., UL transmissions following a main or indicated joint TCI state).
In one example, SBT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

in a first dimension (e.g., azimuth) and

$$[ {d}_{0} , d , … {d}_{\frac{n}{2} - 1} , {d}_{\frac{n}{2}} , {d}_{\frac{n}{2} + 1} , … , {d}_{n - 1} ] ,$$

in a second dimension (e.g. zenith), and
In one example, SBT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ]$$

in the first dimension (e.g., azimuth), in one example the coefficients of the second dimension (e.g., zenith) can correspond to

$$[ {d}_{0} , d , … {d}_{\frac{n}{2} - 1} , {d}_{\frac{n}{2}} , {d}_{\frac{n}{2} + 1} , … , {d}_{n - 1} ] .$$

In one example, SBT-RS3 is a difference beam (or difference spatial domain filter) in the second dimension (e.g., zenith), e.g., with beam coefficients

$$[ {d}_{0} , d , … {d}_{\frac{n}{2} - 1} , - {d}_{\frac{n}{2}} , - {d}_{\frac{n}{2} + 1} , … , - {d}_{n - 1} ] ,$$

in one example the coefficients of the first dimension (e.g., azimuth) can correspond to

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] .$$

In a variant example, the first metric is measured using the SRS (e.g., using the main or indicated TCI state) (e.g., SRS or PUSCH or PUCCH is used as SBT-RS1) and the second metric and the third metric are measured using a SBT-RS (e.g., SBT-RS2 and SBT-RS3). In one example, the beam (or spatial domain filter) of the SRS or PUSCH or PUCCH is the sum beam, and the beam (or spatial domain filter) of the SBT-RS2 is the difference beam in the first dimension (e.g., azimuth), and the beam (or spatial domain filter) of the SBT-RS3 is the difference beam in the second dimension (e.g., zenith). In a variant example, of the aforementioned examples, the gNB determines a TCI state or spatial relation based on the first metric, the second metric and/or the third metric, and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the UE determines a TCI state or spatial relation based on the first metric, the second metric and/or the third metric, and the UE signals the TCI state or the spatial relation to the gNB for the gNB and/or UE to use for UL transmissions and in case of reciprocity for DL transmissions (e.g., DL transmissions following a main or indicated joint TCI state).

In one example, the UE transmits a first beam tracking reference signals (SBT-RS1), a second beam tracking reference signal (SBT-RS2) and a third beam tracking reference signal (SBT-RS3), the receiver, e.g., in the base station, measures a first metric from SBT-RS1, a second metric from SBT-RS2 and a third metric from SBT-RS3. In one example, the base station calculates a quantity(s) based on the first metric, the second metric and/or the third metric, and the base station reports the quantity to the UE. In one example, the base station calculates a first quantity based on the first metric and the second metric, and the base station calculates a second quantity based on the first metric and the third metric, and the base station reports the first quantity and the second quantity to the UE. In one example, the UE can adjust the TCI state or spatial relation or spatial domain transmission filter the UE uses for UL transmissions (e.g., for PUSCH and/or PUCCH and/or SRS) based on the quantity or quantities, and in case of reciprocity, the adjustment can also apply to the TCI state or spatial relation or spatial domain reception filter the UE uses for DL transmissions (e.g., DL transmissions following a main or indicated joint TCI state).
In one example, SBT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

in a first dimension (e.g., azimuth) and

$$[ {d}_{0} , d , … {d}_{\frac{n}{2} - 1} , {d}_{\frac{n}{2}} , {d}_{\frac{n}{2} + 1} , … , {d}_{n - 1} ] ,$$

in a second dimension (e.g., zenith),
In one example, SBT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] ,$$

in the first dimension (e.g., azimuth), in one example the coefficients of the second dimension (e.g., zenith) can correspond to

$$[ {d}_{0} , d , … {d}_{\frac{n}{2} - 1} , {d}_{\frac{n}{2}} , {d}_{\frac{n}{2} + 1} , … , {d}_{n - 1} ] ,$$

In one example, SBT-RS3 is a difference beam (or difference spatial domain filter) in the second dimension (e.g., zenith), e.g., with beam coefficients

$$[ {d}_{0} , d , … {d}_{\frac{n}{2} - 1} , - {d}_{\frac{n}{2}} , - {d}_{\frac{n}{2} + 1} , … , - {d}_{n - 1} ] ,$$

in one example the coefficients of the first dimension (e.g., azimuth) can correspond to

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] .$$

In a variant example, the first metric is measured using the SRS or PUSCH or PUCCH (e.g., using the main or indicated TCI state) (e.g., SRS or PUSCH or PUCCH is used as SBT-RS1) and the second metric and the third metric are measured using a SBT-RS (e.g., CBT-RS2 and CBT-RS3). In one example, the beam (or spatial domain filter) of the SRS or PUSCH or PUCCH is the sum beam, and the beam (or spatial domain filter) of the SBT-RS2 is the difference beam in the first dimension (e.g., azimuth), and the beam (or spatial domain filter) of the CBT-RS3 is the difference beam in the second dimension (e.g., zenith). In a variant example, of the aforementioned examples, the gNB determines a TCI state or spatial relation based on the quantity(s) (from the first metric, the second metric and/or the third metric), and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the gNB determines a TCI state or spatial relation based on a first quantity (from the first metric and the second metric), a second quantity (from the first metric and the third metric), and the gNB signals the TCI state or the spatial relation to the UE for the UE and/or gNB to use for UL transmissions and in case of reciprocity for DL transmissions (e.g., DL transmissions following a main or indicated joint TCI state). In a variant example, of the aforementioned examples, the UE determines a TCI state or spatial relation based on the quantity or quantities (from the first metric and/or the second metric and/or third metric), and the UE signals the TCI state or the spatial relation to the gNB for the gNB and/or UE to use for UL transmissions and in case of reciprocity for DL transmissions (e.g., DL transmissions following a main or indicated joint TCI state).

In the present disclosure, mapping SBT-RS to REs or RBs or symbols outside of an UL transmission is provided.

In one example, a UE can transmit SRS or SBT-RS using a main spatial domain transmission filter (e.g., main beam) and one or more adjacent spatial domain transmission filters (e.g., adjacent beam(s)).

In one example, SRS using the main spatial domain transmission has N-ports. In one example, a SRS (referred to as SBT-RS for Beam tracking reference signal) using an adjacent spatial domain transmission filter has one port. In one example, a SBT-RS using an adjacent spatial domain transmission filter has two ports. In one example, a SBT-RS using an adjacent spatial domain transmission filter has N-ports.

In one example, the SRS and the SBT-RS are multiplexed in a same symbol or in a same group of symbols. In one example, the SRS uses a first one or more comb offsets, and the SBT-RS uses a second one or comb offsets. In one example, the SRS uses a first one or more CDM groups, and the SBT-RS uses a second one or CDM groups.

In one example, a symbol can have SRS and SBT-RS, for example, a first antenna port(s) or a first CDM group(s) or a first set of RE(s) or a first set of RB(s) or a first comb offset(s) is used for SRS, and a second antenna port(s) or a second CDM group(s) or a second set of RE(s) or a second set of RB(s) or a second comb offset(s) is used for SBT-RS. The mapping of CDM groups or comb offsets to REs can be as described in this disclosure.

In one example, a symbol can have SRS and SBT-RS, for example, a first antenna port(s) or a first CDM group(s) or a first set of RE(s) or a first set of RB(s) or a first comb offset(s) is used for SRS, and a second antenna port(s) or a second CDM group(s) or a second set of RE(s) or a second set of RB(s) or a second comb offset(s) is used for SBT-RS. The mapping of CDM groups or comb offsets to REs can be as described in this disclosure. In addition, a symbol can have SRS with no SBT-RS.

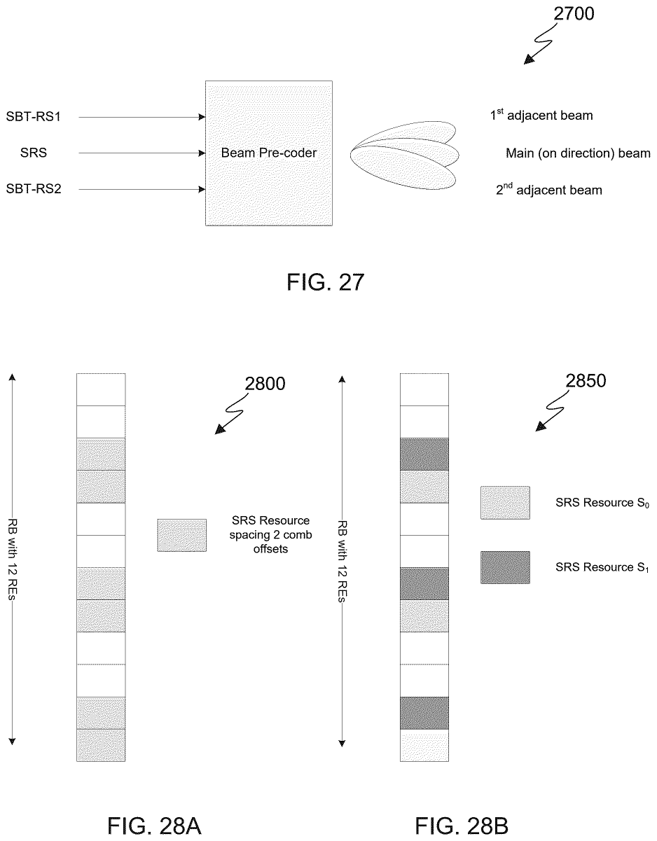

FIGS. 28A-28B illustrate example SRS resources 2800 and 2850 according to embodiments of the present disclosure. For example, SRS resources 2800 and 2850 can be implemented by any of the UEs 111-116 of FIG. 1. This example is for illustration only and can be used without departing from the scope of the present disclosure.

In one example, N-port SRS is configured, wherein the N-port SRS has n comb offsets. In one example, each comb offset is associated with N/n ports. FIG. 28A illustrates an example of SRS resource 2800 with two-comb offsets—comb offset 0 and comb offset 1 (in the example of FIG. 28A the comb size is 4). In one example, n SRS resources are configured, wherein SRS resource Sᵢ is associated with comb offset cᵢ for i=0, 1, . . . , n−1, and SRS resource Sᵢ is associated with Nᵢ ports. In one example, Nᵢ can be different for each SRS resources, with

$${\sum }_{i = 0}^{n - 1} {N}_{i} = N .$$

In one example, Nᵢ can be the same for each SRS resource, Nᵢ=N/n, for i=0, 1, . . . , n−1. FIG. 28B illustrates an example of two SRS resources 2850, a first SRS resource S₀ with comb offset 0, and second SRS resource S₁ with comb offset 1 (in the example of FIG. 28B the comb size is 4).

In one example, a SRS configuration is used for SRS and SBT-RS. In one example, a first SRS configuration is used SRS and SBT-RS, and a second SRS configuration is used for SBT-RS. In one example, a first SRS configuration is used SRS, and a second SRS configuration is used for SBT-RS.

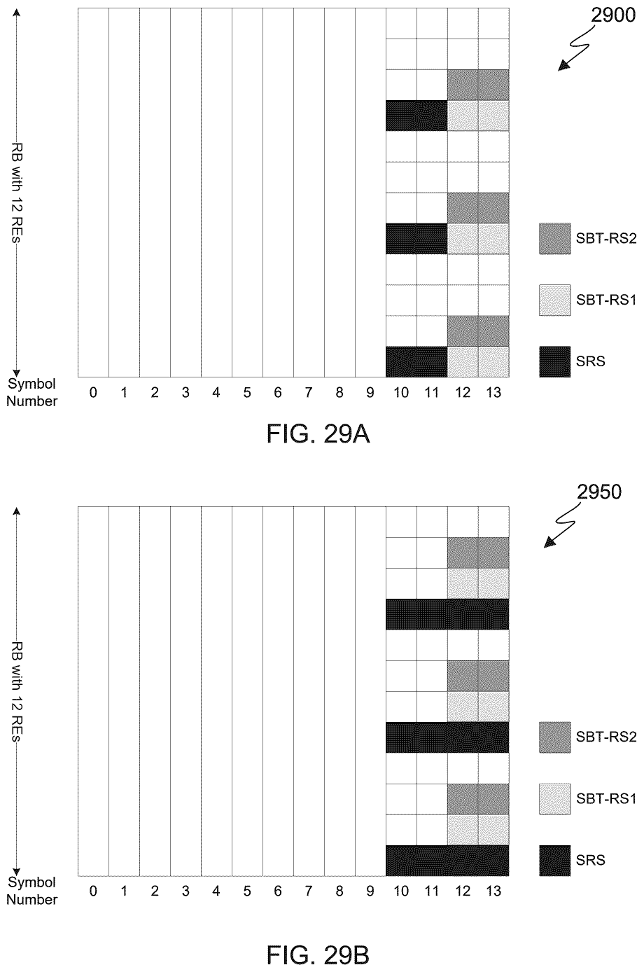

FIGS. 29A-29B illustrate example configurations 2900 and 2950 used for SRS and SBT-RS according to embodiments of the present disclosure. For example, configurations 2900 and 2950 can be implemented by any of the UEs 111-116 of FIG. 1. This example is for illustration only and can be used without departing from the scope of the present disclosure.

In one example, a CSI-RS configuration is used for SRS and SBT-RS, wherein SRS and SBT-RS are mapped to comb offsets in different symbols. For example, in FIG. 29A, SRS is mapped to the comb offset 0 in symbols 10 and 11, and SBT-RS is mapped to comb offset 0 and 1 in symbols 12 and 13. In the example of FIG. 29A the comb size is 4.

In one example, a SRS configuration is used for SRS and SBT-RS, wherein SRS and SBT-RS are mapped to comb offsets in the same or different symbols. For example, in FIG. 29B, SRS is mapped to the comb offset 0 in symbols 10-13 and SBT-RS is mapped to comb offsets 1 and 2 in symbols 12 and 13. In the example of FIG. 29B the comb size is 4.

In one example, a SRS configuration is used for SRS and SBT-RS, and a comb offset can include ports for SRS and ports for SBT-RS.

In one example, a comb offset used for SBT-RS is associated with one SBT-RS. In one example, of, a comb offset used for SBT-RS can be associated with more than one SBT-RS.

In one example, a SRS configuration is used at least for multiple SBT-RS (e.g., SBT-RS1, SBT-RS2, etc.). In one example, different SBT-RS can be mapped to different antenna ports of a same comb offset (for example, SBT-RS1 is mapped to a first port(s) of a comb offset, and SBT-RS2 is mapped to a second port(s) of the comb offset).

In one example, a SRS configuration is used at least for multiple SBT-RS (e.g., SBT-RS1, SBT-RS2, etc.). In one example, different SBT-RS are mapped to different comb offset (for example, SBT-RS1 is mapped to a first comb offset(s), and SBT-RS2 is mapped to a second comb offset(s)), wherein the comb offsets can be in a same symbol(s) or in different symbol(s).

In one example, a SRS configuration is used at least for multiple SBT-RS (e.g., SBT-RS1, SBT-RS2, etc.). In one example, different SBT-RS are mapped to same or different CDM groups in different symbols(s) (for example, SBT-RS1 is mapped to a first CDM group(s) in first symbol(s), and SBT-RS2 is mapped to a CMD group(s) in second symbol(s)).

In one example, for a periodic or semi-persistent SRS or SBT-RS configuration, the following parameters are configured:
A periodicity of SRS or SBT-RS, in units of time (e.g., in slots) and an offset or offsets within the periodicity in units of time (e.g., slots). In one example, the offset is with respect to slot 0 of frame 0. In one example, the periodicity is T units of time (e.g., slots), and the offset is O units of time (e.g., slots), wherein O∈{0, 1, . . . , T−1}, the SRS or SBT-RS is transmitted in time unit (e.g., slot) with offset O. In one example, offset 0 is O₀ units of time (e.g., slots), offset 1 is O₁ units of time (e.g., slots), . . . , offset N−1 is O_{N-1} units of time (e.g., slots) wherein Oᵢ∈{0, 1, . . . , T−1}, for i=0, 1, . . . , N−1, the SRS or SBT-RS is transmitted in time unit (e.g., slot) with offset Oᵢ, for i=0, 1, . . . , N−1.
The symbols within a slot for SRS or SBT-RS. In one example, symbols sₘ, sₘ₊₁, . . . s_{m+d} are used for SRS or SBT-RS. In one example, the symbols can contiguous. In one example, the symbols can be non-contiguous. In one example, the symbols in a slot used for used for SRS or SBT-RS are given by a starting symbol and/or duration (e.g., number of symbols), and a repetition R wherein an SRS or SBT-RS is repeated across R symbols.
The size of the comb K and a comb offset or comb offsets. In one example, a comb offset can be a value in the set {0, 1, . . . , K−1}.
A set of frequency units (e.g., RBs) within the SRS or SBT-RS bandwidth that can be used for SRS or SB-RS. In one example, the frequency units (e.g., RBs) for SRS or SBT-RS are contiguous. In one example, the frequency units (e.g., RBs) for SRS or SBT-RS are non-contiguous. In one example, the frequency units (e.g., RBs) for SRS or SBT-RS across transmission instances of SRS or SBT-RS follow a hopping pattern. For example, the hopping pattern can be a function of the SRS transmission instance counter (e.g., n_{SRS}) or of the SBT-RS transmission instance counter (e.g., n_{SBT-RS}). In one example, the SRS or SBT-RS is countered on groups of R symbols in a slot (wherein R is the repetition factor) and across slots used for SRS or SBT-RS transmission. In one the set of frequency units (e.g., RBs) can be determined by parameter such C_{SRS}, B_{SRS}, bₕₒₚ, n_{shift} and n_{RRC}, as aforementioned.

In one example, for an aperiodic SRS or SBT-RS configuration, the following parameters are configured:
Offset or offsets in units of time (e.g., slots) from the time unit (e.g., slot) triggering the aperiodic SRS or SBT-RS (e.g., using L1 control (e.g., DCI Format), or MAC CE or RRC), or from the time unit (e.g., slot) containing the acknowledgment of the triggering message. In one example, the offset is O is units of time (e.g., slots), wherein O∈{0, 1, . . . , M}, e.g., M=32, the SRS or SBT-RS is transmitted in a time unit (e.g., slot) with offset O from the trigger or the acknowledgement of the trigger. In one example, offset 0 is O₀ units of time (e.g., slots), offset 1 is O₁ units of time (e.g., slots), . . . , offset N−1 is O_{N-1} units of time (e.g., slots) wherein Oᵢ∈{0, 1, . . . , M}, e.g., M=32, for i=0, 1, . . . , N−1, the SRS or SBT-RS is transmitted in time unit (e.g., slot) with offset Oᵢ, for i=0, 1, . . . , N−1 from the trigger or the acknowledgement of the trigger.
Antenna port or antenna port(s) for SRS or SBT-RS transmission within an SRS or SBT-RS transmission instance. In one example, the antenna port determines the cyclic shift of the sequence used for SRS or SBT-RS transmission as aforementioned. In one example, the antenna port determines the comb offset used for SRS or SBT-RS transmission as aforementioned.
The symbols within a slot for SRS or SBT-RS. In one example, symbols sₘ, sₘ₊₁, . . . s_{m+d} are used for SRS or SBT-RS. In one example, the symbols can contiguous. In one example, the symbols can be non-contiguous. In one example, the symbols in a slot used for used for SRS or SBT-RS are given by a starting symbol and/or duration (e.g., number of symbols), and a repetition R wherein an SRS or SBT-RS is repeated across R symbols.
The size of the comb K and a comb offset or comb offsets. In one example, a comb offset can be a value in the set {0, 1, . . . , K−1}.
A set of frequency units (e.g., RBs) within the SRS or SBT-RS bandwidth that can be used for SRS or SB-RS. In one example, the frequency units (e.g., RBs) for SRS or SBT-RS are contiguous. In one example, the frequency units (e.g., RBs) for SRS or SBT-RS are non-contiguous. In one example, the frequency units (e.g., RBs) for SRS or SBT-RS across transmission instances of SRS or SBT-RS follow a hopping pattern. For example, the hopping pattern can be a function of the SRS transmission instance counter (e.g., n_{SRS}) or of the SBT-RS transmission instance counter (e.g., n_{SBT-RS}). In one example, the SRS or SBT-RS is countered on groups of R symbols in a slot (wherein R is the repetition factor) and across slots used for SRS or SBT-RS transmission. In one the set of frequency units (e.g., RBs) can be determined by parameters such C_{SRS}, B_{SRS}, bₕₒₚ, n_{shift} and n_{RRC}, as aforementioned.

In one example, the SRS/SBT-RS configuration can be used for SRS and one or more SBT-RS.
In one example, for a periodic or semi-persistent SRS/SBT-RS configuration, a same periodicity is configured for SRS and for one or more SBT-RS.
In one example, for a periodic or semi-persistent SRS/SBT-RS configuration, a first periodicity is configured for SRS and a second periodicity is configured for one or more SBT-RS. In one example, the first periodicity and the second periodicity are integer multiples of one another, e.g., if the first periodicity is T₁ and the second periodicity is T₂, then either T₁/T₂ is an integer or T₂/T₁ is an integer.
In one example, for a periodic or semi-persistent SRS/SBT-RS configuration, a first periodicity is configured for SRS and a second periodicity is configured for a first one or more SBT-RS, and a third periodicity is configured for a second one or more SBT-RS, . . . . In one example, the first periodicity and the second periodicity and the third periodicity, . . . are integer multiples of one another.
In one example, for a periodic or semi-persistent SRS/SBT-RS configuration, a same one or more offsets is configured for SRS and for one or more SBT-RS.
In one example, for a periodic or semi-persistent SRS/SBT-RS configuration, a first one or more offsets is configured for SRS and a second one or more offsets is configured for one or more SBT-RS.
In one example, for a periodic or semi-persistent SRS/SBT-RS configuration, a first one or more offsets is configured for SRS and a second one or more offsets is configured for a first one or more SBT-RS, a third one or more offsets is configured for a second one or more SBT-RS, . . . .
In one example, for an aperiodic SRS/SBT-RS configuration, a same one or more offsets is configured for SRS and for one or more SBT-RS.

In one example, for an aperiodic SRS/SBT-RS configuration, a first one or more offsets is configured for SRS and a second one or more offsets is configured for one or more SBT-RS.
In one example, for an aperiodic SRS/SBT-RS configuration, a first one or more offsets is configured for SRS and a second one or more offsets is configured for a first one or more SBT-RS, a third one or more offsets is configured for a second one or more SBT-RS, . . . .
In one example, for an SRS/SBT-RS configuration, a same set of one or more antenna ports is configured for SRS and for one or more SBT-RS. For example, the antenna ports can be used in different time and/or frequency resources for SRS and for SBT-RS.
In one example, for an SRS/SBT-RS configuration, a first set of one or more antenna ports is configured for SRS, and a second set of one or more antenna ports is configured for one or more SBT-RS. In one example, the first set and second set of antenna ports can be used in the same time and frequency resources. In one example, the first set and second set of antenna ports can be used in different time and/or frequency resources.
In one example, for an SRS/SBT-RS configuration, a first set of one or more antenna ports is configured for SRS, and a second set of one or more antenna ports is configured for a first one or more SBT-RS, and a third set of one or more antenna ports is configured for a second one or more SBT-RS, . . . . In one example, the first set and second set and third set . . . of antenna ports can be used in the same time and frequency resources. In one example, the first set and/or second set and/or third set . . . of antenna ports can be used in different time and/or frequency resources. In one example, the second set and third set . . . of antenna ports can be used in the same time and frequency resources.

In one example, for an SRS/SBT-RS configuration, a same set of one or more symbols in a time unit (e.g., slot) is configured for SRS and for one or more SBT-RS. For example, the set of symbols can be determined by a starting symbol and/or a duration and/or a repetition factor.
In one example, for an SRS/SBT-RS configuration, a first set of one or more symbols in a time unit (e.g., slot) is configured for SRS, and a second set of one or more symbols in a time unit (e.g., slot) is configured for one or more SBT-RS.
   In one example, a same starting symbol is configured for the first set and for the second set.
   In one example, a first starting symbol is configured for the first set, and a second starting symbol is configured for the second set.
   In one example, a same duration is configured for the first set and for the second set.
   In one example, a first duration is configured for the first set, and a second duration is configured for the second set.
   In one example, a same repetition factor is configured for the first set and for the second set.
   In one example, a first repetition factor is configured for the first set, and a second repetition factor is configured for the second set.
In one example, for an SRS/SBT-RS configuration, a first set of one or more symbols in a time unit (e.g., slot) is configured for SRS, and a second set of one or more symbols in a time unit (e.g., slot) is configured for a first one or more SBT-RS, and a third set of one or more symbols in a time unit (e.g., slot) is configured for a second one or more SBT-RS, . . . .
   In one example, a same starting symbol is configured for the first set and/or for the second set and/or for the third set,
   In one example, a first starting symbol is configured for the first set, and a second starting symbol is configured for the second set, and a third starting symbol is configured for the third set, . . . . In one example, starting symbols are same for second, third, . . . sets.
   In one example, a same duration is configured for the first set and/or for the second set and/or for the third set, . . . .
   In one example, a first duration is configured for the first set, and a second duration is configured for the second set, and a third duration is configured for the third set, . . . . In one example, durations are same for second, third, . . . sets.
   In one example, a same repetition factor is configured for the first set and/or for the second set and/or for the third set,
   In one example, a first repetition factor is configured for the first set, and a second repetition factor is configured for the second set, and a third repetition factor is configured for the third set, . . . . In one example, repetition factors same for second, third, . . . sets
In one example, for an SRS/SBT-RS configuration, a same comb size, K, is configured for SRS and for one or more SBT-RS.
In one example, for an SRS/SBT-RS configuration, a first comb size is configured for SRS and a second comb size is configured for one or more SBT-RS. In one example, the first comb size and the second comb size are integer multiples of one another, e.g., if the first comb size is K₁ and the second comb size is K₂, then either K₁/K₂ is an integer or K₂/K₁ is an integer.
In one example, for an SRS/SBT-RS configuration, a first comb size is configured for SRS and a second comb size is configured for a first one or more SBT-RS, and a third comb size is configured for a second one or more SBT-RS, . . . . In one example, the first comb size and the second comb size and the third comb size, . . . are integer multiples of one another.
In one example, for an SRS/SBT-RS configuration, a same one or more comb offsets is configured for SRS and for one or more SBT-RS.
In one example, for an SRS/SBT-RS configuration, a first one or more comb offsets is configured for SRS and a second one or more comb offsets is configured for one or more SBT-RS.
In one example, for an SRS/SBT-RS configuration, a first one or more comb offsets is configured for SRS and a second one or more comb offsets is configured for a first one or more SBT-RS, a third one or more comb offsets is configured for a second one or more SBT-RS, . . . .
In one example, for an SRS/SBT-RS configuration, a same set of one or more frequency units (e.g., RB), with or without frequency hopping across SRS or SBT-RS instances, e.g., based on counter n_{SRS} or n_{SBT-RS}, is configured for SRS and for one or more SBT-RS. For example, the set of frequency units (e.g., RBs) can be determined by C_{SRS}, B_{SRS}, bₕₒₚ, n_{shift} and n_{RRC}, as aforementioned.
In one example, for an SRS/SBT-RS configuration, a first set of one or more frequency units (e.g., RB), with or without frequency hopping across SRS instances, e.g., based on counter n_{SRS}, is configured for SRS, and a second set of one or more frequency units (e.g., RB), with or without frequency hopping across SBT-RS instances, e.g., based on counter n_{SBT-RS}, is configured for one or more SBT-RS.
   In one example, a same C_{SRS} is configured for the first set and for the second set.
   In one example, a first C_{SRS} is configured for the first set and a second C_{SRS} is configured for the second set.
   In one example, a same B_{SRS} is configured for the first set and for the second set.
   In one example, a first B_{SRS} is configured for the first set and a second B_{SRS} is configured for the second set.
   In one example, a same bₕₒₚ is configured for the first set and for the second set.
   In one example, a first bₕₒₚ is configured for the first set and a second bₕₒₚ is configured for the second set.
   In one example, a same n_{shift} is configured for the first set and for the second set.
   In one example, a first n_{shift} is configured for the first set and a second n_{shift} is configured for the second set.
   In one example, a same n_{RRC} is configured for the first set and for the second set.
   In one example, a first n_{RRC} is configured for the first set and a second n_{RRC} is configured for the second set.
In one example, for an SRS/SBT-RS configuration, a first set of one or more frequency units (e.g., RB), with or without frequency hopping across SRS instances, e.g., based on counter n_{SRS}, is configured for SRS, and a second set of one or more frequency units (e.g., RB), with or without frequency hopping across SBT-RS instances, e.g., based on counter n_{SBT-RS}, is configured for a first one or more SBT-RS, and a third set of one or more frequency units (e.g., RB), with or without frequency hopping across SBT-RS instances, e.g., based on counter n_{SBT-RS}, is configured for a second one or more SBT-RS, . . . .
   In one example, a same C_{SRS} is configured for the first set and/or for the second set and/or for the third set
   In one example, a first C_{SRS} is configured for the first set and a second C_{SRS} is configured for the second set and a third C_{SRS} is configured for the third set, . . . . In one example, C_{SRS} are same for second, third, . . . sets.
   In one example, a same B_{SRS} is configured for the first set and/or for the second set and/or for the third set . . . .
   In one example, a first B_{SRS} is configured for the first set and a second B_{SRS} is configured for the second set and a third B_{SRS} is configured for the third set, . . . . In one example, B_{SRS} are same for second, third, . . . sets.
   In one example, a same bₕₒₚ is configured for the first set and/or for the second set and/or the third set . . . .
   In one example, a first bₕₒₚ is configured for the first set and a second bₕₒₚ is configured for the second set and a third bₕₒₚ is configured for the third set, . . . . In one example, bₕₒₚ are same for second, third, . . . sets.
   In one example, a same n_{shift} is configured for the first set and/or for the second set and/or for the third set . . . .
   In one example, a first n_{shift} is configured for the first set and a second n_{shift} is configured for the second set and a third n_{shift} is configured for the third set, . . . . In one example, n_{shift} are same for second, third, . . . sets.
   In one example, a same n_{RRC} is configured for the first set and/or for the second set and/or for the third set . . . .
   In one example, a first n_{RRC} is configured for the first set and a second n_{RRC} is configured for the second set and a third n_{RRC} is configured for the third set, . . . . In one example, n_{RRC} are same for second, third, . . . sets.

In one example, the SBT-RS configuration can be used for one or more SBT-RS.
In one example, for a periodic or semi-persistent SBT-RS configuration, a same periodicity is configured for one or more SBT-RS.
In one example, for a periodic or semi-persistent SBT-RS configuration, a first periodicity is configured for a first one or more SBT-RS, and a second periodicity is configured for a second one or more SBT-RS, . . . . In one example, the first periodicity and the second periodicity, . . . are integer multiples of one another, e.g., if the first periodicity is T₁ and the second periodicity is T₂, then either T₁/T₂ is an integer or T₂/T₁ is an integer.
In one example, for a periodic or semi-persistent SBT-RS configuration, a same one or more offsets is configured for one or more SBT-RS.
In one example, for a periodic or semi-persistent SBT-RS configuration, a first one or more offsets is configured for a first one or more SBT-RS, a second one or more offsets is configured for a second one or more SBT-RS, . . . .

In one example, for an aperiodic SBT-RS configuration, a same one or more offsets is configured for one or more SBT-RS.
In one example, for an aperiodic SBT-RS configuration, a first one or more offsets is configured for a first one or more SBT-RS, a second one or more offsets is configured for a second one or more SBT-RS, . . . .
In one example, for an SBT-RS configuration, a same set of one or more antenna ports is configured for one or more SBT-RS. For example, the antenna ports can be used in different time and/or frequency resources for SBT-RS.
In one example, for an SBT-RS configuration, a first set of one or more antenna ports is configured for a first one or more SBT-RS, and a second set of one or more antenna ports is configured for a second one or more SBT-RS, . . . . In one example, the first set and second set, . . . of antenna ports can be used in the same time and frequency resources. In one example, the first set and/or second set . . . of antenna ports can be used in different time and/or frequency resources.
In one example, for an SBT-RS configuration, a same set of one or more symbols in a time unit (e.g., slot) is configured for one or more SBT-RS. For example, the set of symbols can be determined by a starting symbol and/or a duration and/or a repetition factor.
In one example, for an SBT-RS configuration, a first set of one or more symbols in a time unit (e.g., slot) is configured for a first one or more SBT-RS, and a second set of one or more symbols in a time unit (e.g., slot) is configured for a second one or more SBT-RS, . . . .
   In one example, a same starting symbol is configured for the first set and/or for the second set, . . . .
   In one example, a first starting symbol is configured for the first set, and a second starting symbol is configured for the second set, . . . .
   In one example, a same duration is configured for the first set and/or for the second set, . . . .
   In one example, a first duration is configured for the first set, and a second duration is configured for the second set, . . . .
   In one example, a same repetition factor is configured for the first set and/or for the second set, . . . .
   In one example, a first repetition factor is configured for the first set, and a second repetition factor is configured for the second set, . . . .

In one example, for an SBT-RS configuration, a same comb size, K, is configured for one or more SBT-RS.
In one example, for an SBT-RS configuration, a first comb size is configured for a first one or more SBT-RS, and a second comb size is configured for a second one or more SBT-RS, . . . . In one example, the first comb size and the second comb size, . . . are integer multiples of one another, e.g., if the first comb size is K₁ and the second comb size is K₂, then either K₁/K₂ is an integer or K₂/K₁ is an integer.
In one example, for an SBT-RS configuration, a same one or more comb offsets is configured for one or more SBT-RS.
In one example, for an SBT-RS configuration, a first one or more comb offsets is configured for a first one or more SBT-RS, a second one or more comb offsets is configured for a second one or more SBT-RS, . . . .
In one example, for an SBT-RS configuration, a same set of one or more frequency units (e.g., RB), with or without frequency hopping across SRS or SBT-RS instances, e.g., based on counter n_{SBT-RS}, is configured for one or more SBT-RS. For example, the set of frequency units (e.g., RBs) can be determined by C_{SRS}, B_{SRS}, bₕₒₚ, n_{shift} and n_{RRC}, as aforementioned.
In one example, for an SBT-RS configuration, a first set of one or more frequency units (e.g., RB), with or without frequency hopping across SBT-RS instances, e.g., based on counter n_{SBT-RS}, is configured for a first one or more SBT-RS, and a second set of one or more frequency units (e.g., RB), with or without frequency hopping across SBT-RS instances, e.g., based on counter n_{SBT-RS}, is configured for a second one or more SBT-RS, . . . .
   In one example, a same C_{SRS} is configured for the first set and/or for the second set . . . .
   In one example, a first C_{SRS} is configured for the first set and a second C_{SRS} is configured for the second set, . . . .
   In one example, a same B_{SRS} is configured for the first set and/or for the second set . . . .
   In one example, a first B_{SRS} is configured for the first set and a second B_{SRS} is configured for the second set, . . . .
   In one example, a same bₕₒₚ is configured for the first set and/or for the second set . . . .
   In one example, a first bₕₒₚ is configured for the first set and a second bₕₒₚ is configured for the second set, . . . .
   In one example, a same n_{shift} is configured for the first set and/or for the second set
   In one example, a first n_{shift} is configured for the first set and a second n_{shift} is configured for the second set, . . . .
   In one example, a same RRC is configured for the first set and/or for the second set . . . .
   In one example, a first n_{RRC} is configured for the first set and a second n_{RRC} is configured for the second set, . . . .

In one example, an SRS configuration is configured for SRS, and a M SBT-RS configuration(s) are configured for N SBT-RS, wherein M≥1 and N≥1 and N≥M. In one example, SBT-RS configuration 0 is for N₀ SBT-RS and SBT-RS configuration 1 is for N₁ SBT-RS, . . . , and SBT-RS configuration M−1 is for N_{M-1} SBT-RS, wherein Nᵢ≥1, for i=0, 1, . . . , M−1 and

$${\sum }_{i = 0}^{M - 1} {N}_{i} = N .$$

In one example, N-port SRS is configured, wherein the N-port SRS has n CDM groups. The n CDM groups can span l time occasions and m frequency occasions such that n=l×m. For example, as illustrated in FIG. 10, a 24-port (N=24), is configured that has 6 (n=6) CDM groups arranged as 2×3 CDM groups, where l=2 and m=3.

In one example, a CSI-RS configuration is used for SRS and SBT-RS. In one example, a first CSI-RS configuration is used SRS and SBT-RS, and a second CSI-RS configuration is used for SBT-RS. In one example, a first CSI-RS configuration is used SRS, and a second CSI-RS configuration is used for SBT-RS.

In one example, a CSI-RS configuration is used for SRS and SBT-RS, wherein SRS and SBT-RS are mapped to CDM groups in different symbols. For example, in FIG. 10, SRS can be mapped to the CDM groups in symbols 4 and 5, and SBT-RS can be mapped to CDM groups in symbols 8 and 9.

In one example, a CSI-RS configuration is used for SRS and SBT-RS, wherein SRS and SBT-RS are mapped to CDM groups in the same or different symbols. For example, in FIG. 10, SRS can be mapped to the CDM group 0 and SBT-RS can be mapped to CDM groups 1 to 5.

In one example, a CSI-RS configuration is used for SRS and SBT-RS, and a CDM group can include ports for SRS and ports for SBT-RS.

In one example, a CDM group used for SBT-RS is associated with one SBT-RS. In one example, of, a CDM group used for SBT-RS can be associated with more than one SBT-RS. In one example, SBT-RS can be associated with more than one CDM group.

In one example, a CSI-RS configuration is used at least for multiple SBT-RS (e.g., SBT-RS1, SBT-RS2, etc.). In one example, different SBT-RS can be mapped to different antenna ports of a same CDM group (for example, SBT-RS1 is mapped to a first port(s) of a CDM group, and SBT-RS2 is mapped to a second port(s) of the CMD group).

In one example, a CSI-RS configuration is used at least for multiple SBT-RS (e.g., SBT-RS1, SBT-RS2, etc.). In one example, different SBT-RS are mapped to different CDM groups (for example, SBT-RS1 is mapped to a first CDM group(s), and SBT-RS2 is mapped to a CMD group(s)), wherein the CDM groups can be in a same symbol(s) or in different symbol(s).

In one example, a CSI-RS configuration is used at least for multiple SBT-RS (e.g., SBT-RS1, SBT-RS2, etc.). In one example, different SBT-RS are mapped to same or different CDM groups in different symbols(s) (for example, SBT-RS1 is mapped to a first CDM group(s) in first symbol(s), and SBT-RS2 is mapped to a CMD group(s) in second symbol(s)).

In one example, in symbols with reference signal (e.g., SRS/SBT-RS symbols or SBT-RS symbols), a first set of RBs are allocated to SRS, and a second set of RBs are allocated to SBT-RS.
In one example, the RBs allocated to SRS can be configured with comb offsets and CDM groups and antenna ports according the aforementioned SRS or CSI-RS configuration.
In one example, the RBs allocated to SBT-RS can be configured with comb offset and CDM groups and antenna ports according to the aforementioned SRS or CSI-RS configuration. In one example, a SBT-RS on an adjacent beam (or spatial domain filter) can be allocated one or two ports or more ports in a comb offset or CDM group. In one example, a comb offset or a CDM group is used for one SBT-RS. In one example, a comb offset or a CDM group can be used for more than one SBT-RS.
In one example, the REs of RBs allocated to BT-RS can be divided into groups, wherein a group of REs is associated with a SBT-RS. For example, the first group of REs are associated, with a first SBT-RS, the second group of REs are associated with a second SBT-RS and so on. In one example, the REs in a RB associated with a SBT-RS can be contiguous. In one example, the REs in a RB associated with a SBT-RS can be non-contiguous.
In one example, the RBs allocated to SBT-RS can be divided into groups, wherein a group of RBs is associated with a SBT-RS. For example, the first group of RBs are associated with a first SBT-RS, the second group of RBs are associated with a second SBT-RS and so on. In one example, the RBs associated with a SBT-RS can be contiguous. In one example, the RBs associated with a SBT-RS can be non-contiguous.

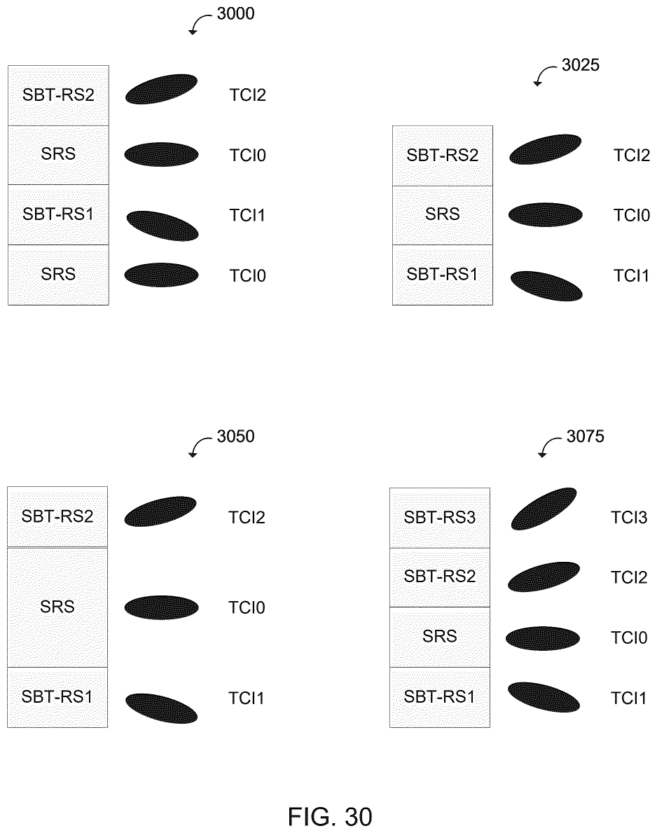

FIG. 30 illustrates further examples of RB allocation to different types of reference signals according to embodiments of the present disclosure. For example, the RB allocation can be implemented by any of the UEs 111-116 of FIG. 1. This example is for illustration only and can be used without departing from the scope of the present disclosure.

As illustrated in FIG. 30, contiguous REs or contiguous RBs can be allocated to different types of reference signals. In example 3000, the frequency allocation is split in to 4 equal or near equal frequency bands. In SRS/SBT-RS symbols, frequency band 0 and frequency band 2 are allocated to SRS using TCI state 0 or spatial domain filter 0 or spatial relation 0, frequency band 1 is allocated to SBT-RS1 and uses TCI state 1 or spatial domain filter 1 or spatial relation 1, and frequency band 3 is allocated to SBT-RS2 and uses TCI state 2 or spatial domain filter 2, or spatial relation 2. In a variant example 3025, the bands for SRS are contiguous bands, for example, frequency band 0 is allocated to SBT-RS1 and uses TCI state 1 or spatial domain filter 1, or spatial relation 0, frequency band 1 and frequency band 2 are allocated to SRS and uses TCI state 0 or spatial domain filter 0, or spatial relation 1, frequency band 3 is allocated to SBT-RS2 and uses TCI state 2 or spatial domain filter 2, or spatial relation 2.

In yet another example 3050, the frequency allocation is split in frequency bands that can be of unequal size for the SRS/SBT-RS symbol, frequency band 1 is larger than frequency band 0 and frequency band 2. Frequency band 0 is allocated to SBT-RS1 and uses TCI state 1 or spatial domain filter 1, or spatial relation 1, frequency band 1 is allocated to SRS and uses TCI state 0 or spatial domain filter 0, or spatial relation 0, and frequency band 2 is allocated to SBT-RS2, and uses TCI state 2 or spatial domain filter 2, or spatial relation 2.

In yet another example 3075, the frequency allocation is split in to 4 equal or near equal frequency bands for the SRS/BT-RS symbol. Frequency band 0 is allocated to SBT-RS1 and uses TCI state 1 or spatial domain filter 1, or spatial relation 1, frequency band 1 is allocated to SRS and uses TCI state 0 or spatial domain filter 0, or spatial relation 0, frequency band 2 is allocated to SBT-RS2, and uses TCI state 2 or spatial domain filter 2, or spatial relation 2, and frequency band 3 is allocated to SBT-RS3, and uses TCI state 3 or spatial domain filter 3, or spatial relation 3.

A block shown in FIG. 30, can represent, a symbol, or a group of symbols in a same comb offset or CDM group, or a group of symbols across multiple comb offsets or CDM groups in a slot (or in an instance of SRS or CSI-RS configuration).

In another example of the aforementioned examples of FIG. 30, the SBT-RS can have a physical signal structure similar to the physical signal structure of SRS. In one example of the aforementioned examples of FIG. 30, the SBT-RS can have a physical signal structure similar to the physical signal structure of CSI-RS. In one example of the aforementioned examples of FIG. 30, the SBT-RS can have a physical signal structure similar to the physical signal structure of DM-RS.

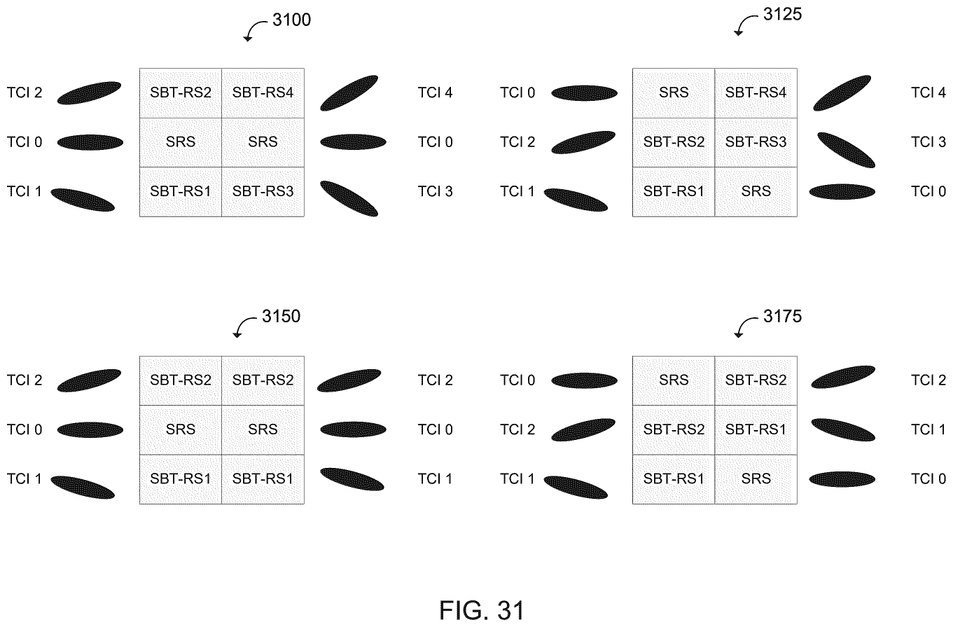

FIG. 31 illustrates further examples of RB allocation to different types of reference signals according to embodiments of the present disclosure. For example, the RB allocation can be implemented by any of the UEs 111-116 of FIG. 1. This example is for illustration only and can be used without departing from the scope of the present disclosure.

In yet another example, there are two SRS/SBT-RS symbols or groups of symbols (e.g., a group of symbols are symbols of a CDM group). In one example, the SRS/SBT-RS symbols or groups of symbols are consecutive. In one example, SRS/SBT-RS symbols or groups of symbols are non-consecutive. In one example, the frequency allocation of each SRS/SBT-RS symbol or group of symbols is split into three frequency bands, wherein different SBT-RS can be allocated to different SRS/SBT-RS as illustrated in example 3100 of FIG. 31:
In one example, frequency band 0 is allocated to SBT-RS1 in SRS/SBT-RS symbol 0 or symbol group 0 and frequency band 0 is allocated to SBT-RS3 in SRS/SBT-RS symbol 1 or symbol group 1.
In one example, frequency band 1 is allocated to SRS in SRS/SBT-RS symbol 0 or symbol group 0 and SRS/SBT-RS symbol 1 or symbol group 1, in this example, there is no frequency hopping of SRS between symbols.
In one example, frequency band 2 is allocated to SBT-RS2 in SRS/SBT-RS symbol 0 or symbol group 1 and frequency band 2 is allocated to SBT-RS4 in SRS/SBT-RS symbol 1 or symbol group 1.
In a variant example, the same SBT-RS can be repeated in both SRS/SBT-RS symbols or symbol groups without or with frequency hopping.

In a variant of the aforementioned examples, the number of frequency bands can be N. In one example, N=2. In one example, N=1 (e.g., one SBT-RS per OFDM symbol).

In yet another example, there are two SRS/SBT-RS symbols or groups of symbols (e.g., a group of symbols are symbols of a CDM group). In one example, the SRS/SBT-RS symbols or groups of symbols are consecutive. In one example, SRS/SBT-RS symbols or groups of symbols are non-consecutive. In one example, the frequency allocation of each SRS/SBT-RS symbol or group of symbols is split into three frequency bands, wherein different SBT-RS can be allocated to different SRS/SBT-RS, with frequency hopping of SRS as illustrated in example 3125 of FIG. 31:
In one example, frequency band 0 is allocated to SBT-RS1 in SRS/SBT-RS symbol 0 or symbol group 0 and frequency band 0 is allocated to SRS in SRS/SBT-RS symbol 1 or symbol group 1.
In one example, frequency band 1 is allocated to SBT-RS2 in SRS/SBT-RS symbol 0 or symbol group 0 and frequency band 1 is allocated to SBT-RS3 in SRS/SBT-RS symbol 1 or symbol group 1.
In one example, frequency band 2 is allocated to SRS in SRS/SBT-RS symbol 0 or symbol group 0 and frequency band 2 is allocated to SBT-RS4 in SRS/SBT-RS symbol 1 or symbol group 1.
In a variant example, the same SBT-RS can be repeated in both SRS/SBT-RS symbols or symbol groups with or without frequency hopping.
In a variant of the aforementioned examples, the number of frequency bands can be N. In one example, N=2. In one example, N=1 (e.g., one SBT-RS per OFDM symbol).

In yet another example, there are two SRS/SBT-RS symbols or groups of symbols (e.g., a group of symbols are symbols of a CDM group). In one example, the SRS/SBT-RS symbols or groups of symbols are consecutive. In one example, SRS/SBT-RS symbols or groups of symbols are non-consecutive. In one example, the frequency allocation of each SRS/SBT-RS symbol or groups of symbols is split into three frequency bands, wherein same SBT-RS can be allocated to different SRS/SBT-RS without frequency hopping as illustrated in example 3150 of FIG. 31:
In one example, frequency band 0 is allocated to SBT-RS1 in SRS/SBT-RS symbol 0 or symbol group 0 and SRS/SBT-RS symbol 1 or symbol group 1.
In one example, frequency band 1 is allocated to SRS in SRS/SBT-RS symbol 0 or symbol group 0 and SRS/SBT-RS symbol 1 or symbol group 1.
In one example, frequency band 2 is allocated to SBT-RS2 in SRS/SBT-RS symbol 0 or symbol group 0 and SRS/SBT-RS symbol 1 or symbol group 1.

In a variant of the aforementioned examples, the number of frequency bands can be N. In one example, N=2. In one example, N=1 (e.g., one SBT-RS per OFDM symbol).

In yet another example, there are two SRS/SBT-RS symbols or groups of symbols (e.g., a group of symbols are symbols of a CDM group). In one example, the SRS/SBT-RS symbols or groups of symbols are consecutive. In one example, SRS/SBT-RS symbols or groups of symbols are non-consecutive. In one example, the frequency allocation of each SRS/SBT-RS symbol or groups of symbols is split into three frequency bands, wherein same SBT-RS can be allocated to different SRS/SBT-RS, with frequency hopping of SRS as illustrated in example 3175 of FIG. 31:
In one example, frequency band 0 is allocated to SBT-RS1 in SRS/SBT-RS symbol 0 or symbol group 0 and frequency band 0 is allocated to SRS in SRS/SBT-RS symbol 1 or symbol group 1.
In one example, frequency band 1 is allocated to SBT-RS2 in SRS/SBT-RS symbol 0 or symbol group 0 and frequency band 1 is allocated to SBT-RS1 in SRS/SBT-RS symbol 1 or symbol group 1.
In one example, frequency band 2 is allocated to SRS in SRS/SBT-RS symbol 0 or symbol group 0 and frequency band 2 is allocated to SBT-RS2 in SRS/SBT-RS symbol 1 or symbol group 1.
In a variant of the aforementioned examples, the number of frequency bands can be N. In one example, N=2. In one example, N=1 (e.g., one SBT-RS per OFDM symbol).

In the aforementioned mentioned: SRS uses TCI state 0 or spatial domain filter 0 or spatial relation 0, SBT-RS1 uses TCI state 1 or spatial domain filter 1 or spatial relation 1, SBT-RS2 uses TCI state 2 or spatial domain filter 2 or spatial relation 2, SBT-RS3 uses TCI state 3 or spatial domain filter 3 or spatial relation 3, and SBT-RS4 uses TCI state 4 or spatial domain filter 4 or spatial relation 4.

In another example of the aforementioned examples of FIG. 31, the SBT-RS can have a physical signal structure similar to the physical signal structure of SRS. In one example of the aforementioned examples of FIG. 31, the SBT-RS can have a physical signal structure similar to the physical signal structure of CSI-RS. In one example of the aforementioned examples of FIG. 31, the SBT-RS can have a physical signal structure similar to the physical signal structure of DM-RS.

In one example, within respective frequency bands, one or more comb offsets or one or more CDM groups are used for respective SRS or respective SBT-RS. In one example, in addition to the SRS/SBT-RS, there is one or more SRS symbols wherein the entire frequency allocation of the SRS symbol is used for SRS, wherein TCI state 0 or spatial domain filter 0 or spatial relation 0 is used. In one example, for symbols used for data transmission (e.g., for transmitting PUSCH), TCI state 0 or spatial domain filter 0 or spatial relation 0 is used. In aforementioned, example, TCI state 0 or spatial domain filter 0 or spatial relation 0, is the TCI state or spatial domain filter or spatial relation of the main beam. TCI state 1 . . . M, or spatial domain filter 1 . . . M or spatial relation 1 . . . M, is the TCI state or spatial domain filter or spatial relation of the 1^{st}, . . . Mth beam respectively.

In one example, the SRS and the SBT-RS are transmitted (or multiplexed) in different symbols or in different groups of symbols. In one example, a first one or more symbols or groups of symbols can have SRS. A second one or more symbols or groups of symbols can have SBT-RS.

In one example, the REs of the symbol(s) or group(s) of symbols allocated to SBT-RS can be divided into groups, wherein a group of REs is associated with a SBT-RS. For example, the first group of REs are associated, with a first SBT-RS, the second group of REs are associated with a second SBT-RS and so on. In one example, the REs in a symbol or group of symbols associated with a SBT-RS can be contiguous. In one example, the REs in a symbol or group of symbols associated with a SBT-RS can be non-contiguous. In one example, the REs in a RB of a symbol or group of symbols associated with a SBT-RS can be contiguous. In one example, the REs in a RB of a symbol or group of symbols associated with a SBT-RS can be non-contiguous.

In one example, the RBs of the symbol(s) or group(s) of symbols allocated to SBT-RS can be divided into groups, wherein a group of RBs is associated with a SBT-RS. For example, the first group of RBs are associated with a first SBT-RS, the second group of RBs are associated with a second SBT-RS and so on. In one example, the RBs in a symbol or group of symbols associated with a SBT-RS can be contiguous. In one example, the RBs in a symbol or group of symbols associated with a SBT-RS can be non-contiguous.

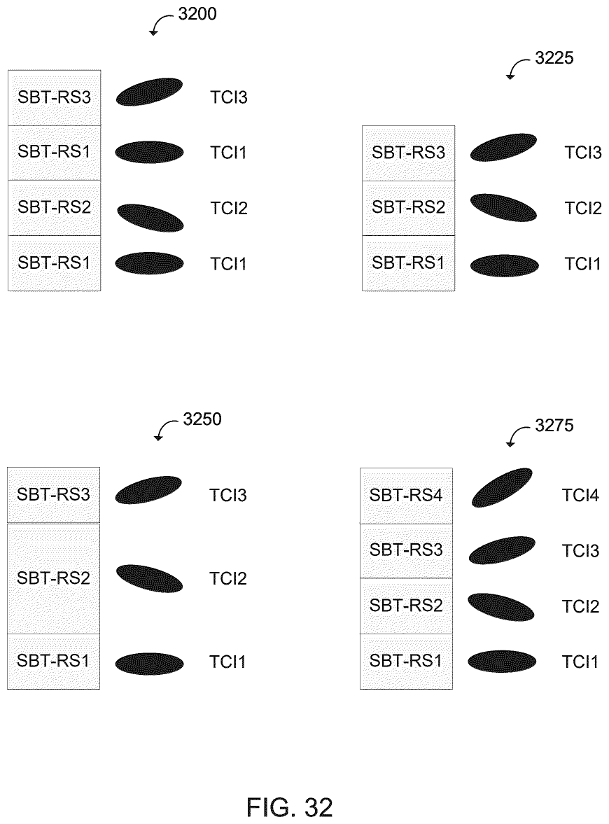

FIG. 32 illustrates further examples of RB allocation to different types of reference signals according to embodiments of the present disclosure. For example, the RB allocation can be implemented by any of the UEs 111-116 of FIG. 1. This example is for illustration only and can be used without departing from the scope of the present disclosure.

As illustrated in FIG. 32, contiguous REs or contiguous RBs can be allocated to different SBT-RS. In one example, a SBT-RS is allocated a one frequency band. In one example, a SBT-RS can be allocated multiple frequency bands. In one example, different SBT-RS are allocated the same number of frequency bands. In one example, different SBT-RS can be allocated different number of frequency bands. In example 3200, the frequency allocation is split in to 4 equal or near equal frequency bands. In SBT-RS symbols or groups of symbols, frequency band 0 and frequency band 2 are allocated to SBT-RS1 using TCI state 1 or spatial domain filter 1 or spatial relation 1, frequency band 1 is allocated to SBT-RS2 and uses TCI state 2 or spatial domain filter 2 or spatial relation 2, and frequency band 3 is allocated to SBT-RS3 and uses TCI state 3 or spatial domain filter 3 or spatial relation 3. In a variant example 3225, the bands for SBT-RS, when SBT-RS is allocated multiple bands, are contiguous bands, for example, frequency band 0 is allocated to SBT-RS1 and uses TCI state 1 or spatial domain filter 1 or spatial relation 1, frequency band 1 and frequency band 2 are allocated to SBT-RS2 and uses TCI state 2 or spatial domain filter 2 or spatial relation 2, frequency band 3 is allocated to SBT-RS3 and uses TCI state 3 or spatial domain filter 3 or spatial relation 3.

In yet another example 3250, the frequency allocation is split in frequency bands that can be of unequal size where each SBT-RS is allocated one frequency band, for the SBT-RS symbol, frequency band 1 is larger than frequency band 0 and frequency band 2. Frequency band 0 is allocated to SBT-RS1 and uses TCI state 1 or spatial domain filter 1 or spatial relation 1, frequency band 1 is allocated to SBT-RS2 and uses TCI state 2 or spatial domain filter 2 or spatial relation 2, and frequency band 2 is allocated to SBT-RS3, and uses TCI state 3 or spatial domain filter 3 or spatial relation 3.

In yet another example 3275, the frequency allocation is split in to 4 equal or near equal frequency bands for the SBT-RS symbol or group of symbols. Frequency band 0 is allocated to SBT-RS1 and uses TCI state 1 or spatial domain filter 1 or spatial relation 1, frequency band 1 is allocated to SBT-RS2 and uses TCI state 2 or spatial domain filter 2 or spatial relation 2, frequency band 2 is allocated to SBT-RS3, and uses TCI state 3 or spatial domain filter 3 or spatial relation 3, and frequency band 3 is allocated to SBT-RS4, and uses TCI state 4 or spatial domain filter 4 or spatial relation 4.

In another example of the aforementioned examples of FIG. 32, the SBT-RS can have a physical signal structure similar to the physical signal structure of SRS. In one example of the aforementioned examples of FIG. 32, the SBT-RS can have a physical signal structure similar to the physical signal structure of CSI-RS. In one example of the aforementioned examples of FIG. 32, the SBT-RS can have a physical signal structure similar to the physical signal structure of DM-RS.

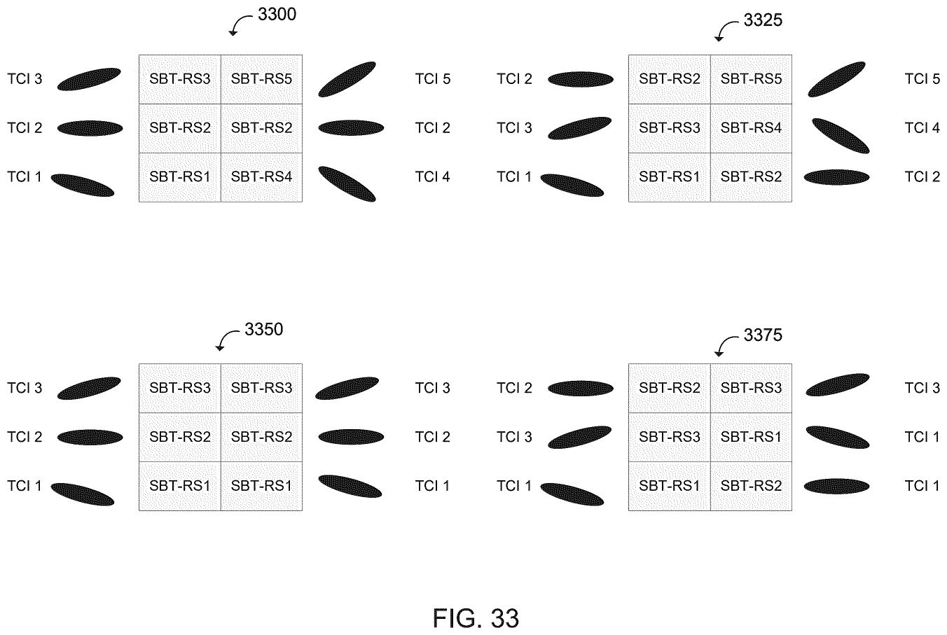

FIG. 33 illustrates further examples of RB allocation to different types of reference signals according to embodiments of the present disclosure. For example, the RB allocation can be implemented by any of the UEs 111-116 of FIG. 1. This example is for illustration only and can be used without departing from the scope of the present disclosure.

In yet another example, there are two SBT-RS symbols or groups of symbols (e.g., a group of symbols are symbols of a CDM group). In one example, the SBT-RS symbols or groups of symbols are consecutive. In one example, SBT-RS symbols or groups of symbols are non-consecutive. In one example, some of the SBT-RS occur in both symbols or groups of symbols (e.g., SBT-RS2 in example 3300 of FIG. 33), while other SBT-RS occur in one symbol or group of symbols (either symbol 0 symbol group 0, such as SBT-RS1 and SBT-RS3 in example 3300, or symbol 1 symbol group 1 such as SBT-RS4 and SBT-RS5 in example 3300)). In one example, SBT-RS allocated to both SBT-RS symbols or groups of symbols are allocated the same frequency. In one example, the frequency allocation of each SBT-RS symbol is split into three frequency bands, as illustrated in example 3300:
In one example, frequency band 0 is allocated to SBT-RS1 in SBT-RS symbol 0 or symbol group 0 and frequency band 0 is allocated to SBT-RS4 in SBT-RS symbol 1 or symbol group 1.

In one example, frequency band 1 is allocated to SBT-RS2 in SBT-RS symbol 0 or symbol group 0 and SBT-RS symbol 1 or symbol group 1, in this example, there is no frequency hopping of SBT-RS between symbols or groups of symbols.
In one example, frequency band 2 is allocated to SBT-RS3 in SRS/SBT-RS symbol 0 or symbol group 0 and frequency band 2 is allocated to SBT-RS5 in SRS/SBT-RS symbol 1 or symbol group 1.
In a variant of the aforementioned examples, the number of frequency bands can be N. In one example, N=2. In one example, N=1 (e.g., one SBT-RS per OFDM symbol).

In yet another example, there are two SBT-RS symbols or groups of symbols (e.g., a group of symbols are symbols of a CDM group). In one example, the SBT-RS symbols or groups of symbols are consecutive. In one example, the SBT-RS symbols or groups of symbols are non-consecutive. In one example, some of the SBT-RS occur in both symbols or groups of symbols (e.g., SBT-RS2 in example 3325 of FIG. 33), while other SBT-RS occur in one symbol or group of symbols (either symbol 0 symbol group 0, such as SBT-RS1 and SBT-RS3 in example 3325, or symbol 1 or symbol group 1 such as SBT-RS4 and SBT-RS5 in example 3325). In one example, SBT-RS allocated to both SBT-RS symbols or groups of symbols can be allocated different frequencies (e.g., hopping between the first symbol or group of symbols and the second symbol or group of symbols). In one example, the frequency allocation of each SBT-RS symbol or group of symbols is split into three frequency bands, as illustrated in example 3325:
In one example, frequency band 0 is allocated to SBT-RS1 in SBT-RS symbol 0 or symbol group 0 and frequency band 0 is allocated to SBT-RS2 in SBT-RS symbol 1 or symbol group 1.
In one example, frequency band 1 is allocated to SBT-RS3 in SBT-RS symbol 0 or symbol group 0 and frequency band 1 is allocated to SBT-RS4 in SBT-RS symbol 1 or symbol group 1.
In one example, frequency band 2 is allocated to SBT-RS2 in SBT-RS symbol 0 or symbol group 0 and frequency band 2 is allocated to SBT-RS5 in SBT-RS symbol 1 or symbol group 1.
In a variant of the aforementioned examples, the number of frequency bands can be N. In one example, N=2. In one example, N=1 (e.g., one SBT-RS per OFDM symbol).

In yet another example, there are two SBT-RS symbols or groups of symbols (e.g., a group of symbols are symbols of a CDM group). In one example, the SBT-RS symbols or groups of symbols are consecutive. In one example, the SBT-RS symbols or groups of symbols are non-consecutive. In one example, the SBT-RS occur in both symbols or groups of symbols. In one example, SBT-RS allocated to both SBT-RS symbols or groups of symbols are allocated the same frequency. In one example, the frequency allocation of each SBT-RS symbol or group of symbols is split into three frequency bands, as illustrated in example 3350 of FIG. 33:

In one example, frequency band 0 is allocated to SBT-RS1 in SBT-RS symbol 0 or symbol group 0 and SBT-RS symbol 1 or symbol group 1.
In one example, frequency band 1 is allocated to SBT-RS2 in SBT-RS symbol 0 or symbol group 0 and SBT-RS symbol 1 or symbol group 1.

In one example, frequency band 2 is allocated to SBT-RS3 in SBT-RS symbol 0 or symbol group 0 and SBT-RS symbol 1 or symbol group 1.
In a variant of the aforementioned examples, the number of frequency bands can be N. In one example, N=2. In one example, N=1 (e.g., one SBT-RS per OFDM symbol).

In yet another example, there are two SBT-RS symbols or groups of symbols (e.g., a group of symbols are symbols of a CDM group). In one example, the SBT-RS symbols or groups of symbols are consecutive. In one example, the SBT-RS symbols or groups of symbols are non-consecutive. In one example, the SBT-RS occur in both symbols or groups of symbols. In one example, SBT-RS allocated to both SBT-RS symbols or groups of symbols can be allocated different frequencies (e.g., hopping between the first symbol or group of symbols and the second symbol or group of symbols). In one example, the frequency allocation of each SBT-RS symbol is split into three frequency bands, as illustrated in example 3375 of FIG. 33:
In one example, frequency band 0 is allocated to SBT-RS1 in SBT-RS symbol 0 or symbol group 0 and frequency band 0 is allocated to SBT-RS2 in SBT-RS symbol 1 or symbol group 1.
In one example, frequency band 1 is allocated to SBT-RS3 in SBT-RS symbol 0 or symbol group 0 and frequency band 1 is allocated to SBT-RS1 in SBT-RS symbol 1 or symbol group 1.
In one example, frequency band 2 is allocated to SBT-RS2 in SBT-RS symbol 0 or symbol group 0 and frequency band 2 is allocated to SBT-RS3 in SBT-RS symbol 1 or symbol group 1.
In a variant of the aforementioned examples, the number of frequency bands can be N. In one example, N=2. In one example, N=1 (e.g., one SBT-RS per OFDM symbol).

In the aforementioned mentioned: SBT-RS1 uses TCI state 1 or spatial domain filter 1 or spatial relation 1, SBT-RS2 uses TCI state 2 or spatial domain filter 2 or spatial relation 2, SBT-RS3 uses TCI state 3 or spatial domain filter 3 or spatial relation 3, SBT-RS4 uses TCI state 4 or spatial domain filter 4 or spatial relation 4, and SBT-RS5 uses TCI state 5 or spatial relation 5 or spatial domain filter 5.

In another example of the aforementioned examples of FIG. 33, the SBT-RS can have a physical signal structure similar to the physical signal structure of SRS. In one example of the aforementioned examples of FIG. 33, the SBT-RS can have a physical signal structure similar to the physical signal structure of CSI-RS. In one example of the aforementioned examples of FIG. 33, the SBT-RS can have a physical signal structure similar to the physical signal structure of DM-RS.

In one example, within respective frequency bands, one or more comb offsets or one or more CDM groups are used for respective SBT-RS. In one example, there is one or more SRS symbols wherein the entire frequency allocation of the SRS symbol is used for SRS, wherein TCI state 0 or spatial domain filter 0 or spatial relation 0. In one example, for symbols used for data transmission (e.g., for transmitting PUSCH), TCI state 0 or spatial domain filter 0 or spatial relation 0 is used. In aforementioned, example, TCI state 0 or spatial domain filter 0 or spatial relation 0, is the TCI state or spatial domain filter or spatial relation of the main beam. TCI state 1 . . . M, or spatial domain filter 1 . . . M or spatial relation 1 . . . M, is the TCI state or spatial domain filter or spatial relation of the 1^{st}, . . . Mth beam respectively.

In the present disclosure, UL reception on multiple beams is provided.

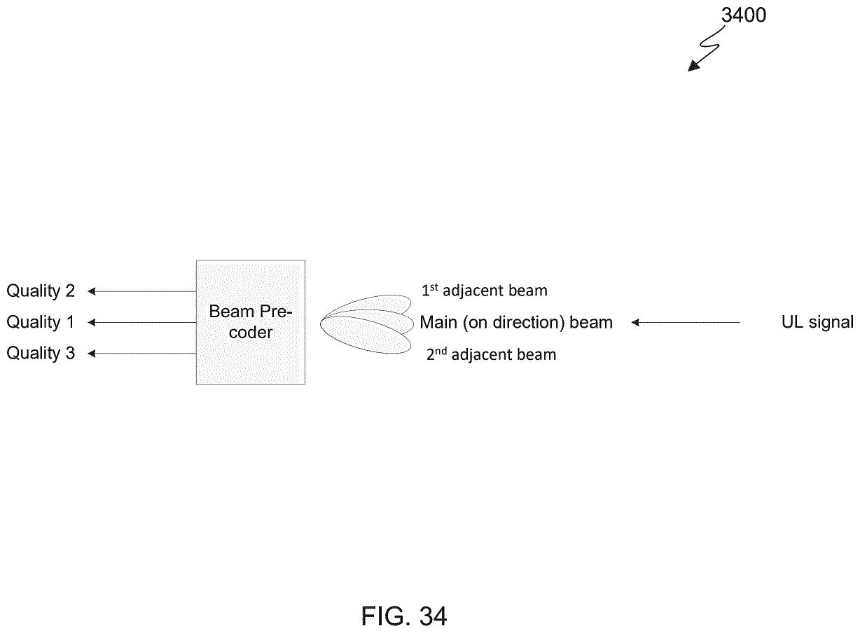

FIG. 34 illustrates another example beam or spatial domain transmission filter 3400 according to embodiments of the disclosure. For example, filter 3400 can be implemented by any of the UEs 111-116 of FIG. 1. This example is for illustration only and other embodiments can be used without departing from the scope of the present disclosure.

In one example, the UE transmits an UL channel or an UL signal. As illustrated in FIG. 34, the base station can receive the UL channel or the UL signal using multiple spatial domain reception filters to identify a best received signal. For example, the UL signal can be DM-RS or SRS or CSI-RS-like UL signal or BT-RS or SBT-RS, and the base station receives the UL signal using a first spatial domain reception filter (e.g., main beam used for reception of UL channels) and determines a first quality of the UL signal, and the base station receives the UL signal using a second spatial domain reception filter (e.g., first adjacent beam) and determines a second quality of the UL signal, and the base station receives the UL signal using a third spatial domain reception filter (e.g., second adjacent beam) and determines a third quality of the UL signal, . . . .

Based on a comparison of the first quality, second quality, third quality . . . . The base station decides whether or not to switch the main spatial domain reception filter to one of the adjacent spatial domain filters. A quality can be reference signal received power (RSRP), signal to interference and noise ratio (SINR), etc. the quality can be an instantaneous value or an averaged value (e.g., sliding window or long term average).

In the present disclosure, signaling between the UE and gNB is provided.

In one example, a UE transmits a first UL signal and N second UL signal(s). In one example, the first UL signal is DM-RS, and the N second UL signal(s) are BT-RS as aforementioned. In one example, the first UL signal is SRS, the N second UL signal(s) are SBT-RS as aforementioned. In one example, the first UL signal is transmitted using a first spatial domain filter (e.g., associated with a first TCI state). The N second UL signal(s) are transmitted using a second, third, . . . , (N+1)th spatial domain filter(s) respectively, (e.g., associated with a second, third, . . . , (N+1)th TCI state(s), respectively or associated with a second, third, . . . , (N+1)th spatial domain filter or spatial relation, respectively).

In one example, the first UL signal and N second UL signals(s) are associated by RRC signaling as aforementioned.

In one example, N second UL signals are activated by MAC CE and/or RRC and/or L1 control (e.g., DCI Format) signaling. In one example, the DCI Format is UE specific. In one example, the DCI Format is to a group of UEs (e.g., group common DCI).

In one example, resources for N second UL signals are configured, e.g., resources for N BT-RS or resources for N SBT-RS.

In one example, the gNB measures a signal quality associated with the first UL signal and each of the second N UL signals. In one example, the gNB measures a signal quality associated with each of the second N UL signals. In one example, the measured quality is reference signal received power (RSRP). In one example, the measured quality is signal-to-interference-and-noise ratio (SINR). In one example, the gNB uses the instantaneous value of the measured quality. In one example, the gNB uses an averaged value of the measured quality. In one example, the average is a sliding window average, e.g., an average of the most recent K instantaneous measurements. In one example, the measured quality is an exponential average, e.g., average quantity after instance n=α*(instantaneous quantity of instance n)+(1−α)*(average quantity after instance n−1). Alternatively, average quantity after instance n=(1−α)*(instantaneous quantity of instance n)+α*(average quantity after instance n−1). In one example, the measurement of the first UL signal and the second N UL signals is up to the gNB implementation.

In one example, the UE can indicate to the gNB to reset the average quantity (e.g., to ignore previously averaged value and start calculating the averaged quantity using the new measurements). For example, the UE can indicate to the gNB to reset the measurements, when the transmission parameters of the UL signal(s), e.g., spatial filters, change. In one example, a gNB can reset the average quantity, when it indicates and/or applies a new TCI state.

In one example, the gNB uses a measured quantity (instantaneous or average) to determine a report to the UE. In one example, the report to UE is transmitted if one or more of the following occurs:
The measured quantity associated with one or more of the second UL signals is above a threshold (or equal to or above a threshold).
The measured quantity associated with the first UL signals is below (or equal to or below) a threshold.
The measured quantity associated with one or more of the second UL signals is above a first threshold (or equal to or above a threshold); and the measured quantity associated with the first UL signal is below (or equal to or below) a second threshold. In one example, the first threshold and the second threshold can be different. In one example, the first threshold and the second threshold are the same threshold.
The difference (e.g., in dB or dBm) between the measured quality (Q₂) associated with one or more of the second UL signals and the measured quality associated with the first UL signal (Q₁), is above a threshold (or equal to or above a threshold Th). i.e., U=Q₂−Q₁>Th or U=Q₂−Q₁≥Th, where U can be evaluated for each second UL signal.
The difference (e.g., in dB or dBm) between the measured quality (Q₂) associated with one or more of the second UL signals and the measured quality associated with the first UL signal (Q₁), is above (or equal to or above) a first threshold Th; and the measured quantity associated with the corresponding second UL signals is above (or equal to or above) a second threshold.
The difference (e.g., in dB or dBm) between the measured quality (Q₂) associated with one or more of the second UL signals and the measured quality associated with the first UL signal (Q₁), is above (or equal to or above) a first threshold Th; and the measured quantity associated with the first UL signal is below (or equal to or below) a second threshold.
The difference (e.g., in dB or dBm) between the measured quality (Q₂) associated with one or more of the second UL signals and the measured quality associated with the first UL signal (Q₁), is above (or equal to or above) a first threshold Th; and at least one of (1) the measured quantity associated with the corresponding second UL signals is above (or equal to or above) a second threshold; or (2) the measured quantity associated with the first UL signal is below (or equal to or below) a third threshold. In one example, the second threshold and the third threshold can be different. In one example, the second threshold and the third threshold are the same threshold.
The difference (e.g., in dB or dBm) between the measured quality (Q₂) associated with one or more of the second UL signals and the measured quality associated with the first UL signal (Q₁), is above (or equal to or above) a first threshold Th; and the measured quantity associated with the corresponding second UL signals is above (or equal to or above) a second threshold; and the measured quantity associated with the first UL signal is below (or equal to or below) a third threshold. In one example, the second threshold and the third threshold can be different. In one example, the second threshold and the third threshold are the same threshold.

In the above examples, the threshold, or the first threshold or the second threshold or the third threshold can be configured and/or updated by SIB and/or RRC and/or MAC CE and/or L1 control (e.g., DCI Format) signaling.

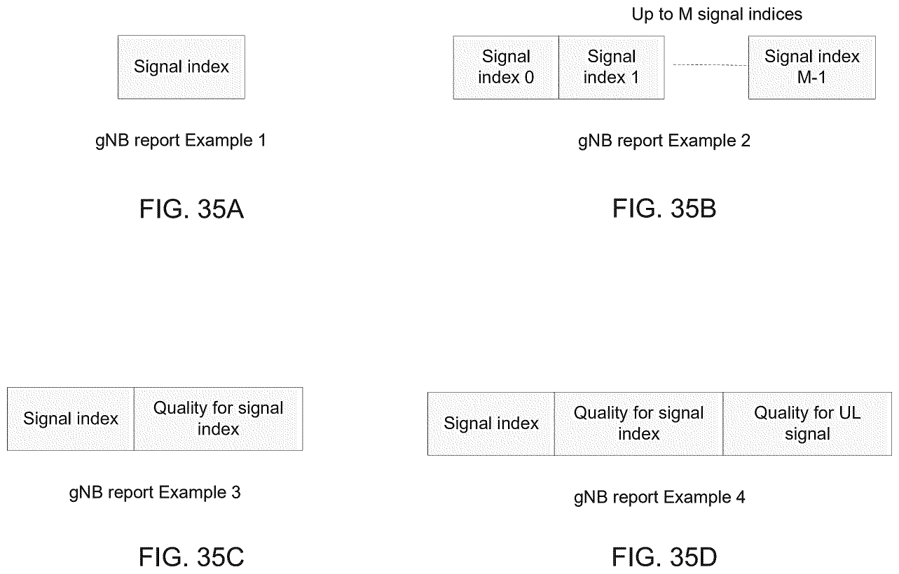

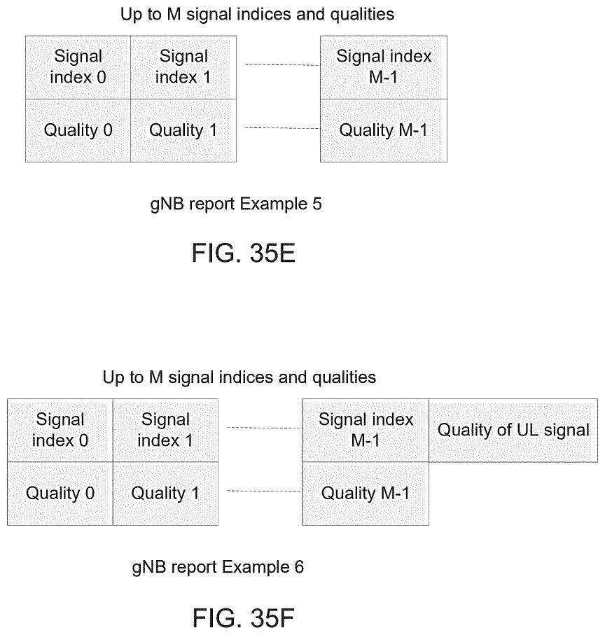

FIGS. 35A-35F illustrate example gNB reports to the UE according to embodiments of the present disclosure. For example, the reports can be implemented by gNB 102 of FIG. 1. This example is for illustration only and other embodiments can be used without departing from the scope of the present disclosure.

In one example, the gNB can report to the UE one or more of the following:
The index of a signal, as illustrated in FIG. 35A. In one example, the index can be the first signal or one of the second N UL signals, e.g., this can be indicated by a field of size └log₂(N+1)┘. In one example, index 0 indicates the existing beam or first signal. In one example, the index can be one of the second N UL signals, e.g., this can be indicated by a field of size └log₂ N┘. In one example, the indicated signal is a signal with the largest quality. In one example, the indicated signal is a signal with a quality above (or above or equal to) a threshold (e.g., the gNB can select from any of such signals)−condition A. In one example, the indicated signal is a signal with a quality higher than (or higher than or equal to) the quality of the first signal by a threshold (e.g., the gNB can select from any of such signals)−condition B, in a variant example such a threshold is 0. In one example, the indicated signal is a signal that satisfies at least one of condition A or condition B. In one example, the indicated signal is a signal that satisfies both condition A or condition B.
In one example, the gNB can indicate to the UE the multiple indices, as illustrated in FIG. 35B. For example, the gNB can indicate M or up to M indices. In one example, the M indices can be from first signal or second N UL signals. In one example, the M indices can be from second N UL signals. In one example, the M indices can be arranged in order of quality, e.g., from highest quality to lowest quality of signals of the M indices, or vice versa, e.g., from lowest quality to highest quality of signals of the M indices. In one example, the M indices can be arranged regardless of quality of the M indices. In one example, the indicated M indices correspond to signals with the largest M signal qualities. In one example, the indicated indices correspond to signals is with a signal quality above (or above or equal to) a threshold (e.g., the gNB can select from any of such signals)−condition A. In one example, the indicated M indices correspond to signals with signal qualities higher than (or higher than or equal to) the quality of the first signal by a threshold (e.g., the gNB can select from any of such signals)−condition B, in a variant example such a threshold is 0. In one example, the indicated M indices stratify at least one of condition A or condition B. In one example, the indicated M indices satisfy both condition A or condition B. In one example, M can be specified in the system specifications and/or configured and/or updated by SIB, RRC, MAC CE and/or L1 control (e.g., DCI Format) signaling.
In one example, the gNB report to the UE can include a signal index, according to the aforementioned examples, and a quality value corresponding to the signal index, as illustrated in FIG. 35C. In one example, the quality value is the RSRP corresponding to the indicated signal index in dBm, e.g., value can be represented by a X1-bit value, in increments of Y1 dB in the range [A1, B1] dBm (e.g., absolute reporting of RSRP). In one example, X1=7 bits, Y1=1 dB, A1=−140 dBm, and B1=−44 dBm. In one example, the quality value is the difference of RSRP of the indicated signal index and the RSRP of the first UL signal, the value can be indicated in dB, e.g., value can be represented by a X2-bit value, in increments of Y2 dB in the range [A2, B2] dB (e.g., differential reporting of RSRP), or the negative of such value. In one example, X2=4 bits, Y2=2 dB, A2=0 dB, and B2=30 dB. In one example, the quality value is the SINR corresponding to the indicated signal index in dB, e.g., value can be represented by a X3-bit value, in increments of Y3 dB in the range [A3, B3] dB (e.g., absolute reporting of SINR). In one example, X3=7 bits, Y3=0.5 dB, A3=−23 dB, and B3=40 dB. In one example, the quality value is difference of the SINR of the indicated signal index and the SINR of the first UL signal, the value can be indicated in dB, e.g., value can be represented by a X4-bit value, in increments of Y4 dB in the range [A4, B4] dB (e.g., differential reporting of SINR), or the negative of such value. In one example, X4=4 bits, Y4=1 dB, A4=0 dB, and B4=15 dB. In one example, the quality can be CQI or MCS or BLER corresponding to the indicated signal index (e.g., absolute reporting of CQI or MCS or BLER). In one example, the quality value is the difference of the CQI or MCS or BLER of the indicated signal index and the CQI or MCS or BLER of the first UL signal, (e.g., differential reporting of CQI or MCS or BLER), or the negative of such value.
In one example, the gNB report to the UE can include a signal index, according to the aforementioned examples, and a quality value corresponding to the signal index, and a quality value corresponding to the first UL signal, as illustrated in FIG. 35D. In one example, the quality value is RSRP (absolute or differential). In one example, the quality value is SINR (absolute or differential). In one example, the quality value is CQI or MCS or BLER (absolute or differential). In one example, the quality corresponding to the signal index is absolute as aforementioned, and the quality corresponding to the first UL signal is absolute as aforementioned. In one example, the quality corresponding to the signal index is differential, e.g., relative to the quality of the first UL signal as aforementioned, and the quality corresponding to the first UL signal is absolute as aforementioned. In one example, the quality corresponding to the signal index is absolute as aforementioned, and the quality corresponding to the first UL signal is differential, e.g., relative to the quality of the signal of the index as aforementioned.
In one example, the gNB report to the UE can include M or up to M signal indices, according to the aforementioned examples, and corresponding M or up to M qualities, as illustrated in FIG. 35E. In one example, the quality value is RSRP (absolute or differential). In one example, the quality value is SINR (absolute or differential). In one example, the quality value is CQI or MCS or BLER (absolute or differential). In one example, the M (or up to M) qualities corresponding to the M (or up to M) signal indices are absolute as aforementioned. In one example, the M (or up to M) qualities corresponding to the M (or up to M) signal indices are differential (e.g., relative to the quality corresponding to the first UL signal) as aforementioned. In one example, the quality of one of M (or up to M) qualities is absolute as aforementioned, and the qualities of the remaining M−1 (or up M−1) is differential (e.g., relative to the reported absolute quality) as aforementioned, in one example the one of M (or up to M) corresponds to the signal index with the largest (or smallest) quality. In one example, the quality of one of M (or up to M) qualities is differential (e.g., relative to quality of the first UL signal) as aforementioned, and the qualities of the remaining M−1 (or up M−1) is differential (e.g., relative to the reported differential quality that is relative to the quality of the first UL signal) as aforementioned, in one example the one of M (or up to M) corresponds to the signal of the index with the largest (or smallest) quality.
In one example, the gNB report to the UE can include M or up to M signal indices, according to the aforementioned examples, and corresponding M or up to M qualities, and a quality value corresponding to the first UL signal, as illustrated in FIG. 35F. In one example, the quality value is RSRP (absolute or differential). In one example, the quality value is SINR (absolute or differential). In one example, the quality value is CQI or MCS or BLER (absolute or differential). In one example, the M (or up to M) qualities corresponding to the M (or up to M) signal indices are absolute as aforementioned, and the quality corresponding to the first UL signal is absolute as aforementioned. In one example, the M (or up to M) qualities corresponding to the M (or up to M) signal indices are differential, e.g., relative to the quality of the first UL signal as aforementioned, and the quality corresponding to the first UL signal is absolute as aforementioned. In one example, the quality of one of M (or up to M) qualities is absolute as aforementioned, and the qualities of the remaining M−1 (or up M−1) is differential (e.g., relative to the reported absolute quality) as aforementioned, and the quality corresponding to the first UL signal is differential (e.g., relative to the reported absolute quality) as aforementioned, in one example the one of M (or up to M) corresponds to the signal index with the largest (or smallest) quality. In one example, the quality of one of M (or up to M) qualities is differential (e.g., relative to quality of the first UL signal) as aforementioned, and the qualities of the remaining M−1 (or up M−1) is differential (e.g., relative to the reported differential quality that is relative to the quality of the first UL signal) as aforementioned, and the quality corresponding to the first UL signal is absolute as aforementioned, in one example the one of M (or up to M) corresponds to the signal of the index with the largest (or smallest) quality.

In one example, the UE can use the aforementioned gNB report to select a spatial domain filter to transmit to the gNB. In one example, the UE can use the aforementioned gNB report to select a spatial domain filter to transmit to the gNB for an indicated TCI state. In one example, and when there is beam reciprocity between UL and DL, the UE can use the aforementioned gNB report to select a spatial domain filter to receive from the gNB.

In one example, the aforementioned gNB report is included in a DCI Format multiplexed on PDCCH from gNB to UE.
In one example, the DCI Format is a DCI Format scheduling PUSCH (e.g., DCI Format 0_X, where X can be 0, 1, 2 or 3).
In one example, the DCI Format is a DCI Format scheduling PDSCH (e.g., DCI Format 1_X, where X can be 0, 1, 2 or 3).
In one example, the DCI Format is purpose designed DCI Format.
In one example, the DCI Format is UE specific. In one example, the DCI Format is to a group of UEs (e.g., group common DCI).
In one example, the DCI Format is used for other purposes in addition to including the gNB report.

In one example, the aforementioned gNB report is included in a DCI multiplexed on PDSCH.

In one example, the aforementioned gNB report is included in a MAC CE from gNB to UE.

In one example, the aforementioned gNB report is included in a RRC message.

In one example, the aforementioned gNB report is aperiodic.

In one example, the aforementioned gNB report is semi-persistent.

In one example, the aforementioned gNB report is periodic.

In one example, after the UE receives the gNB report, the UE can update the transmit spatial domain transmission filter and/or, in case of UL/DL reciprocity, the receive spatial domain transmission, based on the gNB report.

In one example, based on the measurement of the UL RS transmitted by the UE, e.g., UL DM-RS and/or UL BT-RS and/or SRS and/or SBT-RS, the gNB can determine a TCI state and/or spatial relation, and signal the TCI state and/or spatial relation to the UE, following the unified TCI state framework. For example, the TCI state is signaled to the UE in a DL related DCI Format (with or without DL assignment) or in an UL related DCI Format (with or without UL grant), or in a purpose designed DCI format for TCI state indication, or in a purpose designed channel for TCI state indication. The signaled or indicated TCI state to the UE is applied after a beam application time.

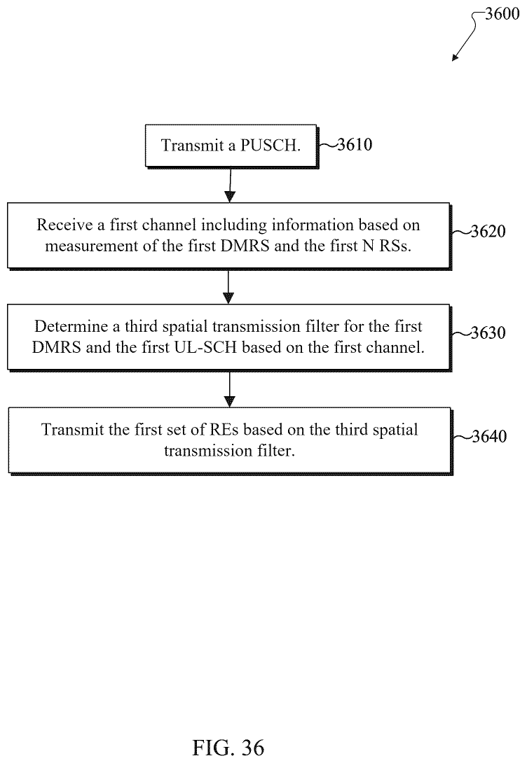

FIG. 36 illustrates an example method 3600 performed by a UE in a wireless communication system according to embodiments of the present disclosure. The method 3600 of FIG. 36 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3600 is for illustration only and other embodiments can be used without departing from the scope of the present disclosure.

The method 3600 begins with the UE transmitting a PUSCH (3610). For example, in 3610, the PUSCH includes a first set of REs including a first DMRS and a first UL-SCH, the first DMRS and UL-SCH based on a first spatial transmission filter, and a second set of REs including first N RSs based on second N spatial transmission filters, respectively, where N is larger than or equal to 1. In various embodiments, the first set of REs is transmitted using a sum beam with spatial filter coefficients

$$[ {c}_{0} , {c}_{1} , … {c}_{\frac{n}{2} - 1} , {c}_{\frac{n}{2}} , {c}_{\frac{n}{2} + 1} , … , - {c}_{n - 1} ] ,$$

N=1, the second set of REs is transmitted using a difference beam with spatial filter coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] ,$$

and the information is based on a metric measured using the first DMRS, and a metric measured using a first RS, from the first N RSs.

The UE then receives a first channel including information based on measurement of the first DMRS and the first N RSs (3620). In various embodiments, the first channel is a PDCCH that includes DCI. In various embodiments, the information is an index corresponding to a RS among the first DMRS and the first N RSs, and the information is represented by a bit field of size └log₂(N+1)┘, where index 0 represents the first DMRS and indices 1 to N represent a corresponding first RS of the first N RSs. In various embodiments, the information includes an index corresponding to a first RS among the first N RSs, a first RSRP corresponding to the first RS, and a second RSRP corresponding to the first DMRS.

The UE then determines a third spatial transmission filter for the first DMRS and the first UL-SCH based on the first channel (3630). The UE then transmits the first set of REs based on the third spatial transmission filter (3640).

In various embodiments, the UE receives a configuration of M SRS, receives an association of a TCI state with at least K SRS from the M SRS, receives a second channel indicating the TCI state, and transmits at least the K SRS associated with the TCI state.

In various embodiments, the UE transmits a third set of REs including a second DMRS and a second UL-SCH based on a fourth spatial domain filter, transmits a fourth set of REs including a second N RSs based on fifth N spatial transmission filters, respectively. The first channel includes information based on measurement of the second DMRS and the second N RS. The UE determines, based on the first channel, a sixth spatial transmission for the second DMRS and the second UL-SCH and transmits the third set of REs based on the sixth spatial transmission filter.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
transmit a physical uplink shared channel (PUSCH), wherein the PUSCH includes:
a first set of resource elements (REs) including a first demodulation reference signal (DMRS) and a first uplink shared channel (UL-SCH), the first DMRS and UL-SCH based on a first spatial transmission filter, and
a second set of REs including first N reference signals (RSs) based on second N spatial transmission filters, respectively, where N is larger than or equal to 1, and
receive a first channel including information based on measurement of the first DMRS and the first N RSs; and
a processor operably coupled to the transceiver, the processor configured to determine, based on the first channel, a third spatial transmission filter for the first DMRS and the first UL-SCH,
wherein the transceiver is further configured to transmit the first set of REs based on the third spatial transmission filter.

2. The UE of claim 1, wherein:
the first channel is a physical downlink channel (PDCCH), and
the PDCCH includes downlink control information (DCI).

3. The UE of claim 1, wherein:
the information is an index corresponding to a RS among the first DMRS and the first N RSs, and
the information is represented by a bit field of size └log₂(N+1)┘, where index 0 represents the first DMRS and indices 1 to N represent a corresponding first RS of the first N RSs.

4. The UE of claim 1, wherein the information includes:
an index corresponding to a first RS among the first N RSs,
a first reference signal received power (RSRP) corresponding to the first RS, and
a second RSRP corresponding to the first DMRS.

5. The UE of claim 1, wherein:
the first set of REs is transmitted using a sum beam with spatial filter coefficients
$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$
N=1,
the second set of REs is transmitted using a difference beam with spatial filter coefficients
$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] ,$$
and
the information is based on a metric measured using the first DMRS, and a metric measured using the first N RSs.

6. The UE of claim 1, wherein the transceiver is further configured to:
receive a configuration of M sounding reference signal (SRS),
receive an association of a transmission configuration indicator (TCI) state with K SRS from the M SRS,
receive a second channel indicating the TCI state, and
transmit the K SRS associated with the TCI state.

7. The UE of claim 1, wherein:
the transceiver is further configured to:
transmit a third set of REs including a second DMRS and a second UL-SCH based on a fourth spatial domain filter, and
transmit a fourth set of REs including a second N RSs based on fifth N spatial transmission filters, respectively,
the first channel includes information based on measurement of the second DMRS and the second N RS,
the processor is further configured to determine, based on the first channel, a sixth spatial transmission for the second DMRS and the second UL-SCH, and
the transceiver is further configured to transmit the third set of REs based on the sixth spatial transmission filter.

8. A base station (BS), comprising:
a transceiver configured to:
receive a physical uplink shared channel (PUSCH), wherein the PUSCH includes:
a first set of resource elements (REs) including a first demodulation reference signal (DMRS) and a first uplink shared channel (UL-SCH), the first DMRS and UL-SCH based on a first spatial transmission filter, and
a second set of REs including first N reference signals (RSs) based on second N spatial transmission filters, respectively, where N is larger than or equal to 1; and
a processor operably coupled to the transceiver, the processor configured to:
measure a metric based on the first DMRS and N metrics based on the first N RS, and
determine information based on the metric and the N metrics,
wherein the transceiver is further configured to transmit a first channel including the information.

9. The BS of claim 8, wherein:
the first channel is a physical downlink channel (PDCCH), and
the PDCCH includes downlink control information (DCI).

10. The BS of claim 8, wherein:
the information is an index corresponding to a RS among the first DMRS and the first N RSs, and
the information is represented by a bit field of size └log₂(N+1)┘, where index 0 represents the first DMRS and indices 1 to N represent a corresponding first RS of the first N RSs.

11. The BS of claim 8, wherein the information includes:
an index corresponding to a first RS among the first N RSs,
a first reference signal received power (RSRP) corresponding to the first RS, and
a second RSRP corresponding to the first DMRS.

12. The BS of claim 8, wherein:
the first set of REs is transmitted using a sum beam with spatial filter coefficients
$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$
$$N = 1 ,$$
the second set of REs is transmitted using a difference beam with spatial filter coefficients
$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] ,$$
and
the information is based on a metric measured using the first DMRS, and a metric measured using the first N RSs.

13. The BS of claim 8, wherein the transceiver is further configured to:
transmit a configuration of M sounding reference signal (SRS),
transmit an association of a transmission configuration indicator (TCI) state with K SRS from the M SRS,
transmit a second channel indicating the TCI state, and
receive the K SRS associated with the TCI state.

14. A method of operating a user equipment (UE), the method comprising:
transmitting a physical uplink shared channel (PUSCH), wherein the PUSCH includes:
a first set of resource elements (REs) including a first demodulation reference signal (DMRS) and a first uplink shared channel (UL-SCH), the first DMRS and UL-SCH based on a first spatial transmission filter, and
a second set of REs including first N reference signals (RSs) based on second N spatial transmission filters, respectively, where N is larger than or equal to 1;
receiving a first channel including information based on measurement of the first DMRS and the first N RSs;
determining, based on the first channel, a third spatial transmission filter for the first DMRS and the first UL-SCH; and
transmitting the first set of REs based on the third spatial transmission filter.

15. The method of claim 14, wherein:
the first channel is a physical downlink channel (PDCCH), and
the PDCCH includes downlink control information (DCI).

16. The method of claim 14, wherein:
the information is an index corresponding to a RS among the first DMRS and the first N RSs, and
the information is represented by a bit field of size └log₂(N+1)┘, where index 0 represents the first DMRS and indices 1 to N represent a corresponding first RS of the first N RSs.

17. The method of claim 14, wherein the information includes:
an index corresponding to a first RS among the first N RSs,
a first reference signal received power (RSRP) corresponding to the first RS, and
a second RSRP corresponding to the first DMRS.

18. The method of claim 14, wherein:
the first set of REs is transmitted using a sum beam with spatial filter coefficients
$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$
$$N = 1 ,$$
the second set of REs is transmitted using a difference beam with spatial filter coefficients
$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] ,$$
and
the information is based on a metric measured using the first DMRS, and a metric measured using the first N RSs.

19. The method of claim 14, further comprising:
receiving a configuration of M sounding reference signal (SRS);
receiving an association of a transmission configuration indicator (TCI) state with K SRS from the M SRS;
receiving a second channel indicating the TCI state; and
transmitting the K SRS associated with the TCI state.

20. The method of claim 14, further comprising:
transmitting a third set of REs including a second DMRS and a second UL-SCH based on a fourth spatial domain filter;
transmitting a fourth set of REs including a second N RSs based on fifth N spatial transmission filters, respectively, wherein the first channel includes information based on measurement of the second DMRS and the second N RS;
determining, based on the first channel, a sixth spatial transmission for the second DMRS and the second UL-SCH, and
transmitting the third set of REs based on the sixth spatial transmission filter.
